(19) United States
(12) Patent Application Publication
(10) Pub. No.: US 2026/0013541 A1
(43) Pub. Date: Jan. 15, 2026

(54) FATTY ACID COMPOSITIONS

(71) Applicant: ByHeart, Inc., New York, NY (US)

(72) Inventors: Devon KUEHN, Providence, RI (US); Jitinder WILKHU, Walderslade (GB); Kathryn CHASE, Brooklyn, NY (US); Michael LUTTRELL, Knoxville, TN (US); Diana ORENSTEIN, Needham, MA (US)

(21) Appl. No.: 19/269,709

(22) Filed: Jul. 15, 2025

Related U.S. Application Data
(60) Provisional application No. 63/671,548, filed on Jul. 15, 2024.

(51) Int. Cl. A23L 33/00; A23L 33/12

(52) U.S. Cl. CPC A23L 33/40; A23L 33/12

(57) ABSTRACT

The present disclosure provides a composition and an oil comprising fatty acids. The fatty acids include saturated fatty acids selected from the group consisting of short/medium chain fatty acids, intermediate chain fatty acids, long chain fatty acids, and combinations thereof. The fatty acids also include unsaturated fatty acids selected from the group consisting of monounsaturated fatty acids, polyunsaturated fatty acids, and combinations thereof. The composition and oil can be derived from various sources including recombinant sources, whole milk powder, plant oils, fatty fish, algae, fungi, dairy products, cooking oils, and plant sources. The composition and oil can be used in an infant formula that mimics human breast milk.

### CROSS-REFERENCE TO RELATED APPLICATIONS

This application claims priority to U.S. Provisional Application No. 63/671,548 filed on Jul. 15, 2024, which is incorporated herein by reference in its entirety.

### BACKGROUND OF THE INVENTION

Infant nutrition plays a crucial role in the growth, development, and long-term health outcomes of newborns. Human breast milk is widely recognized as the gold standard for infant nutrition, providing an optimal balance of nutrients, bioactive compounds, and immune factors tailored to the needs of developing infants. However, not all mothers are able to exclusively breastfeed, and in such cases, infant formula serves as a vital alternative or supplement.

Despite significant advancements in infant formula development, current products still face challenges in replicating the complex composition and benefits of human breast milk. One of the key areas of focus is the fatty acid profile of infant formulas. Fatty acids are essential for infant growth, brain development, and immune function, but achieving the right balance and composition in formula has proven difficult.

Existing infant formulas often rely on a limited range of fat sources, primarily vegetable oils, which may not provide the diverse array of fatty acids found in breast milk. Each fat source (e.g., oil) has its own distinct fatty acid profile, and combining multiple fat sources to achieve a precise fatty acid composition that matches or at least attempts to mimic human milk has proven virtually impossible with current methods. A significant challenge is that when manufacturers include certain oils to obtain beneficial fatty acids, they are simultaneously introducing other potentially unwanted or even harmful components that are inherently present in those same source oils. This can result in suboptimal levels of certain beneficial fatty acids, such as docosahexaenoic acid (DHA) and arachidonic acid (ARA), which are crucial for brain and eye development. For example, it has particularly been difficult to mimic the levels of long chain fatty acids found in human breast milk without using unpopular sources such as palm oil and seed oils. Additionally, the ratios of different fatty acids in current formulas may not closely mimic those found in human milk, further compromising their nutritional value for developing infants.

Another challenge is the presence of undesirable fatty acids in some formula ingredients. For example, certain vegetable oils used in formulas can contain erucic acid, which may have potential negative health effects on infants.

While manufacturers prioritize oils with beneficial components, they often must accept the presence of less desirable components due to the inherent composition of available natural oils. Furthermore, manufacturers typically select popular source oils because they contain consistent amounts of ingredients of interest, which facilitates manufacturing a consistent product. This trade-off between consistency in manufacturing and optimal nutritional profile has been an ongoing challenge for formula manufacturers.

The present disclosure aims to address these challenges by developing a novel approach to infant formula composition. The disclosure presents a unique fatty acid profile that more closely resembles human breast milk. This is achieved through a combination of carefully selected fat sources, including whole milk, plant oils, and potentially recombinant sources, which may overcome the limitations of traditional formula ingredients.

By utilizing a diverse range of fat sources, the present disclosure seeks to provide a more comprehensive fatty acid profile, including optimal levels of essential fatty acids like DHA and ARA. And achieves ratios of different fatty acids that are more aligned with those found in human milk, such as the ratio of linoleic acid to alpha-linolenic acid, and the balance between omega-6 and omega-3 fatty acids, while avoiding the unwanted components typically accompanying traditional oil sources.

Meanwhile, the compositions and oils of the present disclosure minimize or eliminate certain fatty acids that are not optimal in infant formula, such as erucic acid, while maximizing the presence of beneficial short, medium, and long-chain fatty acids. This approach represents the first optimized human breast milk mimicking formula that may overcome many of the limitations inherent in traditional infant formula production. This careful balancing act is designed to create a fatty acid composition that not only meets the nutritional needs of infants but also supports optimal growth and development.

The compositions and oils of the present disclosure have the potential to provide infants who cannot be exclusively breastfed with a nutritional alternative that better supports their growth, development, and long-term health outcomes. Further, the fatty acid profile of the compositions and oils of the present disclosure are superior to human breast milk or any infant formula yet to be disclosed.

### SUMMARY OF THE INVENTION

In some aspects, the techniques described herein relate to a composition including fatty acids, wherein the composition includes saturated fatty acids, unsaturated fatty acids, and combinations thereof.

In some aspects, the techniques described herein relate to a composition including fatty acids, wherein the composition includes saturated fatty acids, unsaturated fatty acids, and combinations thereof; and wherein the saturated fatty acids are selected from the group consisting of short/medium chain fatty acids including less than twelve carbons, intermediate chain fatty acids including twelve to fourteen carbons, long chain fatty acids including greater than fourteen carbons, and combinations thereof; and wherein the unsaturated fatty acids are selected from the group consisting of monounsaturated fatty acids, polyunsaturated fatty acids, and combinations thereof.

In some aspects, the techniques described herein relate to a composition including Butyric acid (C4:0), Caproic acid (C6:0), Caprylic acid (C8:0), Capric acid (C10:0), Lauric acid (C12:0), Myristic acid (C14:0), Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), Myristoleic acid (C14:1), Palmitoleic acid (C16:1), Oleic acid (C181n9), Gadoleic acid (C20:1), Nervonic acid (C24:1), Linoleic acid (C18:2n6), Linolenic acid (C18:3n3), Arachidonic acid (C20:4n6), Eicosapentaenoic acid (C20:5n3), Docosapentaenoic acid (C22:5n3), and Docosahexaenoic acid (C22:6n3); and wherein the composition optionally further includes Erucic acid (C22:1), Nervonic acid (C24:1), and combinations thereof.

In some aspects, the techniques described herein relate to an oil including fatty acids, wherein the oil includes saturated fatty acids, unsaturated fatty acids, and combinations thereof.

In some aspects, the techniques described herein relate to an oil including fatty acids, wherein the oil includes saturated fatty acids, unsaturated fatty acids, and combinations thereof; and wherein the saturated fatty acids are selected from the group consisting of short/medium chain fatty acids including less than twelve carbons, intermediate chain fatty acids including twelve to fourteen carbons, long chain fatty acids including greater than fourteen carbons, and combinations thereof; and wherein the unsaturated fatty acids are selected from the group consisting of monounsaturated fatty acids, polyunsaturated fatty acids, and combinations thereof.

In some aspects, the techniques described herein relate to an oil including Butyric acid (C4:0), Caproic acid (C6:0), Caprylic acid (C8:0), Capric acid (C10:0), Lauric acid (C12:0), Myristic acid (C14:0), Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), Myristoleic acid (C14:1), Palmitoleic acid (C16:1), Oleic acid (C181n9), Gadoleic acid (C20:1), Nervonic acid (C24:1), Linoleic acid (C18:2n6), Linolenic acid (C18:3n3), Arachidonic acid (C20:4n6), Eicosapentaenoic acid (C20:5n3), Docosapentaenoic acid (C22:5n3), and Docosahexaenoic acid (C22:6n3); and wherein the oil optionally further includes Erucic acid (C22:1), Nervonic acid (C24:1), and combinations thereof.

### BRIEF DESCRIPTION OF DRAWINGS

FIG. 1 illustrates a comparison of fatty acid profiles between mature breast milk, currently marketed infant formulas, and the target fatty acid profile of the present disclosure.

FIG. 2 illustrates the fatty acid profiles of mature breast milk from healthy and unhealthy subjects and compares these to the target fatty acid profile of the present disclosure.

FIG. 3 illustrates three target fatty acid profiles according to embodiments disclosed herein compared to fatty acid profiles of currently marketed infant formulas and mature breast milk.

### DETAILED DESCRIPTION OF THE INVENTION

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

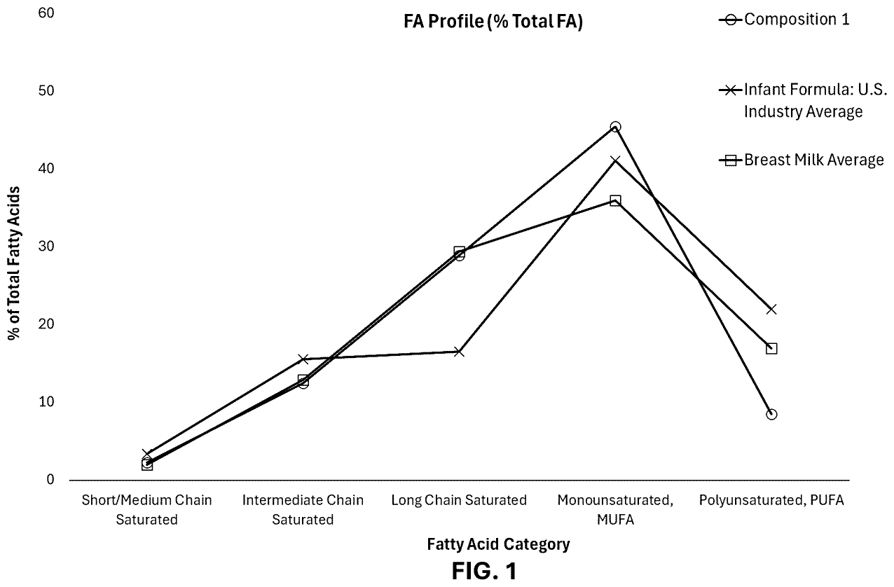

The fatty acid profile of current infant formulas on the USA market (average of three commercially available brands) differs significantly from that found in breast milk as graphically represented in FIG. 1. Breast milk naturally contains a unique balance of essential fatty acids, such as omega-3 and omega-6, which are crucial for an infant's development. In contrast, infant formulas often have a less optimal fatty acid composition, which is related to the fact no naturally occurring source of fatty acids exists to mimic the unique fatty acids as present within breast milk.

The fatty acid profiles of the compositions and oils of the present disclosure were invented to closely mimic the fatty acid levels found in breast milk, ensuring better nutritional support for infants. Furthermore, embodiments of the current disclosure improve upon the fatty acid profile of breast milk. Just because certain fatty acids are present in breast milk does not mean the presence or amount of those fatty acids are advantageous or optimal for healthy development. The compositions and oils of the present disclosure optimize the fatty acid profile of both currently marketed infant formulas and breastmilk. FIG. 1 demonstrates the target profile for a fatty acid composition according to embodiments disclosed herein that has short/medium chain, intermediate chain saturated, and long chain saturated fatty acids in ratios similar to breast milk.

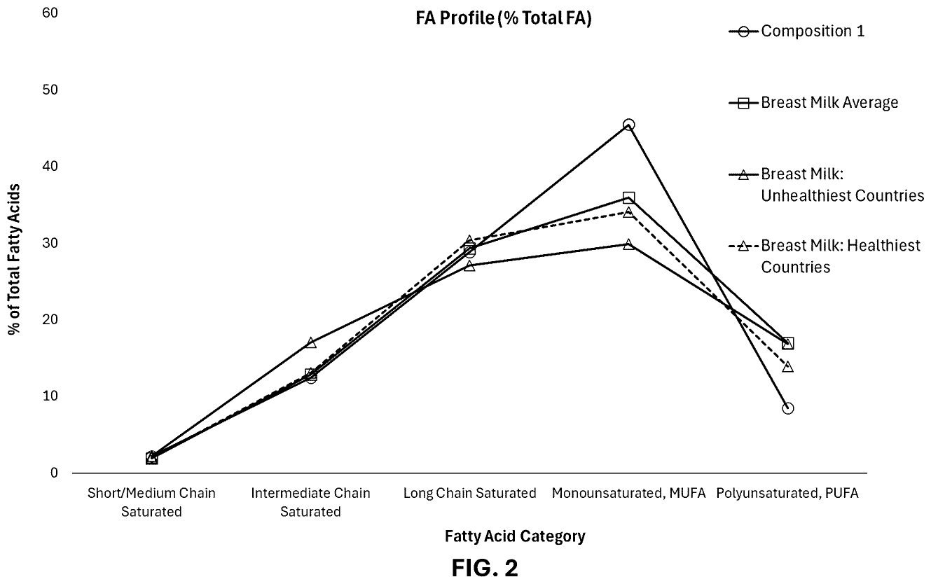

Without being bound by theory, polyunsaturated fatty acids, such as those found in seed oils, are prone to oxidation, forming peroxides and subsequently other degradation products. These seed oils are implicated in oxidative stress, inflammation, and some disease processes. Based on breast milk levels of healthy mothers, the polyunsaturated fats as described herein are at lower levels compared to unhealthy breast milk levels (FIG. 2). Accordingly, some embodiments of the present disclosure relate to compositions and oils have lower levels of polyunsaturated fatty acids.

Without being bound by theory, long chain saturated fatty acids are known to help with neurodevelopment, visual acuity, immune system development, linear growth/differentiation of cells to osteoblasts instead of adipocytes and inflammation balance. In some embodiments of the compositions and oils disclosed herein, the long chain fatty acid profile closely mimics that of breastmilk such as shown in FIG. 1. Some embodiments of the present disclosure achieve this without the use of palm oil, which are often used in infant formulas, but are structurally unsimilar to the long chain fatty acids found in breast milk.

Palmitic acid is one of the most prevalent fatty acids in human milk. In order to replicate the level of palmitic acid in human milk, many infant formulas contain palm oil, due to its high proportion of palmitic acid. However, while much of the palmitic acid in human milk is positioned in the sn-2 position, the majority of the palmitic acid in palm oil is positioned in the sn-1 or sn-3 position (resulting in as low as 7% in the sn-2 position). Without being bound by theory, due to the poor absorption and calcium binding of palmitic acid in the sn-1 and sn-3 position, clinical studies suggest that the inclusion of palm oil in infant formula is associated with lower bone mineralization and harder stools compared to formulas that do not include palm oil. The compositions and oils of the present disclosure reduce or eliminate the use of palm oils, but maintain the presence of palmitic acid.

### Definitions

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Where a range of values is provided, it is intended that each intervening value between the upper and lower limit of that range and any other stated or intervening value in that stated range is encompassed within the disclosure. For example, if a range of 1 μm to 8 μm is stated, it is intended that 2 μm, 3 μm, 4 μm, 5 μm, 6 μm, and 7 μm are also explicitly disclosed.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

As used herein, the term “about” when immediately preceding a numerical value means a range of plus or minus 15% of that value, e.g., “about 50” means 45 to 55, “about 25,000” means 22,500 to 27,500, etc., unless the context of the disclosure indicates otherwise, or is inconsistent with such an interpretation.

The terms “administer,” “administering” or “administration” as used herein refer to directly administering a compound or a composition to a subject.

As used herein, the term “breast milk mimicking” oil and/or composition refers to a substance or mixture that resembles or approximates the composition, nutritional profile, or functional properties of human breast milk. This includes synthetic formulations, naturally derived substances, or combinations thereof that replicate one or more aspects of human milk without using human breast milk fatty acid extracts. A breast milk mimicking oil and/or composition is within +/−25% of the optimized human breast milk fatty acid profile for each of one or more components. The oil or composition may be based on a single ingredient (such as a specific fatty acid), a group of ingredients (such as short or long chain fatty acids), or the composition as a whole. The term encompasses substances designed for infant nutrition, research purposes, or other applications where similarity to human breast milk is desired. Unless otherwise specified, as used herein, the terms “milk”, “breast milk”, and “human breast milk” are interchangeable. As used herein, the terms “breast milk mimicking” and “human breast milk mimicking” are interchangeable.

As used herein, the term “optimized breast milk” oil and/or composition refers to the fatty acid profile specifically formulated to resemble the nutritional profile and functional properties of human breast milk from healthy mothers, while incorporating targeted improvements to enhance infant nutrition as defined in Table A. An optimized human breast milk oil and/or composition is within +/−25% of the optimized human breast milk fatty acid profile for each of one or more components. The oil or composition may be based on a single fatty acid, a group of fatty acids, or the fatty acid composition as a whole. The optimization involves adjusting levels of specific fatty acids, based on current scientific understanding of infant nutritional needs. An optimized human breast milk oil and/or composition addresses specific nutritional goals while maintaining overall similarity to the average composition of human breast milk. This formulation, which does not exist in nature, includes carefully selected components, ratios, and concentrations of nutrients designed to provide optimal nutritional support for infant growth and development. Unless otherwise specified, as used herein, the terms “milk”, “breast milk”, and “human breast milk” are interchangeable. As used herein, the terms “optimized breast milk” and “optimized human breast milk” are interchangeable.

TABLE A
Fatty acid content of optimized human breast milk

| Fatty Acid Type | Range |
|---|---|
| Short/Medium Chain Saturated | 0.4-4.2% |
| Intermediate Chain Saturated | 7.5-20.0% |
| Long Chain Saturated | 22.79-38.0% |
| Monounsaturated | 26.64-55.22% |
| Polyunsaturated | 7.8-12.67% |

As used herein, the term “effective amount” refers to an amount that results in measurable result. As used herein, an effective amount of a nutritional supplements maintains or restores nutrition in the subject.

As used herein, the term “essentially no” refers to an amount that is less than about 0.2% of the composition. The term “essentially no” indicate that a particular component or substance is present in trace amounts or is substantially absent from the composition. The term encompasses situations where the component is present in amounts that are below the detection limit of standard analytical methods or where its presence does not significantly affect the properties or performance of the composition.

As used herein, the term “milk” refers to a nutrient-rich liquid food produced by the mammary glands of mammals. “Milk” includes, but is not limited to, cow's milk, goat's milk, sheep's milk, buffalo milk, camel milk, or human breast milk. The term “milk” also encompasses plant-based milk alternatives derived from sources such as soy, almond, oat, rice, or coconut. Milk may be in various forms, including but not limited to whole milk, reduced-fat milk, low-fat milk, skim milk, or milk powder. Milk may be butter milk. The term “milk” may also include processed milk products such as pasteurized milk, homogenized milk, or ultra-high temperature (UHT) milk. Milk refers to a composition that mimics the nutritional profile of mammalian milk, including synthetic or lab-grown milk alternatives. As used herein, the terms “milk”, “breast milk”, and “human breast milk” are interchangeable.

As used herein, the term “mature breast milk” refers to human milk produced by a lactating individual after the initial colostrum and transitional milk phases, typically beginning around 2-4 weeks postpartum. Mature breast milk is characterized by a relatively stable composition of nutrients, antibodies, and bioactive compounds tailored to meet the nutritional and immunological needs of a growing infant. Mature breast milk may contain a balance of macronutrients including carbohydrates, proteins, and lipids, as well as micronutrients such as vitamins and minerals. The composition of mature breast milk may vary between individuals and changes over the course of lactation to adapt to the infant's changing needs. Mature breast milk may also include various bioactive components such as growth factors, hormones, and beneficial bacteria. The term “mature breast milk” is used to distinguish this stage of milk production from colostrum, transitional milk, or other stages of human lactation.

The term “naturally sourced milk” as used herein refers to milk from any natural source. Naturally sourced milk contains the same or similar ingredients as the formulations described herein, but these ingredients are not used in calculating the amount of each ingredient in the formulations described herein. A naturally sourced milk may be from a non-human source, such as a cow (bovine), sheep, goat, yak, water buffalo, horse, reindeer, or camel. A naturally sourced milk may be non-animal milk, such as soy, rice, hemp, pea, oat, almond or other nuts. A naturally sourced milk may be whole milk, reduced fat milk, low fat milk, and fat-free milk.

The term “nutritional support” as used herein refers to delivery of nutrition to maintain or restore nutritional status.

The term “preventing” refers to prevention of a specific disorder, disease or condition and/or to prevent the reoccurrence of a specific disorder, disease or condition.

The term “subject” as use herein, refers to any recipient of the formulation described herein. The subject can be human or non-human. The subject may be in need of a nutritional supplement. As used herein the terms “subject” and “subject in need thereof” are interchangeable.

The term “substantially free” as used herein refers to 1% or less of a substance.

The term “substantially similar” as used herein refers to having a shared property within 15% of its counterpart.

The term “fatty acids” as used herein refers to carboxylic acids with long aliphatic chains, which may be saturated or unsaturated.

The term “saturated fatty acids” as used herein refers to fatty acids containing no double bonds between carbon atoms in the aliphatic chain.

The term “unsaturated fatty acids” as used herein refers to fatty acids containing one or more double bonds between carbon atoms in the aliphatic chain.

The term “short/medium chain fatty acids” as used herein refers to fatty acids comprising less than twelve carbons.

The term “intermediate chain fatty acids” as used herein refers to fatty acids comprising twelve to fourteen carbons.

The term “long chain fatty acids” as used herein refers to fatty acids comprising greater than fourteen carbons.

The term “monounsaturated fatty acids” as used herein refers to fatty acids containing one double bond in the aliphatic chain.

The term “polyunsaturated fatty acids” as used herein refers to fatty acids containing two or more double bonds in the aliphatic chain.

The term “n-6 fatty acids” as used herein refers to polyunsaturated fatty acids where the first double bond is located at the sixth carbon atom from the methyl end of the fatty acid.

The term “n-3 fatty acids” as used herein refers to polyunsaturated fatty acids where the first double bond is located at the third carbon atom from the methyl end of the fatty acid.

The term “recombinant sources” as used herein refers to sources of fatty acids produced using genetic engineering techniques.

The term “whole milk powder” as used herein refers to a dried form of whole milk.

The term “plant oils” as used herein refers to oils derived from plant sources, including but not limited to coconut oil, canola oil, sunflower oil, and algal oil.

The term “fatty fish” as used herein refers to fish that are rich in oils and fatty acids, including but not limited to salmon, mackerel, sardines, trout, herring, and tuna.

The term “milkfat” as used herein refers to the fat content of milk.

The term “infant formula” as used herein refers to a manufactured food designed and marketed for feeding to babies and infants under 12 months of age, as a substitute for human breast milk.

### Compositions

Some embodiments of the present disclosure relate to compositions that may be breast milk mimicking compositions or optimized human breast milk compositions. Any embodiment described herein may be formulated as a breast milk mimicking composition that resembles or approximates the composition, nutritional profile, or functional properties of human breast milk. Embodiments of the present disclosure may relate to part of a breast milk composition or the entirety of a breast milk formulation. For example, embodiments of the present disclosure may relate to a whole infant formula composition or a portion of a fatty acid composition. Additionally, any embodiment may be formulated as an optimized human breast milk composition that closely resembles the nutritional profile and functional properties of human breast milk from healthy mothers, while incorporating targeted improvements or adjustments to potentially enhance certain aspects of infant nutrition. These compositions may include carefully selected components, ratios, or concentrations of nutrients designed to provide optimal nutritional support for infant growth and development.

Embodiments of the present disclosure provide a composition, specifically a composition, with a tailored fatty acid (FA) profile. The FA profile of the composition is optimized to comprise a variety of saturated and unsaturated fatty acids, each present in specific proportions. The saturated fatty acids comprise short/medium chain saturated fatty acids, intermediate chain saturated fatty acids, long chain saturated fatty acids, and combinations thereof. The unsaturated fatty acids comprise monounsaturated fatty acids and polyunsaturated fatty acids. Compositions of the present disclosure may align with the FA profile of Table A.

The FA profile of the composition is designed to mimic the FA profile found in human breast milk, making it particularly suitable for use in infant formula. The compositions of this invention are uniquely able to mimic human breast milk, which is not naturally occurring in any other source. The composition may be derived from a variety of sources, including but not limited to, whole milk fats, vegetable oils, and recombinant oils. In some cases, the composition may be derived entirely from recombinant oils, which can be produced through precision fermentation processes, thermal chemistry, or any novel technology known in the art.

The fatty acid profile of the compositions was developed from an extensive global analysis of human milk, ensuring it reflects a wide variety of diets and environments. The profile was further refined using data from populations with low non-communicable disease mortality rates, aligning with the fatty acid levels in the milk of mothers from these “healthiest” countries to promote health and wellness. The specific fatty acid levels were also informed by a comprehensive body of research, including mechanistic studies, expert opinions, and human milk studies, to scientifically substantiate the composition's potential health benefits.

In any embodiment described herein, the composition comprises a variety of fatty acids. In some embodiments, the fatty acids comprise both saturated and unsaturated fatty acids. In some embodiments, the saturated fatty acids are present in the composition in various forms, such as short/medium chain saturated fatty acids, intermediate chain saturated fatty acids, and long chain saturated fatty acids. Each of these types of saturated fatty acids contribute to the overall fatty acid profile of the composition and are present in specific proportions relative to the total fatty acid content.

In some embodiments, the present disclosure relates to a composition comprising fatty acids, wherein the composition comprises saturated fatty acids, unsaturated fatty acids, and combinations thereof.

In some embodiments, the present disclosure relates to a composition, wherein the saturated fatty acids are selected from the group consisting of short/medium chain fatty acids, intermediate chain fatty acids, long chain fatty acids, and combinations thereof.

In some embodiments, the present disclosure relates to a composition, wherein the short/medium chain fatty acids comprise less than twelve carbons. In some embodiments, the present disclosure relates to a composition, wherein the short/medium chain saturated fatty acids comprise about 0.40% to about 4.20% of the total fatty acids. In some embodiments, the present disclosure relates to a composition, wherein the short/medium chain saturated fatty acids comprise about 0.50% to about 3.50%, about 0.75% to about 3.00%, about 1.00% to about 2.50%, about 1.25% to about 2.25%, about 1.50% to about 2.00%, about 0.60% to about 3.80%, about 0.80% to about 3.60%, about 1.20% to about 3.20%, about 1.60% to about 2.80%, about 2.00% to about 2.60%, about 0.45% to about 4.00%, about 0.55% to about 3.75%, about 0.70% to about 3.50%, about 0.90% to about 3.25%, about 1.10% to about 3.00%, about 1.30% to about 2.75%, about 1.50% to about 2.50%, about 1.75% to about 2.25%, about 0.65% to about 3.90%, about 0.85% to about 3.70% of the total fatty acid, and any value within these ranges. In some embodiments, the present disclosure relates to a composition, wherein the short/medium chain fatty acids comprise about 2.27% of the total fatty acids. In some embodiments, the present disclosure relates to a composition, wherein the short/medium chain saturated fatty acids comprise about 0.45%, about 0.75%, about 1.10%, about 1.50%, about 1.85%, about 2.27%, about 2.60%, about 2.95%, about 3.30%, about 3.65%, about 4.00%, about 0.60%, about 0.90%, about 1.25%, about 1.70%, about 2.00%, about 2.27%, about 2.75%, about 3.10%, about 3.45%, about 3.80%, about 0.55%, about 0.80%, about 1.15%, about 1.60%, about 1.95%, about 2.27%, about 2.65%, about 3.00%, about 3.40%, about 3.75% of the total fatty acids, and ranges between any two of these values.

In some embodiments, the present disclosure relates to a composition, wherein the short/medium chain fatty acids are selected from the group consisting of Butyric acid (C4:0), Caproic acid (C6:0), Caprylic acid (C8:0), Capric acid (C10:0), and combinations thereof.

In some embodiments, the present disclosure relates to a composition, wherein the Butyric acid (C4:0) is in an amount of less than about 0.39% of the total fatty acids. In some embodiments, the Butyric acid is in amount of less than about 0.01%, less than about 0.03%, less than about 0.05%, less than about 0.07%, less than about 0.10%, less than about 0.12%, less than about 0.15%, less than about 0.18%, less than about 0.20%, less than about 0.23%, less than about 0.25%, less than about 0.28%, less than about 0.30%, less than about 0.32%, less than about 0.35%, less than about 0.37%, less than about 0.02%, less than about 0.04%, less than about 0.06%, less than about 0.08%, less than about 0.11%, less than about 0.13%, less than about 0.16%, less than about 0.19%, less than about 0.21%, less than about 0.24%, less than about 0.26%, less than about 0.29%, less than about 0.31%, less than about 0.33%, less than about 0.36%, less than about 0.38% of the total fatty acids, and any value within these ranges. In some embodiments, the Butyric acid is in an amount of about 0.35% of the total fatty acids. In some embodiments, the Butyric acid is in amount of about 0.01%, about 0.03%, about 0.05%, about 0.07%, about 0.10%, about 0.12%, about 0.15%, about 0.18%, about 0.20%, about 0.23%, about 0.25%, about 0.28%, about 0.30%, about 0.32%, about 0.35%, about 0.37%, about 0.02%, about 0.04%, about 0.06%, about 0.08%, about 0.11%, about 0.13%, about 0.16%, about 0.19%, about 0.21%, about 0.24%, about 0.26%, about 0.29%, about 0.31%, about 0.33%, about 0.35%, about 0.36%, about 0.38% of the total fatty acids, and ranges between any two of these values. In some embodiments, Butyric acid is in an amount of about 0.31% to about 0.42% of the total fatty acids. In some embodiments, the Butyric acid is in an amount of about 0.36% of the total fatty acids.

In some embodiments, the present disclosure relates to a composition, wherein the Caproic acid (C6:0) is in an amount of about 0.05% to about 0.39% of the total fatty acids. In some embodiments, the Caproic acid is in an amount of about 0.05% to about 0.10%, about 0.10% to about 0.15%, about 0.15% to about 0.20%, about 0.20% to about 0.25%, about 0.25% to about 0.30%, about 0.30% to about 0.35%, or about 0.35% to about 0.39% of the total fatty acids, and any value within these ranges. In some embodiments, the Caproic acid is in an amount of about 0.14% of the total fatty acids. In some embodiments, the Caproid acid is in an amount of about 0.05%, about 0.10%, about 0.14%, about 0.15%, about 0.20%, about 0.25%, about 0.30%, about 0.35%, or about 0.39% of the total fatty acids, and ranges between any two of these values. In some embodiments, the Caproic acid is in an amount of about 0.31% to about 0.43% of the total fatty acids. In some embodiments, the Caproic acid is in an amount of about 0.37% of the total fatty acids. In some embodiments, the Caproic acid is in an amount of about 0.28% to about 0.38% of the total fatty acids. In some embodiments, the Caproic acid is in an amount of about 0.33% of the total fatty acids.

In some embodiments, the present disclosure relates to a composition, wherein the Caprylic acid (C8:0) is in an amount of about 0.11% to about 1.68% of the total fatty acids. In some embodiments, the Caprylic acid is in an amount of about 0.11% to about 0.30%, about 0.30% to about 0.50%, about 0.50% to about 0.70%, about 0.70% to about 0.90%, about 0.90% to about 1.10%, about 1.10% to about 1.30%, about 1.30% to about 1.50%, or about 1.50% to about 1.68% of the total fatty acids, and any value within these ranges. In some embodiments, the Caprylic acid is in an amount of about 0.21% of the total fatty acids. In some embodiments, the Caprylic acid is in an amount of about 0.11%, about 0.21%, about 0.30%, about 0.40%, about 0.50%, about 0.60%, about 0.70%, about 0.80%, about 0.90%, about 1.00%, about 1.10%, about 1.20%, about 1.30%, about 1.40%, about 1.50%, 1.60%, or about 1.68% of the total fatty acids, and ranges between any two of these values. In some embodiments, the Caprylic acid is in an amount of about 1.44% to about 1.94% of the total fatty acids. In some embodiments, the Caprylic acid is in an amount of about 1.69% of the total fatty acids. In some embodiments, the Caprylic acid is in an amount of about 1.08% to about 1.46% of the total fatty acids. In some embodiments, the Caprylic acid is in an amount of about 1.27% of the total fatty acids.

In some embodiments, the present disclosure relates to a composition, wherein the Capric acid (C10:0) is in an amount of about 0.28% to about 2.00% of the total fatty acids. In some embodiments, the Capric acid is in amount of about 0.28% to about 0.50%, about 0.50% to about 0.75%, about 0.75% to about 1.00%, about 1.00% to about 1.25%, about 1.25% to about 1.50%, about 1.50% to about 1.75%, or about 1.75% to about 2.00% of the total fatty acids, and any value within these ranges. In some embodiment, the Capric acid is in an amount of about 1.57% of the total fatty acids. In some embodiments, the Capric acid is in an amount of about 0.28%, about 0.50%, about 0.75%, about 1.00%, about 1.25%, about 1.50%, about 1.57%, about 1.75%, or about 2.00% of the total fatty acids, and ranges between any two of these values. In some embodiments, the Capric acid is in an amount of about 1.23% to about 1.67% of the total fatty acids. In some embodiments, the Capric acid is in an amount of about 1.45% of the total fatty acids. In some embodiments, the Capric acid is in an amount of about 0.97% to about 1.31% of the total fatty acids. In some embodiments, the Capric acid is in an amount of about 1.14% of the total fatty acids.

In some embodiments, the present disclosure relates to a composition, wherein the intermediate chain fatty acids comprise twelve to fourteen carbons. In some embodiments, the present disclosure relates to a composition, wherein the intermediate chain fatty acids comprise about 7.50% to about 20.00% of the total fatty acids. In some embodiments, the intermediate chain fatty acids comprise about 7.50% to about 8.50%, about 8.50% to about 9.50%, about 9.50% to about 10.50%, about 10.50% to about 11.50%, about 11.50% to about 12.50%, about 12.50% to about 13.50%, about 13.50% to about 14.50%, about 14.50% to about 15.50%, about 15.50% to about 16.50%, about 16.50% to about 17.50%, about 17.50% to about 18.50%, about 18.50% to about 19.50%, or about 19.50% to about 20.00% of the total fatty acids, and any value within these ranges. In some embodiments, the present disclosure relates to a composition, wherein the intermediate chain fatty acids comprise about 12.51% of the total fatty acids. In some embodiments, the present disclosure relates to a composition, wherein the intermediate chain fatty acids comprise about 7.50%, about 8.00%, about 8.50%, about 9.00%, about 9.50%, about 10.00%, about 10.50%, about 11.00%, about 11.50%, about 12.00%, about 12.51%, about 13.00%, about 13.50%, about 14.00%, about 14.50%, about 15.00%, about 15.50%, about 16.00%, about 16.50%, about 17.00%, about 17.50%, about 18.00%, about 18.50%, about 19.00%, about 19.50%, or about 20.00% of the total fatty acids, and ranges between any two of these values.

In some embodiments, the present disclosure relates to a composition, wherein the intermediate chain fatty acids are selected from the group consisting of Myristic acid (C14:0), Lauric acid (C12:0), and combinations thereof.

In some embodiments, the present disclosure relates to a composition, wherein the Lauric acid (C12:0) is in an amount of about 4.40% to about 10.0% of the total fatty acids. In some embodiments, the Lauric acid is in an amount of about 4.40% to about 5.40%, about 5.40% to about 6.40%, about 6.40% to about 7.40%, about 7.40% to about 8.40%, about 8.40% to about 9.40%, or about 9.40% to about 10.0% of the total fatty acids, and any value within these ranges. In some embodiments, the Lauric acid is in an amount of about 5.90% of the total fatty acids. In some embodiments, the Lauric acid is in an amount of about 4.40%, about 5.40%, about 5.90%, about 6.40%, about 7.40%, about 8.40%, about 9.40%, or about 10.0% of the total fatty acids, and ranges between any two of these values. In some embodiments, the Lauric acid is in an amount of about 7.65% to about 10.35% of the total fatty acids. In some embodiments, the Lauric acid is in an amount of about 9.00% of the total fatty acids. In some embodiments, the Lauric acid is in an amount of about 5.67% to about 7.67% of the total fatty acids. In some embodiments, the Lauric acid is in an amount of about 6.67% of the total fatty acids.

In some embodiments, the Myristic acid (C14:0) is in an amount of about 3.10% to about 10.0% of the total fatty acids. In some embodiments, the Myristic acid is in an amount of about 3.10% to about 4.10%, about 4.10% to about 5.10%, about 5.10% to about 6.10%, about 6.10% to about 7.10%, about 7.10% to about 8.10%, about 8.10% to about 9.10%, or about 9.10% to about 10.0% of the total fatty acids, and any value within these ranges. In some embodiments, the Myristic acid is in an amount of about 6.61% of the total fatty acids. In some embodiments, the Myristic acid is in an amount of about 3.10%, about 4.10%, about 5.10%, about 6.10%, about 6.61%, about 7.10%, about 8.10%, about 9.10%, or about 10.0% of the total fatty acids, and ranges between any two of these values. In some embodiments, the Myristic acid is in an amount of about 3.94% to about 5.32% of the total fatty acids. In some embodiments, the Myristic acid is in an amount of about 4.63% of the total fatty acids. In some embodiments, the Myristic acid is in an amount of about 3.18% to about 4.30% of the total fatty acids. In some embodiments, the Myristic acid is in an amount of about 3.74% of the total fatty acids.

In some embodiments, the present disclosure relates to a composition, wherein the long chain fatty acids comprise greater than fourteen carbons. In some embodiments, the present disclosure relates to a composition, wherein the long chain fatty acids comprise about 28.88% of the total fatty acids. In some embodiments, the present disclosure relates to a composition, wherein the long chain fatty acids comprise about 24.55% to about 33.21% of the total fatty acids. In some embodiments, the long chain fatty acids comprise about 24.55% to about 26.55%, about 26.55% to about 28.55%, about 28.55% to about 30.55%, about 30.55% to about 32.55%, or about 32.55% to about 33.21% of the total fatty acids, and any value within these ranges. In some embodiments, the long chain fatty acids comprise about 24.55%, about 26.00%, about 27.50%, about 28.88%, about 29.00%, about 30.50%, about 32.00%, or about 33.21% of the total fatty acids, and ranges between any two of these values.

In some embodiments, the present disclosure relates to a composition, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

In some embodiments, the present disclosure relates to a composition, wherein the Pentadecanoic acid (C15:0) is in an amount of about 0.16% to about 0.39% of the total fatty acids. In some embodiments, the Pentadecanoic acid (C15:0) is in an amount of about 0.16% to about 0.20%, about 0.20% to about 0.25%, about 0.25% to about 0.30%, about 0.30% to about 0.35%, or about 0.35% to about 0.39% of the total fatty acids, and any value within these ranges. In some embodiments, the Pentadecanoic acid is in an amount of about 0.28% of the total fatty acids. In some embodiments, the Pentadecanoic acid is in an amount of about 0.16%, about 0.20%, about 0.25%, about 0.28%, about 0.30%, about 0.35%, or about 0.39% of the total fatty acids, and ranges between any two of these values. In some embodiments, the Pentadecanoic acid is in an amount of about 0.14% to about 0.20% of the total fatty acids. In some embodiments, the Pentadecanoic acid is in an amount of about 0.17% of the total fatty acids.

In some embodiments, the present disclosure relates to a composition, wherein the Palmitic acid (C16:0) is in an amount of about 18.67% to about 23.83% of the total fatty acids. In some embodiments, the present disclosure relates to a composition, wherein the Palmitic acid (C16:0) is in an amount of about 18.67% to about 19.67%, about 19.67% to about 20.67%, about 20.67% to about 21.67%, about 21.67% to about 22.67%, or about 22.67% to about 23.83% of the total fatty acids, and any value within these ranges. In some embodiments, the Palmitic acid is in an amount of about 21.47% of the total fatty acids. In some embodiments, the Palmitic acid is in an amount of about 18.67%, about 19.67%, about 20.67%, about 21.47%, about 21.67%, about 22.67%, or about 23.83% of the total fatty acids, and ranges between any two of these values. In some embodiments, the Palmitic acid is in an amount of about 7.29% to about 9.87% of the total fatty acids. In some embodiments, the Palmitic acid is in an amount of about 8.58% of the total fatty acids. In some embodiments, the Palmitic acid is in an amount of about 18.17% to about 24.59% of the total fatty acids; Palmitic acid is in an amount of about 21.38% of the total fatty acids.

In some embodiments, the present disclosure relates to a composition, wherein the Margaric acid (C17:0) is in an amount of about 0.09% to about 0.41% of the total fatty acids. In some embodiments, the Margaric acid (C17:0) is in an amount of about 0.09% to about 0.15%, about 0.15% to about 0.20%, about 0.20% to about 0.25%, about 0.25% to about 0.30%, about 0.30% to about 0.35%, about 0.35% to about 0.41% of the total fatty acids, and any value within these ranges. In some embodiments, the Margaric acid is in an amount of about 0.32% of the total fatty acids. In some embodiments, the Margaric acid is in an amount of about 0.09%, about 0.15%, about 0.20%, about 0.25%, about 0.30%, about 0.32%, about 0.35%, or about 0.41% of the total fatty acids, and ranges between any two of these values. In some embodiments, the Margaric acid is in an amount of about 0.08% to about 0.10% of the total fatty acids. In some embodiments, the Margaric acid is in an amount of about 0.09% of the total fatty acids. In some embodiments, the Margaric acid is in an amount of about 0.20% to about 0.28% of the total fatty acids. In some embodiments, the Margaric acid is in an amount of about 0.24% of the total fatty acids.

In some embodiments, the present disclosure relates to a composition, wherein the Stearic acid (C18:0) is in an amount of about 3.61% to about 10.14% of the total fatty acids. In some embodiments, the Stearic acid is in an amount of about 3.61% to about 4.61%, about 4.61% to about 5.61%, about 5.61% to about 6.61%, about 6.61% to about 7.61%, about 7.61% to about 8.61%, about 8.61% to about 9.61%, or about 9.61% to about 10.14% of the total fatty acids, and any value within these ranges. In some embodiments, the Stearic acid is in an amount of about 6.40% of the total fatty acids. In some embodiments, the Stearic acid is in an amount of about 3.61%, about 4.61%, about 5.61%, about 6.40%, about 6.61%, about 7.61%, about 8.61%, about 9.61%, or about 10.14% of the total fatty acids, and ranges between any two of these values. In some embodiments, the Stearic acid is in an amount of about 2.97% to about 4.51% of the total fatty acids. In some embodiments, the Stearic acid is in an amount of about 3.33% to about 4.51% of the total fatty acids. In some embodiments, the Stearic acid is in an amount of about 3.92% of the total fatty acids. In some embodiments, the Stearic acid is in an amount of about 7.92% to about 10.72% of the total fatty acids. In some embodiments, the Stearic acid is in an amount of about 9.32% of the total fatty acids.

In some embodiments, the present disclosure relates to a composition, wherein the Arachidic acid (C20:0) is in an amount of about 0.19% to about 1.30% of the total fatty acids. In some embodiments, the Arachidic acid is in an amount of about 0.19% to about 0.40%, about 0.40% to about 0.60%, about 0.60% to about 0.80%, about 0.80% to about 1.00%, about 1.00% to about 1.20%, or about 1.20% to about 1.30% of the total fatty acids, and any value within these ranges. In some embodiments, the Arachidic acid is in an amount of about 0.22% of the total fatty acids. In some embodiments, the Arachidic acid is in an amount of about 0.19%, about 0.20%, about 0.22%, about 0.30%, about 0.40%, about 0.05%, about 0.60%, about 0.50%, about 0.80%, about 0.90%, about 1.00%, about 1.10%, about 1.20%, or about 1.30% of the total fatty acids, and ranges between any two of these values. In some embodiments, the Arachidic acid is in an amount of about 0.26% to about 0.36% of the total fatty acids. In some embodiments, the Arachidic acid is in an amount of about 0.31% of the total fatty acids. In some embodiments, the Arachidic acid is in an amount of about 0.67% to about 0.91% of the total fatty acids. In some embodiments, the Arachidic acid is in an amount of about 0.79% of the total fatty acids. In some embodiments, the Behenic acid is in an amount of about 0.41% of the total fatty acids.

In some embodiments, the present disclosure relates to a composition, wherein the Behenic acid (C22:0) is in an amount of about 0.05% to about 0.57% of the total fatty acids. In some embodiments, the Behenic acid is in an amount of about 0.05% to about 0.15%, about 0.15% to about 0.25%, about 0.25% to about 0.35%, about 0.35% to about 0.45%, or about 0.45% to about 0.57% of the total fatty acids, and any value within these ranges. In some embodiments, the Behenic acid is in an amount of about 0.11% of the total fatty acids. In some embodiments, the Behenic acid is in an amount of about 0.05%, about 0.10%, about 0.11%, about 0.15%, about 0.20%, about 0.25%, about 0.30%, about 0.35%, about 0.40%, about 0.45%, about 0.50%, about 0.55%, or about 0.57% of the total fatty acids, and ranges between any two of these values. In some embodiments, the Behenic acid is in an amount of about 0.48% to about 0.66% of the total fatty acids. In some embodiments, the Behenic acid is in an amount of about 0.57% of the total fatty acids. In some embodiments, the Behenic acid is in an amount of about 0.35% to about 0.47% of the total fatty acids. In some embodiments, the Behenic acid is in an amount of about 0.41% of the total fatty acids.

In some embodiments, the present disclosure relates to a composition, wherein the Lignoceric acid (C24:0) is in an amount of about 0.02% to about 0.47% of the total fatty acids. In some embodiments, the Lignoceric acid is in an amount of about 0.02% to about 0.10%, about 0.10% to about 0.20%, about 0.20% to about 0.30%, about 0.30% to about 0.40%, or about 0.40% to about 0.47% of the total fatty acids, and any value within these ranges. In some embodiments, the Lignoceric acid is in an amount of about 0.08% of the total fatty acids. In some embodiments, the Lignoceric acid is in an amount of about 0.02%, about 0.04%, about 0.06%, about 0.08%, about 0.10%, about 0.15%, about 0.20%, about 0.25%, about 0.30%, about 0.35%, about 0.40%, about 0.45%, or about 0.47% of the total fatty acids, and ranges between any two of these values. In some embodiments, the Lignoceric acid is in an amount of about 0.18% to about 0.24% of the total fatty acids. In some embodiments, the Lignoceric acid is in an amount of about 0.21% of the total fatty acids. In some embodiments, the Lignoceric acid is in an amount of about 0.34% to about 0.46% of the total fatty acids. In some embodiments, the Lignoceric acid is in an amount of about 0.40% of the total fatty acids.

In some embodiments, the present disclosure relates to a composition, wherein the unsaturated fatty acids are selected from the group consisting of monounsaturated fatty acids, polyunsaturated fatty acids, and combinations thereof. In some embodiments, the present disclosure relates to a composition, wherein the monounsaturated fatty acids comprise about 45.5% of the total fatty acids. In some embodiments, the present disclosure relates to a composition, wherein the monounsaturated fatty acids comprise about 38.68% to about 52.33% of the total fatty acids. In some embodiments, the monounsaturated fatty acids comprise about 38.68% to about 40.68%, about 40.68% to about 42.68%, about 42.68% to about 44.68%, about 44.68% to about 46.68%, about 46.68% to about 48.68%, about 48.68% to about 50.68%, or about 50.68% to about 52.33% of the total fatty acids, and any value within these ranges. In some embodiments, the monounsaturated fatty acids comprise about 38.68%, about 40.68%, about 42.68%, about 44.68%, about 45.55%, about 46.68%, about 48.68%, about 50.68%, or about 52.33% of the total fatty acids, and ranges between any two of these values.

In some embodiments, the present disclosure relates to a composition, wherein the fatty acids are monounsaturated fatty acids are selected from the group consisting of Myristoleic acid (C14:1), Palmitoleic acid (C16:1), Oleic acid (C18:1n9), Gadoleic acid (C20:1), and combinations thereof.

In some embodiments, the present disclosure relates to a composition, wherein the Myristoleic acid (C14:1) is in an amount of about 0.11% to about 0.50% of the total fatty acids. In some embodiments, the Myristoleic acid is in an amount of about 0.11% to about 0.20%, about 0.20% to about 0.30%, about 0.30% to about 0.40%, or about 0.40% to about 0.50% of the total fatty acids, and any value within these ranges. In some embodiments, the Myristoleic acid is in an amount of about 0.22% of the total fatty acids. In some embodiments, the Myristoleic acid is in an amount of about 0.11%, about 0.15%, about 0.20%, about 0.22%, about 0.25%, about 0.30%, about 0.35%, about 0.40%, about 0.45%, or about 0.50% of the total fatty acids, and ranges between any two of these values. In some embodiments, the Myristoleic acid is in an amount of about 0.09% to about 0.12% of the total fatty acids. In some embodiments, the Myristoleic acid is in an amount of about 0.10% of the total fatty acids. In some embodiments, the Myristoleic acid is in an amount of about 0.09% to about 0.13% of the total fatty acids. In some embodiments, the Myristoleic acid is in an amount of about 0.11% of the total fatty acids.

In some embodiments, the present disclosure relates to a composition, wherein the Palmitoleic acid (C16:1) is in an amount of about 0.25% to about 2.70% of the total fatty acids. In some embodiments, the Palmitoleic acid is in an amount of about 0.25% to about 0.70%, about 0.70% to about 1.15%, about 1.15% to about 1.60%, about 1.60% to about 2.05%, or about 2.05% to about 2.70% of the total fatty acids, and any value within these ranges. In some embodiments, the Palmitoleic acid is in an amount of about 2.36% of the total fatty acids. In some embodiments, the Palmitoleic acid is in an amount of about 0.25%, about 0.50%, about 0.70%, about 0.75%, about 1.00%, about 1.15%, about 1.25%, about 1.50%, about 1.60%, about 1.75%, about 2.0%, about 2.05%, about 2.25%, about 2.36%, about 2.50%, about 2.60%, or about 2.70% of the total fatty acids, and ranges between any two of these values. In some embodiments, the Palmitoleic acid is in an amount of about 0.20% to about 0.28% of the total fatty acids. In some embodiments, the Palmitoleic acid is in an amount of about 0.24% of the total fatty acids. In some embodiments, the Palmitoleic acid is in an amount of about 1.42% to about 1.92% of the total fatty acids. In some embodiments, the Palmitoleic acid is in an amount of about 1.67% of the total fatty acids.

In some embodiments, the present disclosure relates to a composition, wherein the Oleic acid (C18:1n9) is in an amount of about 26.20% to about 51.00% of the total fatty acids. In some embodiments, the Oleic acid is in an amount of about 26.20% to about 31.20%, about 31.20% to about 36.20%, about 36.20% to about 41.20%, about 41.20% to about 46.20%, or about 46.20% to about 51.00% of the total fatty acids, and any value within these ranges. In some embodiments, the Oleic acid is in an amount of about 42.38% of the total fatty acids. In some embodiments, the Oleic acid is in an amount of about 26.20%, about 31.20%, about 36.20%, about 41.20%, about 42.38%, about 46.20%, about 48.00%, or about 51.00% of the total fatty acids, and ranges between any two of these values. In some embodiments, the Oleic acid is in an amount of about 46.58% to about 63.02% of the total fatty acids. In some embodiments, the Oleic acid is in an amount of about 54.80% of the total fatty acids. In some embodiments, the Oleic acid is in an amount of about 38.27% to about 51.78% of the total fatty acids. In some embodiments, the Oleic acid is in an amount of about 45.02% of the total fatty acids.

In some embodiments, the present disclosure relates to a composition, wherein the Gadoleic acid (C20:1) is in an amount of about 0.08% to about 0.60% of the total fatty acids. In some embodiments, the Gadoleic acid is in an amount of about 0.08% to about 0.18%, about 0.18% to about 0.28%, about 0.28% to about 0.38%, about 0.38% to about 0.48%, or about 0.48% to about 0.60% of the total fatty acids, and any value within these ranges. In some embodiments, the Gadoleic acid is in an amount of about 0.45% of the total fatty acids. In some embodiments, the Gadoleic acid is in an amount of about 0.08%, about 0.10%, about 0.18%, about 0.22%, about 0.28%, about 0.32%, about 0.38%, about 0.42%, about 0.45%, about 0.48%, about 0.52%, about 0.58%, or about 0.60% of the total fatty acids, and ranges between any two of these values. In some embodiments, the Gadoleic acid is in an amount of about 0.31% to about 0.43% of the total fatty acids. In some embodiments, the Gadoleic acid is in an amount of about 0.37% of the total fatty acids. In some embodiments, the Gadoleic acid is in an amount of about 0.32% to about 0.44% of the total fatty acids. In some embodiments, the Gadoleic acid is in an amount of about 0.38% of the total fatty acids.

In some embodiments, the present disclosure relates to a composition, wherein the composition comprises less than about 0.10% Erucic acid (C22:1). In some embodiments, the present disclosure relates to a composition, wherein the composition comprises less than about 0.10%, about 0.09%, about 0.08%, about 0.07%, about 0.06%, about 0.05%, about 0.04%, about 0.03%, about 0.02%, about 0.01%, or about 0% Erucic acid, and any value within these ranges. In some embodiments, the Erucic acid is in an amount of about 0.10%, about 0.09%, about 0.08%, about 0.07%, about 0.06%, about 0.05%, about 0.04%, about 0.03%, about 0.02%, about 0.01%, or about 0%, and ranges between any two of these values. In some embodiments, the composition is free of Erucic acid. In some embodiments, the composition comprises substantially no Erucic acid.

In some embodiments, the present disclosure relates to a composition, wherein the composition comprises less than about 0.22% Nervonic acid (C24:1). In some embodiments, the present disclosure relates to a composition, wherein the composition comprises less than about 0.22%, about 0.21%, about 0.20%, about 0.19%, about 0.18%, about 0.17%, about 0.16%, about 0.15%, about 0.14%, about 0.13%, about 0.12%, about 0.11%, about 0.10%, about 0.09%, about 0.08%, about 0.07%, about 0.06%, about 0.05%, about 0.04%, about 0.03%, about 0.02%, about 0.01%, or about 0% Nervonic acid, and any value within these ranges. In some embodiments, the Nervonic acid is in an amount of about 0.09% of the total fatty acids. In some embodiments, the Nervonic acid is in an amount of about 0.22%, about 0.21%, about 0.20%, about 0.19%, about 0.18%, about 0.17%, about 0.16%, about 0.15%, about 0.14%, about 0.13%, about 0.12%, about 0.11%, about 0.10%, about 0.09%, about 0.08%, about 0.07%, about 0.06%, about 0.05%, about 0.04%, about 0.03%, about 0.02%, about 0.01%, or about 0% of the total fatty acids. In some embodiments, Nervonic acid in an amount of less than about 0.04% of the total fatty acids. In some embodiments, Nervonic acid in an amount of about 0.04% of the total fatty acids.

In some embodiments, the present disclosure relates to a composition, wherein the polyunsaturated fatty acids comprise about 8.5% of the total fatty acids. In some embodiments, the present disclosure relates to a composition, wherein the polyunsaturated fatty acids comprise about 7.23% to about 9.78% of the total fatty acids. In some embodiments, the polyunsaturated fatty acids comprise about 7.23% to about 7.73%, about 7.73% to about 8.23%, about 8.23% to about 8.73%, about 8.73% to about 9.23%, or about 9.23% to about 9.78% of the total fatty acids, and any value within these ranges. In some embodiments, the polyunsaturated fatty acids comprise about 7.23%, about 7.73%, about 8.23%, about 8.5%, about 8.73%, about 9.23%, or about 9.78% of the total fatty acids, and ranges between any two of these values.

In some embodiments, the present disclosure relates to an oil, wherein the fatty acids are polyunsaturated fatty acids are selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

In some embodiments, the present disclosure relates to a composition, wherein the Linoleic acid (C18:2n6) is in an amount of about 5.85% to about 9.00% of the total fatty acids. In some embodiments, the Linoleic acid is in an amount of about 5.85% to about 6.35%, about 6.35% to about 6.85%, about 6.85% to about 7.35%, about 7.35% to about 7.85%, about 7.85% to about 8.35%, about 8.35% to about 8.85%, or about 8.85% to about 9.00% of the total fatty acids, and any value within these ranges. In some embodiments, the Linoleic acid is in an amount of about 6.20% of the total fatty acid. In some embodiments, the Linoleic acid is in an amount of about 5.85%, about 6.20%, about 6.35%, about 6.85%, about 7.35%, about 7.85%, about 8.35%, about 8.85%, or about 9.00% of the total fatty acids, and ranges between any two of these values. In some embodiments, the Linoleic acid is in an amount of about 7.60% to about 10.27% of the total fatty acids. In some embodiments, the Linoleic acid is in an amount of about 8.93% of the total fatty acids. In some embodiments, the Linoleic acid is in an amount of about 5.58% to about 7.54% of the total fatty acids. In some embodiments, the Linoleic acid is in an amount of about 6.56% of the total fatty acids.

In some embodiments, the present disclosure relates to a composition, wherein the Linolenic acid (C18:3n3) is in an amount of about 0.89% to about 2.07% of the total fatty acids. In some embodiments, the Linolenic acid is in an amount of about 0.89% to about 1.09%, about 1.09% to about 1.29%, about 1.29% to about 1.49%, about 1.49% to about 1.69%, about 1.69% to about 1.89%, or about 1.89% to about 2.07% of the total fatty acids, and any value within these ranges. In some embodiments, the Linolenic acid is in an amount of about 1.02% of the total fatty acids. In some embodiments, the Linolenic acid is in an amount of about 0.89%, about 1.02%, about 1.09%, about 1.15%, about 1.29%, about 1.39%, about 1.49%, about 1.59%, about 1.69%, about 1.79%, about 1.89%, about 1.99%, or about 2.07% of the total fatty acids, and ranges between any two of these values. In some embodiments, the Linolenic acid is in an amount of about 1.59% to about 2.15% of the total fatty acids. In some embodiments, the Linolenic acid is in an amount of about 1.87% of the total fatty acids. In some embodiments, the Linolenic acid is in an amount of about 1.11% to about 1.50% of the total fatty acids. In some embodiments, the Linolenic acid is in an amount of about 1.30% of the total fatty acids.

In some embodiments, the present disclosure relates to a composition, wherein Arachidonic acid (C20:4n6) is in an amount of about 0.60% to about 0.66% of the total fatty acids. In some embodiments, the Arachidonic acid is in an amount of about 0.60% to about 0.61%, about 0.61% to about 0.62%, about 0.62% to about 0.63%, about 0.63% to about 0.64%, about 0.64% to about 0.65%, or about 0.65% to about 0.66% of the total fatty acids, and any value within these ranges. In some embodiments, the Arachidonic acid is in an amount of about 0.63% of the total fatty acids. In some embodiments, the Arachidonic acid is in an amount of about 0.60%, about 0.61%, about 0.62%, about 0.63%, about 0.64%, about 0.65%, or about 0.66% of the total fatty acids, and ranges between any two of these values. In some embodiments, the Arachidonic acid is in an amount of about 0.54% to about 0.73% of the total fatty acids. In some embodiments, the Arachidonic acid is in an amount of about 0.63% of the total fatty acids. In some embodiments, the Arachidonic acid is in an amount of about 0.54% to about 0.73% of the total fatty acids. In some embodiments, the Arachidonic acid in an amount of about 0.63% of the total fatty acids.

In some embodiments, the present disclosure relates to a composition, wherein the Eicosapentaenoic acid (C20:5n3) is in an amount of about 0.06% to about 0.26% of the total fatty acids. In some embodiments, the Eicosapentaenoic acid is in an amount of about 0.06% to about 0.10%, about 0.10% to about 0.14%, about 0.14% to about 0.18%, about 0.18% to about 0.22%, or about 0.22% to about 0.26% of the total fatty acids, and any value within these ranges. In some embodiment, the Eicosapentaenoic acid is in an amount of about 0.11% of the total fatty acids. In some embodiments, the Eicosapentaenoic acid is in an amount of about 0.06%, about 0.7%, about 0.8%, about 0.9%, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, or about 0.26% of the total fatty acids, and ranges between any two of these values. In some embodiments, the Eicosapentaenoic acid is in an amount of about 0.07% to about 0.09% of the total fatty acids. In some embodiments, the Eicosapentaenoic acid is in an amount of about 0.08% of the total fatty acids. In some embodiments, the Eicosapentaenoic acid is in an amount of about 0.07% to about 0.09% of the total fatty acids. In some embodiments, the Eicosapentaenoic acid is in an amount of about 0.08% of the total fatty acids.

In some embodiments, the present disclosure relates to a composition, wherein the Docosapentaenoic acid (C22:5n3) is in an amount of about 0.04% to about 0.29% of the total fatty acids. In some embodiments, the Docosapentaenoic acid is in an amount of about 0.04% to about 0.09%, about 0.09% to about 0.14%, about 0.14% to about 0.19%, about 0.19% to about 0.24%, or about 0.24% to about 0.29% of the total fatty acids, and any value within these ranges. In some embodiments, the Docosapentaenoic acid is in an amount of about 0.17% of the total fatty acids. In some embodiments, the Docosapentaenoic acid is in an amount of about 0.04%, about 0.7%, about 0.09%, about 0.11%, about 0.14%, about 0.17%, about 0.19%, about 0.21%, about 0.24%, about 0.27%, or about 0.29% of the total fatty acids, and ranges between any two of these values. In some embodiments, the Docosapentaenoic acid is in an amount of about 0.03% to about 0.05% of the total fatty acids. In some embodiments, the Docosapentaenoic acid is in an amount of about 0.04% of the total fatty acids.

In some embodiments, the present disclosure relates to a composition, wherein the Docosahexaenoic acid (C22:6n3) is in an amount of about 0.35% to about 0.39% of the total fatty acids. In some embodiments, the Docosahexaenoic acid is in an amount of about 0.35% to about 0.36%, about 0.36% to about 0.37%, about 0.37% to about 0.38%, or about 0.38% to about 0.39% of the total fatty acids, and any value within these ranges. In some embodiments, the Docosahexaenoic acid is in an amount of about 0.37% of the total fatty acids. In some embodiments, the Docosahexaenoic acid is in an amount of about 0.35%, about 0.36%, about 0.37%, about 0.38%, or about 0.39% of the total fatty acids, and ranges between any two of these values. In some embodiments, the Docosahexaenoic acid is in an amount of about 0.31% to about 0.43% of the total fatty acids. In some embodiments, the Docosahexaenoic acid is in an amount of about 0.37% of the total fatty acids.

In some embodiments, the present disclosure relates to a composition, comprising Palmitic acid (C16:0), Linoleic acid (C18:2n6), Arachidonic acid (C20:4n6), Docosahexaenoic acid (C22:6n3), or combinations thereof.

In some embodiments, the present disclosure relates to a composition, comprising Palmitic acid (C16:0), Linoleic acid (C18:2n6), Arachidonic acid (C20:4n6), and Docosahexaenoic acid (C22:6n3).

In some embodiments, the present disclosure relates to a composition, wherein the composition comprises essentially no Erucic acid (C22:1). In some embodiments, the present disclosure relates to a composition, wherein the composition is free of Erucic acid (C22:1).

In some embodiments, the present disclosure relates to a composition, comprising Butyric acid (C4:0), Caproic acid (C6:0), Caprylic acid (C8:0), Capric acid (C10:0), Lauric acid (C12:0), Myristic acid (C14:0), Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), Myristoleic acid (C14:1), Palmitoleic acid (C16:1), Oleic acid (C181n9), Gadoleic acid (C20:1), Nervonic acid (C24:1), Linoleic acid (C18:2n6), Linolenic acid (C18:3n3), Arachidonic acid (C20:4n6), Eicosapentaenoic acid (C20:5n3), Docosapentaenoic acid (C22:5n3), and Docosahexaenoic acid (C22:6n3); and wherein the composition optionally further comprises Erucic acid (C22:1), Nervonic acid (C24:1), and combinations thereof.

In some embodiments, the present disclosure relates to a composition, comprising Butyric acid in an amount of about 0% to about 0.39% of the total fatty acids; Caproic acid in an amount of about 0.05% to about 0.39% of the total fatty acids; Caprylic acid in an amount of about 0.11% to about 1.68% of the total fatty acids; Capric acid in an amount of about 0.28% to about 2.00% of the total fatty acids; Lauric acid in an amount of about 4.40% to about 10.0% of the total fatty acids; Myristic acid in an amount of about 3.10% to about 10.0% of the total fatty acids; Pentadecanoic acid in an amount of about 0.16% to about 0.39% of the total fatty acids; Palmitic acid in an amount of about 18.67% to about 23.83% of the total fatty acids; Margaric acid in an amount of about 0.09% to about 0.41% of the total fatty acids; Stearic acid in an amount of about 3.61% to about 10.14% of the total fatty acids; Arachidic acid in an amount of about 0.19% to about 1.30% of the total fatty acids; Behenic acid in an amount of about 0.05% to about 0.57% of the total fatty acids; Lignoceric acid in an amount of about 0.02% to about 0.47% of the total fatty acids; Myristoleic acid in an amount of about 0.11% to about 0.50% of the total fatty acids; Palmitoleic acid in an amount of about 0.25% to about 2.70% of the total fatty acids; Oleic acid in an amount of about 26.20% to about 51.00% of the total fatty acids; Gadoleic acid in an amount of about 0.08% to about 0.60% of the total fatty acids; Erucic acid in an amount of less than about 0.10% of the total fatty acids; Nervonic acid in an amount of less than about 0.22% of the total fatty acids; Linoleic acid in an amount of about 5.85% to about 9.00% of the total fatty acids; Linolenic acid in an amount of about 0.89% to about 2.07% of the total fatty acids; Arachidonic acid in an amount of about 0.60% to about 0.66% of the total fatty acids; Eicosapentaenoic acid in an amount of about 0.06% to about 0.26% of the total fatty acids; Docosapentaenoic acid in an amount of about 0.04% to about 0.29% of the total fatty acids; and Docosahexaenoic acid in an amount of about 0.35% to about 0.39% of the total fatty acids.

In some embodiments, the present disclosure relates to a composition, comprising Butyric acid in an amount of about 0.35% of the total fatty acids; Caproic acid in an amount of about 0.14% of the total fatty acids; Caprylic acid in an amount of about 0.21% of the total fatty acids; Capric acid in an amount of about 1.57% of the total fatty acids; Lauric acid in an amount of about 5.90% of the total fatty acids; Myristic acid in an amount of about 6.61% of the total fatty acids; Pentadecanoic acid in an amount of about 0.28% of the total fatty acids; Palmitic acid in an amount of about 21.47% of the total fatty acids; Margaric acid in an amount of about 0.32% of the total fatty acids; Stearic acid in an amount of about 6.40% of the total fatty acids; Arachidic acid in an amount of about 0.22% of the total fatty acids; Behenic acid in an amount of about 0.11% of the total fatty acids; Lignoceric acid in an amount of about 0.08% of the total fatty acids; Myristoleic acid in an amount of about 0.22% of the total fatty acids; Palmitoleic acid in an amount of about 2.36% of the total fatty acids; Oleic acid in an amount of about 42.38% of the total fatty acids; Gadoleic acid in an amount of about 0.45% of the total fatty acids; Erucic acid in an amount of about 0% of the total fatty acids; Nervonic acid in an amount of about 0.09% of the total fatty acids; Linoleic acid in an amount of about 6.20% of the total fatty acids; Linolenic acid in an amount of about 1.02% of the total fatty acids; Arachidonic acid in an amount of about 0.63% of the total fatty acids; Eicosapentaenoic acid in an amount of about 0.11% of the total fatty acids; Docosapentaenoic acid in an amount of about 0.17% of the total fatty acids; and Docosahexaenoic acid in an amount of about 0.37% of the total fatty acids.

In some embodiments, the present disclosure relates to a composition, wherein the ratio of Arachidonic acid to Docosahexaenoic acid is about 1.4:1 to about 2:1. In some embodiments, the ratio of Arachidonic acid to Docosahexaenoic acid is about 1.7:1. In some embodiments, the ratio of Arachidonic acid to Docosahexaenoic acid is about 1.4:1, about 1.5:1, about 1.6:1, about 1.7:1, about 1.8:1, about 1.9:1, or about 2:1, and any range between any two of these values. In some embodiments, the ratio is about 4.5:1 to about 8.5:1, about 5:1 to about 8:1, about 5.5:1 to about 7.5:1, about 6:1 to about 7:1, or about 6.5:1 to about 6.5:1. In some embodiments, the ratio is about 3.5:1 to about 2.5:1, about 3:1 to about 2:1, or about 2.5:1 to about 1.5:1, and any value within these ranges.

In some embodiments, the present disclosure relates to a composition, wherein the ratio of Eicosapentaenoic acid to Docosahexaenoic acid is about 0.2:1 to about 0.8:1. In some embodiments, the present disclosure relates to a composition, wherein the ratio of Eicosapentaenoic acid to Docosahexaenoic acid is about 0.3:1. In some embodiments, the ratio of Eicosapentaenoic acid to Docosahexaenoic acid is about 0.2:1, about 0.3:1, about 0.4:1, about 0.5:1, about 0.6:1, about 0.7:1, or about 0.8:1, and any range between any two of these values. In some embodiments, the ratio is about 0.25:1 to about 0.75:1, about 0.3:1 to about 0.7:1, about 0.35:1 to about 0.65:1, about 0.4:1 to about 0.6:1, or about 0.45:1 to about 0.55:1, and any value within these ranges.

In some embodiments, the present disclosure relates to a composition, wherein the ratio of Linoleic acid to alpha-Linolenic acid is about 4:1 to about 20:1. In some embodiments, the present disclosure relates to a composition, wherein the ratio of Linoleic acid to alpha-Linolenic acid is about 4:1 to about 15:1. In some embodiments, the present disclosure relates to a composition, wherein the ratio of Linoleic acid to alpha-Linolenic acid is about 4:1 to about 9:1. In some embodiments, the present disclosure relates to a composition, wherein the ratio of Linoleic acid to alpha-Linolenic acid is about 6.1:1. In some embodiments, the ratio of Linoleic acid to alpha-Linolenic acid is about 4:1, about 4.5:1, about 5:1, about 5.5:1, about 6:1, about 6.1:1, about 6.5:1, about 7:1, about 7.5:1, about 8:1, about 8.5:1, or about 9:1, or about 15:1, or about 20:1, and ranges between any two of these values. In some embodiments, the ratio is about 4.5:1 to about 8.5:1, about 5:1 to about 8:1, about 5.5:1 to about 7.5:1, about 6:1 to about 7:1, or about 6:1 to about 6.5:1, and any value within these ranges.

In some embodiments, the present disclosure relates to a composition, wherein the polyunsaturated fatty acids comprise n-6 fatty acids, n-3 fatty acids, and combinations thereof. In some embodiments, the present disclosure relates to a composition, wherein the ratio of n-6 fatty acids to n-3 fatty acids is about 4.1:1. In some embodiments, the ratio of n-6 fatty acids to n-3 fatty acids is about 3.49:1, about 3.57:1, about 3.65:1, about 3.73:1, about 3.81:1, about 3.89:1, about 3.97:1, about 4.05:1, about 4.1:1, about 4.15:1, about 4.23:1, about 4.31:1, about 4.39:1, about 4.47:1, about 4.55:1, about 4.63:1, or about 4.71:1, and ranges between any two of these values. In some embodiments, the ratio is about 3.49:1 to about 4.71:1, about 3.65:1 to about 4.55:1, about 3.81:1 to about 4.39:1, about 3.97:1 to about 4.23:1, or about 4.05:1 to about 4.15:1, and any value within these ranges.

Embodiments of the present disclosure relate to compositions comprising fatty acids, wherein the composition comprises saturated fatty acids, unsaturated fatty acids, and combinations thereof; and wherein the saturated fatty acids are selected from the group consisting of short/medium chain fatty acids comprising less than twelve carbons, intermediate chain fatty acids comprising twelve to fourteen carbons, long chain fatty acids comprising greater than fourteen carbons, and combinations thereof; and wherein the unsaturated fatty acids are selected from the group consisting of monounsaturated fatty acids, polyunsaturated fatty acids, and combinations thereof.

In some embodiments, the present disclosure relates to a composition, wherein the short/medium chain saturated fatty acids comprise about 3.87% of the total fatty acids. In some embodiments, the short/medium chain saturated fatty acids comprise about 3.29%, about 3.36%, about 3.43%, about 3.50%, about 3.57%, about 3.64%, about 3.71%, about 3.78%, about 3.85%, about 3.87%, about 3.92%, about 3.99%, about 4.06%, about 4.13%, about 4.20%, about 4.27%, about 4.34%, or about 4.45% of the total fatty acids, and ranges between any two of these values. In some embodiments, the short/medium chain saturated fatty acids comprise about 3.29% to about 4.45%, about 3.29% to about 3.75%, about 3.75% to about 4.25%, about 4.25% to about 4.45%, and any value within these ranges.

In some embodiments, the present disclosure relates to a composition, wherein the intermediate chain fatty acids comprise about 13.63% of the total fatty acids. In some embodiments, the intermediate chain fatty acids comprise about 11.59%, about 11.93%, about 12.27%, about 12.61%, about 12.95%, about 13.29%, about 13.63%, about 13.97%, about 14.31%, about 14.65%, about 14.99%, about 15.33%, or about 15.67% of the total fatty acids, and ranges between any two of these values. In some embodiments, the intermediate chain fatty acids comprise about 11.58% to about 15.68%, about 11.58% to about 12%, about 12% to about 13%, about 13% to about 14%, about 14% to about 15%, about 15% to about 15.68% of the total fatty acids, and any value within these ranges.

In some embodiments, the present disclosure relates to a composition, wherein the long chain fatty acids comprise about 13.85% of the total fatty acids. In some embodiments, the long chain fatty acids comprise about 11.77%, about 12.01%, about 12.25%, about 12.49%, about 12.73%, about 12.97%, about 13.21%, about 13.45%, about 13.69%, about 13.85%, about 14.01%, about 14.25%, about 14.49%, about 14.73%, about 14.97%, about 15.21%, or about 15.45% of the total fatty acids, and ranges between any two of these values. In some embodiments, the long chain fatty acids comprise about 11.77% to about 15.45%, about 11.77% to about 12%, about 12% to about 13%, about 13% to about 14%, about 14% to about 15%, about 15% to about 15.45% of the total fatty acids, and any value within these ranges.

In some embodiments, the present disclosure relates to a composition, wherein the monounsaturated fatty acids comprise about 55.56% of the total fatty acids. In some embodiments, the monounsaturated fatty acids comprise about 47.22%, about 48.56%, about 49.90%, about 51.24%, about 52.58%, about 53.92%, about 55.26%, about 56.60%, about 57.94%, about 59.28%, about 60.62%, about 61.96%, about 63.30%, or about 63.90% of the total fatty acids, and ranges between any two of these values. In some embodiments, the monounsaturated fatty acids comprise about 47.22% to about 63.90%, about 47.22% to about 48%, about 48% to about 50%, about 50% to about 52%, about 52% to about 54%, about 54% to about 56%, about 56% to about 58%, about 58% to about 60%, about 60% to about 62%, about 62% to about 64% of the total fatty acids, any value within these ranges.

In some embodiments, the present disclosure relates to a composition, wherein the polyunsaturated fatty acids comprise about 11.92% of the total fatty acids. In some embodiments, the polyunsaturated fatty acids comprise about 10.13%, about 10.37%, about 10.61%, about 10.85%, about 11.09%, about 11.33%, about 11.57%, about 11.81%, about 11.92%, about 12.05%, about 12.29%, about 12.53%, about 12.77%, about 13.01%, about 13.25%, about 13.49%, or about 13.71% of the total fatty acids, and ranges between any two of these values. In some embodiments, the polyunsaturated fatty acids comprise about 10.13% to about 13.71%, about 10.13% to about 10.5%, about 10.5% to about 11%, about 11% to about 11.5%, about 11.5% to about 12%, about 12% to about 12.5%, about 12.5% to about 13%, about 13% to about 13.5%, about 13.5% to about 13.71% of the total fatty acids, and any value within these ranges.

In some embodiments, the present disclosure relates to a composition, comprising Butyric acid in an amount of about 0.31% to about 0.42% of the total fatty acids; Caproic acid in an amount of about 0.31% to about 0.43% of the total fatty acids; Caprylic acid in an amount of about 1.44% to about 1.94% of the total fatty acids; Capric acid in an amount of about 1.23% to about 1.67% of the total fatty acids; Lauric acid in an amount of about 7.65% to about 10.35% of the total fatty acids; Myristic acid in an amount of about 3.94% to about 5.32% of the total fatty acids; Pentadecanoic acid in an amount of about 0.14% to about 0.20% of the total fatty acids; Palmitic acid in an amount of about 7.29% to about 9.87% of the total fatty acids; Margaric acid in an amount of about 0.08% to about 0.10% of the total fatty acids; Stearic acid in an amount of about 2.97% to about 4.51% of the total fatty acids; Arachidic acid in an amount of about 0.26% to about 0.36% of the total fatty acids; Behenic acid in an amount of about 0.48% to about 0.66% of the total fatty acids; Lignoceric acid in an amount of about 0.18% to about 0.24% of the total fatty acids; Myristoleic acid in an amount of about 0.09% to about 0.12% of the total fatty acids; Palmitoleic acid in an amount of about 0.20% to about 0.28% of the total fatty acids; Oleic acid in an amount of about 46.58% to about 63.02% of the total fatty acids; Gadoleic acid in an amount of about 0.31% to about 0.43% of the total fatty acids; Erucic acid in an amount of less than about 0.01% of the total fatty acids; Nervonic acid in an amount of less than about 0.05% of the total fatty acids; Linoleic acid in an amount of about 7.60% to about 10.27% of the total fatty acids; Linolenic acid in an amount of about 1.59% to about 2.15% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; and Docosahexaenoic acid in an amount of about 0.31% to about 0.43% of the total fatty acids.

In some embodiments, the present disclosure relates to a composition, comprising Butyric acid in an amount of about 0.36% of the total fatty acids; Caproic acid in an amount of about 0.37% of the total fatty acids; Caprylic acid in an amount of about 1.69% of the total fatty acids; Capric acid in an amount of about 1.45% of the total fatty acids; Lauric acid in an amount of about 9.00% of the total fatty acids; Myristic acid in an amount of about 4.63% of the total fatty acids; Pentadecanoic acid in an amount of about 0.17% of the total fatty acids; Palmitic acid in an amount of about 8.58% of the total fatty acids; Margaric acid in an amount of about 0.09% of the total fatty acids; Stearic acid in an amount of about 3.92% of the total fatty acids; Arachidic acid in an amount of about 0.31% of the total fatty acids; Behenic acid in an amount of about 0.57% of the total fatty acids; Lignoceric acid in an amount of about 0.21% of the total fatty acids; Myristoleic acid in an amount of about 0.10% of the total fatty acids; Palmitoleic acid in an amount of about 0.24% of the total fatty acids; Oleic acid in an amount of about 54.80% of the total fatty acids; Gadoleic acid in an amount of about 0.37% of the total fatty acids; Erucic acid in an amount of about 0.01% of the total fatty acids; Nervonic acid in an amount of about 0.04% of the total fatty acids; Linoleic acid in an amount of about 8.93% of the total fatty acids; Linolenic acid in an amount of about 1.87% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; and Docosahexaenoic acid in an amount of about 0.37% of the total fatty acids.

In some embodiments, the present disclosure relates to a composition, wherein the ratio of Arachidonic acid to Docosahexaenoic acid is about 1.7:1. In some embodiments, the ratio of Arachidonic acid to Docosahexaenoic acid is about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, or about 0.22:1, and any range between these values. In some embodiments, the ratio of Arachidonic acid to Docosahexaenoic acid is about 1.5:1 to about 0.5:1, about 1.3:1 to about 0.7:1, about 1.1:1 to about 0.9:1, or about 1:1 to about 0.8:1, and any value between these ranges.

In some embodiments, the present disclosure relates to a composition, wherein the ratio of Eicosapentaenoic acid to Docosahexaenoic acid is about 0.22:1. In some embodiments, the ratio of Eicosapentaenoic acid to Docosahexaenoic acid is about 0.19:1, about 0.20:1, about 0.21:1, about 0.22:1, about 0.23:1, about 0.24:1, about 0.25:1, about 0.26:1, about 0.27:1, about 0.28:1, about 0.29:1, about 0.30:1, about 0.31:1, about 0.32:1, about 0.33:1, about 0.34:1, about 0.35:1, or about 0.36:1, and any range between these values. In some embodiments, the ratio of Eicosapentaenoic acid to Docosahexaenoic acid is about 0.19:1 to about 0.20:1, about 0.20:1 to about 0.21:1, about 0.21:1 to about 0.22:1, about 0.22:1 to about 0.23:1, about 0.23:1 to about 0.24:1, about 0.24:1 to about 0.25:1, about 0.25:1 to about 0.26:1, about 0.26:1 to about 0.27:1, about 0.27:1 to about 0.28:1, about 0.28:1 to about 0.29:1, about 0.29:1 to about 0.30:1, about 0.30:1 to about 0.31:1, about 0.31:1 to about 0.32:1, about 0.32:1 to about 0.33:1, about 0.33:1 to about 0.34:1, or about 0.34:1 to about 0.35:1, and any ratio within these ranges.

In some embodiments, the present disclosure relates to a composition, wherein the ratio of Linoleic acid to alpha-Linolenic acid is about 4.78:1. In some embodiments, the ratio of Linoleic acid to alpha-Linolenic acid is about 4.06:1, about 4.15:1, about 4.24:1, about 4.33:1, about 4.42:1, about 4.51:1, about 4.60:1, about 4.69:1, about 4.78:1, about 4.87:1, about 4.96:1, about 5.05:1, about 5.14:1, about 5.23:1, about 5.32:1, about 5.41:1, or about 5.50:1, and any range between these values. In some embodiments, the ratio of Linoleic acid to alpha-Linolenic acid is about 4.06:1 to about 4.20:1, about 4.20:1 to about 4.34:1, about 4.34:1 to about 4.48:1, about 4.48:1 to about 4.62:1, about 4.62:1 to about 4.76:1, about 4.76:1 to about 4.90:1, about 4.90:1 to about 5.04:1, about 5.04:1 to about 5.18:1, about 5.18:1 to about 5.32:1, about 5.32:1 to about 5.46:1, or about 5.46:1 to about 5.50:1, and any ratio between these ranges.

In some embodiments, the present disclosure relates to a composition, wherein the polyunsaturated fatty acids comprise n-6 fatty acids, n-3 fatty acids, and combinations thereof. In some embodiments, the present disclosure relates to a composition, wherein the ratio of n-6 fatty acids to n-3 fatty acids is about 4.05:1. In some embodiments, the ratio of n-6 fatty acids to n-3 fatty acids is about 3.44:1, about 3.52:1, about 3.60:1, about 3.68:1, about 3.76:1, about 3.84:1, about 3.92:1, about 4.00:1, about 4.05:1, about 4.08:1, about 4.16:1, about 4.24:1, about 4.32:1, about 4.40:1, about 4.48:1, about 4.56:1, or about 4.66:1, and any ratio between these values. In some embodiments, the ratio of n-6 fatty acids to n-3 fatty acids is about 3.44:1 to about 3.58:1, about 3.58:1 to about 3.72:1, about 3.72:1 to about 3.86:1, about 3.86:1 to about 4.00:1, about 4.00:1 to about 4.14:1, about 4.14:1 to about 4.28:1, about 4.28:1 to about 4.42:1, about 4.42:1 to about 4.56:1, or about 4.56:1 to about 4.66:1, and any ratio between these ranges.

In some embodiments, the present disclosure relates to a composition, wherein the short/medium chain saturated fatty acids comprise about 3.10% of the total fatty acids. In some embodiments, the short/medium chain saturated fatty acids comprise about 2.64%, about 2.71%, about 2.78%, about 2.85%, about 2.92%, about 2.99%, about 3.06%, about 3.13%, about 3.20%, about 3.27%, about 3.34%, about 3.41%, about 3.48%, about 3.55%, or about 3.62% of the total fatty acids, and any value within these ranges.

In some embodiments, the present disclosure relates to a composition, wherein the intermediate chain fatty acids comprise about 10.41% of the total fatty acids. In some embodiments, the present disclosure relates to a composition, wherein the intermediate chain fatty acids comprise about 8.85%, about 9.06%, about 9.27%, about 9.48%, about 9.69%, about 9.90%, about 10.11%, about 10.32%, about 10.53%, about 10.74%, about 10.95%, about 11.16%, about 11.37%, about 11.58%, about 11.79%, or about 11.97% of the total fatty acids, and any value within these ranges.

In some embodiments, the present disclosure relates to a compositions, wherein the long chain fatty acids comprise about 32.71% of the total fatty acids. In some embodiments, the long chain fatty acids comprise about 27.80%, about 28.41%, about 29.02%, about 29.63%, about 30.24%, about 30.85%, about 31.46%, about 32.07%, about 32.68%, about 33.29%, about 33.90%, about 34.51%, about 35.12%, about 35.73%, about 36.34%, about 36.95%, or about 37.62% of the total fatty acids, and any value within these ranges.

In some embodiments, the present disclosure relates to a composition, wherein the monounsaturated fatty acids comprise about 47.18% of the total fatty acids. In some embodiments, the monounsaturated fatty acids comprise about 40.10%, about 41.02%, about 41.94%, about 42.86%, about 43.78%, about 44.70%, about 45.62%, about 46.54%, about 47.18%, about 47.46%, about 48.38%, about 49.30%, about 50.22%, about 51.14%, about 52.06%, about 52.98%, or about 54.26% of the total fatty acids, and any value within these ranges.

In some embodiments, the present disclosure relates to a composition, wherein the polyunsaturated fatty acids comprise about 8.98% of the total fatty acids. In some embodiments, the polyunsaturated fatty acids comprise about 7.63%, about 7.80%, about 7.97%, about 8.14%, about 8.31%, about 8.48%, about 8.65%, about 8.82%, about 8.98%, about 9.15%, about 9.32%, about 9.49%, about 9.66%, about 9.83%, about 10.00%, about 10.17%, or about 10.33% of the total fatty acids, and any value within these ranges.

In some embodiments, the present disclosure relates to a composition, comprising: Butyric acid in an amount of about 0.31% to about 0.42% of the total fatty acids; Caproic acid in an amount of about 0.28% to about 0.38% of the total fatty acids; Caprylic acid in an amount of about 1.08% to about 1.46% of the total fatty acids; Capric acid in an amount of about 0.97% to about 1.31% of the total fatty acids; Lauric acid in an amount of about 5.67% to about 7.67% of the total fatty acids; Myristic acid in an amount of about 3.18% to about 4.30% of the total fatty acids; Pentadecanoic acid in an amount of about 0.14% to about 0.20% of the total fatty acids; Palmitic acid in an amount of about 18.17% to about 24.59% of the total fatty acids; Margaric acid in an amount of about 0.20% to about 0.28% of the total fatty acids; Stearic acid in an amount of about 7.92% to about 10.72% of the total fatty acids; Arachidic acid in an amount of about 0.67% to about 0.91% of the total fatty acids; Behenic acid in an amount of about 0.35% to about 0.47% of the total fatty acids; Lignoceric acid in an amount of about 0.34% to about 0.46% of the total fatty acids; Myristoleic acid in an amount of about 0.09% to about 0.13% of the total fatty acids; Palmitoleic acid in an amount of about 1.42% to about 1.92% of the total fatty acids; Oleic acid in an amount of about 38.27% to about 51.78% of the total fatty acids; Gadoleic acid in an amount of about 0.32% to about 0.44% of the total fatty acids; Linoleic acid in an amount of about 5.58% to about 7.54% of the total fatty acids; Linolenic acid in an amount of about 1.11% to about 1.50% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; Docosahexaenoic acid in an amount of about 0.31% to about 0.43% of the total fatty acids; and wherein the composition comprises essentially no Erucic acid and/or essentially no Nervonic acid.

In some embodiments, the present disclosure relates to a composition, comprising: Butyric acid in an amount of about 0.36% of the total fatty acids; Caproic acid in an amount of about 0.33% of the total fatty acids; Caprylic acid in an amount of about 1.27% of the total fatty acids; Capric acid in an amount of about 1.14% of the total fatty acids; Lauric acid in an amount of about 6.67% of the total fatty acids; Myristic acid in an amount of about 3.74% of the total fatty acids; Pentadecanoic acid in an amount of about 0.17% of the total fatty acids; Palmitic acid in an amount of about 21.38% of the total fatty acids; Margaric acid in an amount of about 0.24% of the total fatty acids; Stearic acid in an amount of about 9.32% of the total fatty acids; Arachidic acid in an amount of about 0.79% of the total fatty acids; Behenic acid in an amount of about 0.41% of the total fatty acids; Lignoceric acid in an amount of about 0.40% of the total fatty acids; Myristoleic acid in an amount of about 0.11% of the total fatty acids; Palmitoleic acid in an amount of about 1.67% of the total fatty acids; Oleic acid in an amount of about 45.02% of the total fatty acids; Gadoleic acid in an amount of about 0.38% of the total fatty acids; Linoleic acid in an amount of about 6.56% of the total fatty acids; Linolenic acid in an amount of about 1.30% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; Docosahexaenoic acid in an amount of about 0.37% of the total fatty acids; and wherein the composition comprises essentially no Erucic acid and essentially no Nervonic acid.

In some embodiments, the present disclosure relates to a composition, wherein the ratio of Arachidonic acid to Docosahexaenoic acid is about 1.7:1. In some embodiments, the ratio of Arachidonic acid to Docosahexaenoic acid is about 1.45:1, about 1.48:1, about 1.51:1, about 1.54:1, about 1.57:1, about 1.60:1, about 1.63:1, about 1.66:1, about 1.70:1, about 1.73:1, about 1.76:1, about 1.79:1, about 1.82:1, about 1.85:1, about 1.88:1, about 1.91:1, or about 1.96:1, and any range between these values. In some embodiments, the ratio of Arachidonic acid to Docosahexaenoic acid is about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, or about 0.22:1, and any range between these values. In some embodiments, the ratio is about 1.5:1 to about 0.5:1, about 1.3:1 to about 0.7:1, about 1.1:1 to about 0.9:1, or about 1:1 to about 0.8:1, and any value between these ranges.

In some embodiments, the present disclosure relates to a composition, wherein the ratio of Eicosapentaenoic acid to Docosahexaenoic acid is about 0.22:1. In some embodiments, the ratio of Eicosapentaenoic acid to Docosahexaenoic acid is about 0.19:1, about 0.20:1, about 0.21:1, about 0.22:1, about 0.23:1, about 0.24:1, about 0.25:1, and any range between these values. In some embodiments, the ratio of Eicosapentaenoic acid to Docosahexaenoic acid is about 0.19:1 to about 0.20:1, about 0.20:1 to about 0.21:1, about 0.21:1 to about 0.22:1, about 0.22:1 to about 0.23:1, about 0.23:1 to about 0.24:1, about 0.24:1 to about 0.25:1, about 0.25:1 to about 0.26:1, about 0.26:1 to about 0.27:1, about 0.27:1 to about 0.28:1, about 0.28:1 to about 0.29:1, about 0.29:1 to about 0.30:1, about 0.30:1 to about 0.31:1, about 0.31:1 to about 0.32:1, about 0.32:1 to about 0.33:1, about 0.33:1 to about 0.34:1, or about 0.34:1 to about 0.35:1, and any ratio within these ranges.

In some embodiments, the present disclosure relates to a composition, wherein the ratio of Linoleic acid to alpha-Linolenic acid is about 5.05:1. In some embodiments, the ratio of Linoleic acid to alpha-Linolenic acid is about 4.29:1, about 4.37:1, about 4.45:1, about 4.53:1, about 4.61:1, about 4.69:1, about 4.77:1, about 4.85:1, about 4.93:1, about 5.01:1, about 5.05:1, about 5.09:1, about 5.17:1, about 5.25:1, about 5.33:1, about 5.41:1, about 5.49:1, about 5.57:1, about 5.65:1, about 5.73:1, or about 5.81:1, and any range between these values. In some embodiments, the ratio of Linoleic acid to alpha-Linolenic acid is about 4.26:1 to about 5.81:1, about 4.26:1 to about 4.34:1, about 4.34:1 to about 4.48:1, about 4.48:1 to about 4.62:1, about 4.62:1 to about 4.76:1, about 4.76:1 to about 4.90:1, about 4.90:1 to about 5.04:1, about 5.04:1 to about 5.18:1, about 5.18:1 to about 5.32:1, about 5.32:1 to about 5.46:1, about 5.46:1 to about 5.50:1, about 5.50:1 to about 5.81:1, and any ratio between these ranges.

In some embodiments, the present disclosure relates to a composition, wherein the polyunsaturated fatty acids comprise n-6 fatty acids, n-3 fatty acids, and combinations thereof. In some embodiments, the present disclosure relates to a composition, wherein the ratio of n-6 fatty acids to n-3 fatty acids is about 4.02:1. In some embodiments, the ratio of n-6 fatty acids to n-3 fatty acids is about 3.42:1, about 3.48:1, about 3.54:1, about 3.60:1, about 3.66:1, about 3.72:1, about 3.78:1, about 3.84:1, about 3.90:1, about 3.96:1, about 4.02:1, about 4.08:1, about 4.14:1, about 4.20:1, about 4.26:1, about 4.32:1, about 4.38:1, about 4.44:1, about 4.50:1, about 4.56:1, about 4.62:1, and any range between these values. In some embodiments, the ratio of n-6 fatty acids to n-3 fatty acids is about 3.42:1 to about 3.58:1, about 3.58:1 to about 3.72:1, about 3.72:1 to about 3.86:1, about 3.86:1 to about 4.00:1, about 4.00:1 to about 4.14:1, about 4.14:1 to about 4.28:1, about 4.28:1 to about 4.42:1, about 4.42:1 to about 4.56:1, or about 4.56:1 to about 4.62:1, and any ratio between these ranges.

In some embodiments, the present disclosure relates to a composition, wherein the fatty acids are derived from recombinant sources. In some embodiments, the present disclosure relates to a composition, wherein the fatty acids are derived from only recombinant sources. Recombinant sources include, but are not limited to genetically engineered microorganisms (e.g. bacteria, yeast, algae), transgenic plants, transgenic animals, cell-free protein synthesis systems, recombinant enzymes, engineered cell lines, synthetic biology platforms, recombinant DNA technology, CRISPR-engineered organisms, recombinant protein production systems, metabolically engineered microbes, genetically modified crops, recombinant antibody production systems, engineered mammalian cell cultures, recombinant vaccine production platforms, engineered insect cell lines, recombinant gene therapy vectors, engineered plant cell cultures, recombinant hormone production systems, engineered microbial consortia, recombinant enzyme bioreactors, engineered chloroplasts, recombinant protein secretion systems, engineered fungi, recombinant nucleic acid production systems, carbon dioxide and water sources via thermal chemistry, and combinations thereof.

In some embodiments, the present disclosure relates to a composition, wherein the fatty acids are derived from recombinant sources in combination with whole milk powder. In some embodiments, the present disclosure relates to a composition, wherein the fatty acids are derived from whole milk and plant oils.

In some embodiments, the present disclosure relates to a composition, wherein the plant oils are selected from the group comprising coconut oil, canola oil, sunflower oil, algal oil, and combinations thereof. In some embodiments, the present disclosure relates to a composition, wherein the plant oils are selected from the group comprising coconut oil, algal oil, and combinations thereof. In some embodiments, plant oils include but are not limited to Coconut oil, olive oil, palm oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, palm kernel oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

In some embodiments, the present disclosure relates to a composition, wherein the fatty acids are derived from whole milk, plant oils, and recombinant oils.

In some embodiments, the present disclosure relates to a composition, wherein the whole milk powder is in an amount of about 11% to about 21% of the composition. In some embodiments, the present disclosure relates to a composition, wherein the whole milk powder is in an amount of about 11.7% of the composition. In some embodiments, the present disclosure relates to a composition, wherein the whole milk powder is in an amount of about 21% of the composition. In some embodiments, the present disclosure relates to a composition, wherein the whole milk powder comprises less than about 50% milkfat. In some embodiments, the present disclosure relates to a composition, wherein the whole milk powder comprises about 26% to about 42% milkfat. In some embodiments, the present disclosure relates to a composition, wherein the whole milk powder comprises substantially no milkfat. In some embodiments, the present disclosure relates to a composition, wherein the whole milk powder comprises nonfat whole milk.

In some embodiments, the present disclosure relates to a composition, wherein the fatty acids are derived from fatty fish, algae, fungi, dairy products, cooking oils, plant source, or combinations thereof.

In some embodiments, the present disclosure relates to a composition, wherein the fatty fish are salmon, mackerel, sardines, trout, herring, tuna, or combinations thereof.

In some embodiments, the present disclosure relates to a composition, wherein the dairy products are butter, cheese, cream, whole milk, or combinations thereof.

In some embodiments, the present disclosure relates to a composition, wherein the cooking oils are palm oil, coconut oil, vegetable oil, or combinations thereof. In some embodiments, the cooking oil is vegetable oil, canola oil, olive oil, coconut oil, sunflower oil, corn oil, peanut oil, soybean oil, grapeseed oil, avocado oil, sesame oil, safflower oil, palm oil, rice bran oil, almond oil, walnut oil, flaxseed oil, cottonseed oil, ghee, lard, butter, margarine, shortening, palm kernel oil, mustard oil, groundnut oil, rapeseed oil, hemp seed oil, pumpkin seed oil, macadamia oil, hazelnut oil, grape seed oil, argan oil, camellia oil, tea seed oil, and combinations thereof.

In some embodiments, the present disclosure relates to an oil that does not include or is substantially free of palm oil, seed oils, soybean oil, rapeseed oil, and/or cottonseed oil. The oil may comprise less than about 5%, less than about 2%, less than about 1%, or less than about 0.5% of these oils, based on the total weight of the oil.

In some embodiments, the present disclosure relates to a composition, wherein the plant source is a nut, a seed, an avocado, a plant oil, a soybean product, a whole grain, or combinations thereof.

In some embodiments, the present disclosure relates to a composition, wherein the nut or seed is an almond, a walnut, flaxseed, chia seed, hemp seed, pumpkin seed, or combinations thereof. In some embodiments, the nut or seed oil is almond, walnut, hazelnut, macadamia, pecan, pistachio, cashew, brazil nut, coconut, sunflower, pumpkin, flaxseed, chia, sesame, hemp, poppy, grape seed, rapeseed (also known as canola), safflower, cotton seed, and combinations thereof.

In some embodiments, the present disclosure relates to a composition, wherein the plant oil is olive oil, canola oil, flaxseed oil, walnut oil, sesame oil, or combinations thereof. In some embodiments, the present disclosure relates to a composition, wherein the soybean product is tofu, tempeh, edamame, or combinations thereof. In some embodiments, the present disclosure relates to a composition, wherein the whole grain is oats, quinoa, brown rice, or combinations thereof.

Embodiments of the present disclosure relate to preparing any composition described herein by combining the fatty acids.

Embodiments of the present disclosure relate to an infant formula comprising a composition of any embodiment described herein. In some embodiments, the infant formula mimics human breast milk.

### Oils

In some embodiments of the present disclosure relate to oils that may be breast milk mimicking oils or optimized human breast milk oils. Any embodiment described herein may be formulated as a breast milk mimicking oil that resembles or approximates the composition, nutritional profile, or functional properties of human breast milk. Embodiments of the present disclosure may relate to part of a breast milk oil or the entirety of a breast milk oil formulation. For example, embodiments of the present disclosure may relate to a whole infant formula oil or a portion of a fatty acid oil. Additionally, any embodiment may be formulated as an optimized human breast milk oil that closely resembles the nutritional profile and functional properties of human breast milk from healthy mothers, while incorporating targeted improvements or adjustments to potentially enhance certain aspects of infant nutrition. These oils may include carefully selected components, ratios, or concentrations of nutrients designed to provide optimal nutritional support for infant growth and development.

Embodiments of the present disclosure provide an oil, specifically an oil, with a tailored fatty acid (FA) profile. The FA profile of the oil is optimized to comprise a variety of saturated and unsaturated fatty acids, each present in specific proportions. The saturated fatty acids comprise short/medium chain saturated fatty acids, intermediate chain saturated fatty acids, long chain saturated fatty acids, and combinations thereof. The unsaturated fatty acids comprise monounsaturated fatty acids and polyunsaturated fatty acids. Oils of the present disclosure may align with the FA profile of Table A.

The FA profile of the oil is designed to mimic the FA profile found in human breast milk, making it particularly suitable for use in infant formula. The oils of this invention are uniquely able to mimic human breast milk, which is not naturally occurring in any other source. The oil may be derived from a variety of sources, including but not limited to, whole milk fats, vegetable oils, and recombinant oils. In some cases, the oil may be derived entirely from recombinant oils, which can be produced through precision fermentation processes, thermal chemistry, or any novel technology known in the art.

The fatty acid profile of the oils was developed from an extensive global analysis of human milk, ensuring it reflects a wide variety of diets and environments. The profile was further refined using data from populations with low non-communicable disease mortality rates, aligning with the fatty acid levels in the milk of mothers from these “healthiest” countries to promote health and wellness. The specific fatty acid levels were also informed by a comprehensive body of research, including mechanistic studies, expert opinions, and human milk studies, to scientifically substantiate the oil's potential health benefits.

In any embodiment described herein, the oil comprises a variety of fatty acids. In some embodiments, the fatty acids comprise both saturated and unsaturated fatty acids. In some embodiments, the saturated fatty acids are present in the oil in various forms, such as short/medium chain saturated fatty acids, intermediate chain saturated fatty acids, and long chain saturated fatty acids. Each of these types of saturated fatty acids contribute to the overall fatty acid profile of the oil and are present in specific proportions relative to the total fatty acid content.

In some embodiments, the present disclosure relates to an oil comprising fatty acids, wherein the oil comprises saturated fatty acids, unsaturated fatty acids, and combinations thereof.

In some embodiments, the present disclosure relates to an oil, wherein the saturated fatty acids are selected from the group consisting of short/medium chain fatty acids, intermediate chain fatty acids, long chain fatty acids, and combinations thereof.

In some embodiments, the present disclosure relates to an oil, wherein the short/medium chain fatty acids comprise less than twelve carbons. In some embodiments, the present disclosure relates to an oil, wherein the short/medium chain saturated fatty acids comprise about 0.40% to about 4.20% of the total fatty acids. In some embodiments, the present disclosure relates to an oil, wherein the short/medium chain saturated fatty acids comprise about 0.50% to about 3.50%, about 0.75% to about 3.00%, about 1.00% to about 2.50%, about 1.25% to about 2.25%, about 1.50% to about 2.00%, about 0.60% to about 3.80%, about 0.80% to about 3.60%, about 1.20% to about 3.20%, about 1.60% to about 2.80%, about 2.00% to about 2.60%, about 0.45% to about 4.00%, about 0.55% to about 3.75%, about 0.70% to about 3.50%, about 0.90% to about 3.25%, about 1.10% to about 3.00%, about 1.30% to about 2.75%, about 1.50% to about 2.50%, about 1.75% to about 2.25%, about 0.65% to about 3.90%, about 0.85% to about 3.70% of the total fatty acid, and any value within these ranges. In some embodiments, the present disclosure relates to an oil, wherein the short/medium chain fatty acids comprise about 2.27% of the total fatty acids. In some embodiments, the present disclosure relates to an oil, wherein the short/medium chain saturated fatty acids comprise about 0.45%, about 0.75%, about 1.10%, about 1.50%, about 1.85%, about 2.27%, about 2.60%, about 2.95%, about 3.30%, about 3.65%, about 4.00%, about 0.60%, about 0.90%, about 1.25%, about 1.70%, about 2.00%, about 2.27%, about 2.75%, about 3.10%, about 3.45%, about 3.80%, about 0.55%, about 0.80%, about 1.15%, about 1.60%, about 1.95%, about 2.27%, about 2.65%, about 3.00%, about 3.40%, about 3.75% of the total fatty acids, and ranges between any two of these values.

In some embodiments, the present disclosure relates to an oil, wherein the short/medium chain fatty acids are selected from the group consisting of Butyric acid (C4:0), Caproic acid (C6:0), Caprylic acid (C8:0), Capric acid (C10:0), and combinations thereof.

In some embodiments, the present disclosure relates to an oil, wherein the Butyric acid (C4:0) is in an amount of less than about 0.39% of the total fatty acids. In some embodiments, the Butyric acid is in amount of less than about 0.01%, less than about 0.03%, less than about 0.05%, less than about 0.07%, less than about 0.10%, less than about 0.12%, less than about 0.15%, less than about 0.18%, less than about 0.20%, less than about 0.23%, less than about 0.25%, less than about 0.28%, less than about 0.30%, less than about 0.32%, less than about 0.35%, less than about 0.37%, less than about 0.02%, less than about 0.04%, less than about 0.06%, less than about 0.08%, less than about 0.11%, less than about 0.13%, less than about 0.16%, less than about 0.19%, less than about 0.21%, less than about 0.24%, less than about 0.26%, less than about 0.29%, less than about 0.31%, less than about 0.33%, less than about 0.36%, less than about 0.38% of the total fatty acids, and any value within these ranges. In some embodiments, the Butyric acid is in an amount of about 0.35% of the total fatty acids. In some embodiments, the Butyric acid is in amount of about 0.01%, about 0.03%, about 0.05%, about 0.07%, about 0.10%, about 0.12%, about 0.15%, about 0.18%, about 0.20%, about 0.23%, about 0.25%, about 0.28%, about 0.30%, about 0.32%, about 0.35%, about 0.37%, about 0.02%, about 0.04%, about 0.06%, about 0.08%, about 0.11%, about 0.13%, about 0.16%, about 0.19%, about 0.21%, about 0.24%, about 0.26%, about 0.29%, about 0.31%, about 0.33%, about 0.35%, about 0.36%, about 0.38% of the total fatty acids, and ranges between any two of these values. In some embodiments, Butyric acid is in an amount of about 0.31% to about 0.42% of the total fatty acids. In some embodiments, the Butyric acid is in an amount of about 0.36% of the total fatty acids.

In some embodiments, the present disclosure relates to an oil, wherein the Caproic acid (C6:0) is in an amount of about 0.05% to about 0.39% of the total fatty acids. In some embodiments, the Caproic acid is in an amount of about 0.05% to about 0.10%, about 0.10% to about 0.15%, about 0.15% to about 0.20%, about 0.20% to about 0.25%, about 0.25% to about 0.30%, about 0.30% to about 0.35%, or about 0.35% to about 0.39% of the total fatty acids, and any value within these ranges. In some embodiments, the Caproic acid is in an amount of about 0.14% of the total fatty acids. In some embodiments, the Caproid acid is in an amount of about 0.05%, about 0.10%, about 0.14%, about 0.15%, about 0.20%, about 0.25%, about 0.30%, about 0.35%, or about 0.39% of the total fatty acids, and ranges between any two of these values. In some embodiments, the Caproic acid is in an amount of about 0.31% to about 0.43% of the total fatty acids. In some embodiments, the Caproic acid is in an amount of about 0.37% of the total fatty acids. In some embodiments, the Caproic acid is in an amount of about 0.28% to about 0.38% of the total fatty acids. In some embodiments, the Caproic acid is in an amount of about 0.33% of the total fatty acids.

In some embodiments, the present disclosure relates to an oil, wherein the Caprylic acid (C8:0) is in an amount of about 0.11% to about 1.68% of the total fatty acids. In some embodiments, the Caprylic acid is in an amount of about 0.11% to about 0.30%, about 0.30% to about 0.50%, about 0.50% to about 0.70%, about 0.70% to about 0.90%, about 0.90% to about 1.10%, about 1.10% to about 1.30%, about 1.30% to about 1.50%, or about 1.50% to about 1.68% of the total fatty acids, and any value within these ranges. In some embodiments, the Caprylic acid is in an amount of about 0.21% of the total fatty acids. In some embodiments, the Caprylic acid is in an amount of about 0.11%, about 0.21%, about 0.30%, about 0.40%, about 0.50%, about 0.60%, about 0.70%, about 0.80%, about 0.90%, about 1.00%, about 1.10%, about 1.20%, about 1.30%, about 1.40%, about 1.50%, 1.60%, or about 1.68% of the total fatty acids, and ranges between any two of these values. In some embodiments, the Caprylic acid is in an amount of about 1.44% to about 1.94% of the total fatty acids. In some embodiments, the Caprylic acid is in an amount of about 1.69% of the total fatty acids. In some embodiments, the Caprylic acid is in an amount of about 1.08% to about 1.46% of the total fatty acids. In some embodiments, the Caprylic acid is in an amount of about 1.27% of the total fatty acids.

In some embodiments, the present disclosure relates to an oil, wherein the Capric acid (C10:0) is in an amount of about 0.28% to about 2.00% of the total fatty acids. In some embodiments, the Capric acid is in amount of about 0.28% to about 0.50%, about 0.50% to about 0.75%, about 0.75% to about 1.00%, about 1.00% to about 1.25%, about 1.25% to about 1.50%, about 1.50% to about 1.75%, or about 1.75% to about 2.00% of the total fatty acids, and any value within these ranges. In some embodiment, the Capric acid is in an amount of about 1.57% of the total fatty acids. In some embodiments, the Capric acid is in an amount of about 0.28%, about 0.50%, about 0.75%, about 1.00%, about 1.25%, about 1.50%, about 1.57%, about 1.75%, or about 2.00% of the total fatty acids, and ranges between any two of these values. In some embodiments, the Capric acid is in an amount of about 1.23% to about 1.67% of the total fatty acids. In some embodiments, the Capric acid is in an amount of about 1.45% of the total fatty acids. In some embodiments, the Capric acid is in an amount of about 0.97% to about 1.31% of the total fatty acids. In some embodiments, the Capric acid is in an amount of about 1.14% of the total fatty acids.

In some embodiments, the present disclosure relates to an oil, wherein the intermediate chain fatty acids comprise twelve to fourteen carbons. In some embodiments, the present disclosure relates to an oil, wherein the intermediate chain fatty acids comprise about 7.50% to about 20.00% of the total fatty acids. In some embodiments, the intermediate chain fatty acids comprise about 7.50% to about 8.50%, about 8.50% to about 9.50%, about 9.50% to about 10.50%, about 10.50% to about 11.50%, about 11.50% to about 12.50%, about 12.50% to about 13.50%, about 13.50% to about 14.50%, about 14.50% to about 15.50%, about 15.50% to about 16.50%, about 16.50% to about 17.50%, about 17.50% to about 18.50%, about 18.50% to about 19.50%, or about 19.50% to about 20.00% of the total fatty acids, and any value within these ranges. In some embodiments, the present disclosure relates to an oil, wherein the intermediate chain fatty acids comprise about 12.51% of the total fatty acids. In some embodiments, the present disclosure relates to an oil, wherein the intermediate chain fatty acids comprise about 7.50%, about 8.00%, about 8.50%, about 9.00%, about 9.50%, about 10.00%, about 10.50%, about 11.00%, about 11.50%, about 12.00%, about 12.51%, about 13.00%, about 13.50%, about 14.00%, about 14.50%, about 15.00%, about 15.50%, about 16.00%, about 16.50%, about 17.00%, about 17.50%, about 18.00%, about 18.50%, about 19.00%, about 19.50%, or about 20.00% of the total fatty acids, and ranges between any two of these values.

In some embodiments, the present disclosure relates to an oil, wherein the intermediate chain fatty acids are selected from the group consisting of Myristic acid (C14:0), Lauric acid (C12:0), and combinations thereof.

In some embodiments, the present disclosure relates to an oil, wherein the Lauric acid (C12:0) is in an amount of about 4.40% to about 10.0% of the total fatty acids. In some embodiments, the Lauric acid is in an amount of about 4.40% to about 5.40%, about 5.40% to about 6.40%, about 6.40% to about 7.40%, about 7.40% to about 8.40%, about 8.40% to about 9.40%, or about 9.40% to about 10.0% of the total fatty acids, and any value within these ranges. In some embodiments, the Lauric acid is in an amount of about 5.90% of the total fatty acids. In some embodiments, the Lauric acid is in an amount of about 4.40%, about 5.40%, about 5.90%, about 6.40%, about 7.40%, about 8.40%, about 9.40%, or about 10.0% of the total fatty acids, and ranges between any two of these values. In some embodiments, the Lauric acid is in an amount of about 7.65% to about 10.35% of the total fatty acids. In some embodiments, the Lauric acid is in an amount of about 9.00% of the total fatty acids. In some embodiments, the Lauric acid is in an amount of about 5.67% to about 7.67% of the total fatty acids. In some embodiments, the Lauric acid is in an amount of about 6.67% of the total fatty acids.

In some embodiments, the Myristic acid (C14:0) is in an amount of about 3.10% to about 10.0% of the total fatty acids. In some embodiments, the Myristic acid is in an amount of about 3.10% to about 4.10%, about 4.10% to about 5.10%, about 5.10% to about 6.10%, about 6.10% to about 7.10%, about 7.10% to about 8.10%, about 8.10% to about 9.10%, or about 9.10% to about 10.0% of the total fatty acids, and any value within these ranges. In some embodiments, the Myristic acid is in an amount of about 6.61% of the total fatty acids. In some embodiments, the Myristic acid is in an amount of about 3.10%, about 4.10%, about 5.10%, about 6.10%, about 6.61%, about 7.10%, about 8.10%, about 9.10%, or about 10.0% of the total fatty acids, and ranges between any two of these values. In some embodiments, the Myristic acid is in an amount of about 3.94% to about 5.32% of the total fatty acids. In some embodiments, the Myristic acid is in an amount of about 4.63% of the total fatty acids. In some embodiments, the Myristic acid is in an amount of about 3.18% to about 4.30% of the total fatty acids. In some embodiments, the Myristic acid is in an amount of about 3.74% of the total fatty acids.

In some embodiments, the present disclosure relates to an oil, wherein the long chain fatty acids comprise greater than fourteen carbons. In some embodiments, the present disclosure relates to an oil, wherein the long chain fatty acids comprise about 28.88% of the total fatty acids. In some embodiments, the present disclosure relates to an oil, wherein the long chain fatty acids comprise about 24.55% to about 33.21% of the total fatty acids. In some embodiments, the long chain fatty acids comprise about 24.55% to about 26.55%, about 26.55% to about 28.55%, about 28.55% to about 30.55%, about 30.55% to about 32.55%, or about 32.55% to about 33.21% of the total fatty acids, and any value within these ranges. In some embodiments, the long chain fatty acids comprise about 24.55%, about 26.00%, about 27.50%, about 28.88%, about 29.00%, about 30.50%, about 32.00%, or about 33.21% of the total fatty acids, and ranges between any two of these values.

In some embodiments, the present disclosure relates to an oil, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

In some embodiments, the present disclosure relates to an oil, wherein the Pentadecanoic acid (C15:0) is in an amount of about 0.16% to about 0.39% of the total fatty acids. In some embodiments, the Pentadecanoic acid (C15:0) is in an amount of about 0.16% to about 0.20%, about 0.20% to about 0.25%, about 0.25% to about 0.30%, about 0.30% to about 0.35%, or about 0.35% to about 0.39% of the total fatty acids, and any value within these ranges. In some embodiments, the Pentadecanoic acid is in an amount of about 0.28% of the total fatty acids. In some embodiments, the Pentadecanoic acid is in an amount of about 0.16%, about 0.20%, about 0.25%, about 0.28%, about 0.30%, about 0.35%, or about 0.39% of the total fatty acids, and ranges between any two of these values. In some embodiments, the Pentadecanoic acid is in an amount of about 0.14% to about 0.20% of the total fatty acids. In some embodiments, the Pentadecanoic acid is in an amount of about 0.17% of the total fatty acids.

In some embodiments, the present disclosure relates to an oil, wherein the Palmitic acid (C16:0) is in an amount of about 18.67% to about 23.83% of the total fatty acids. In some embodiments, the present disclosure relates to an oil, wherein the Palmitic acid (C16:0) is in an amount of about 18.67% to about 19.67%, about 19.67% to about 20.67%, about 20.67% to about 21.67%, about 21.67% to about 22.67%, or about 22.67% to about 23.83% of the total fatty acids, and any value within these ranges. In some embodiments, the Palmitic acid is in an amount of about 21.47% of the total fatty acids. In some embodiments, the Palmitic acid is in an amount of about 18.67%, about 19.67%, about 20.67%, about 21.47%, about 21.67%, about 22.67%, or about 23.83% of the total fatty acids, and ranges between any two of these values. In some embodiments, the Palmitic acid is in an amount of about 7.29% to about 9.87% of the total fatty acids. In some embodiments, the Palmitic acid is in an amount of about 8.58% of the total fatty acids. In some embodiments, the Palmitic acid is in an amount of about 18.17% to about 24.59% of the total fatty acids; Palmitic acid is in an amount of about 21.38% of the total fatty acids.

In some embodiments, the present disclosure relates to an oil, wherein the Margaric acid (C17:0) is in an amount of about 0.09% to about 0.41% of the total fatty acids. In some embodiments, the Margaric acid (C17:0) is in an amount of about 0.09% to about 0.15%, about 0.15% to about 0.20%, about 0.20% to about 0.25%, about 0.25% to about 0.30%, about 0.30% to about 0.35%, about 0.35% to about 0.41% of the total fatty acids, and any value within these ranges. In some embodiments, the Margaric acid is in an amount of about 0.32% of the total fatty acids. In some embodiments, the Margaric acid is in an amount of about 0.09%, about 0.15%, about 0.20%, about 0.25%, about 0.30%, about 0.32%, about 0.35%, or about 0.41% of the total fatty acids, and ranges between any two of these values. In some embodiments, the Margaric acid is in an amount of about 0.08% to about 0.10% of the total fatty acids. In some embodiments, the Margaric acid is in an amount of about 0.09% of the total fatty acids. In some embodiments, the Margaric acid is in an amount of about 0.20% to about 0.28% of the total fatty acids. In some embodiments, the Margaric acid is in an amount of about 0.24% of the total fatty acids.

In some embodiments, the present disclosure relates to an oil, wherein the Stearic acid (C18:0) is in an amount of about 3.61% to about 10.14% of the total fatty acids. In some embodiments, the Stearic acid is in an amount of about 3.61% to about 4.61%, about 4.61% to about 5.61%, about 5.61% to about 6.61%, about 6.61% to about 7.61%, about 7.61% to about 8.61%, about 8.61% to about 9.61%, or about 9.61% to about 10.14% of the total fatty acids, and any value within these ranges. In some embodiments, the Stearic acid is in an amount of about 6.40% of the total fatty acids. In some embodiments, the Stearic acid is in an amount of about 3.61%, about 4.61%, about 5.61%, about 6.40%, about 6.61%, about 7.61%, about 8.61%, about 9.61%, or about 10.14% of the total fatty acids, and ranges between any two of these values. In some embodiments, the Stearic acid is in an amount of about 2.97% to about 4.51% of the total fatty acids. In some embodiments, the Stearic acid is in an amount of about 3.33% to about 4.51% of the total fatty acids. In some embodiments, the Stearic acid is in an amount of about 3.92% of the total fatty acids. In some embodiments, the Stearic acid is in an amount of about 7.92% to about 10.72% of the total fatty acids. In some embodiments, the Stearic acid is in an amount of about 9.32% of the total fatty acids.

In some embodiments, the present disclosure relates to an oil, wherein the Arachidic acid (C20:0) is in an amount of about 0.19% to about 1.30% of the total fatty acids. In some embodiments, the Arachidic acid is in an amount of about 0.19% to about 0.40%, about 0.40% to about 0.60%, about 0.60% to about 0.80%, about 0.80% to about 1.00%, about 1.00% to about 1.20%, or about 1.20% to about 1.30% of the total fatty acids, and any value within these ranges. In some embodiments, the Arachidic acid is in an amount of about 0.22% of the total fatty acids. In some embodiments, the Arachidic acid is in an amount of about 0.19%, about 0.20%, about 0.22%, about 0.30%, about 0.40%, about 0.05%, about 0.60%, about 0.50%, about 0.80%, about 0.90%, about 1.00%, about 1.10%, about 1.20%, or about 1.30% of the total fatty acids, and ranges between any two of these values. In some embodiments, the Arachidic acid is in an amount of about 0.26% to about 0.36% of the total fatty acids. In some embodiments, the Arachidic acid is in an amount of about 0.31% of the total fatty acids. In some embodiments, the Arachidic acid is in an amount of about 0.67% to about 0.91% of the total fatty acids. In some embodiments, the Arachidic acid is in an amount of about 0.79% of the total fatty acids. In some embodiments, the Behenic acid is in an amount of about 0.41% of the total fatty acids.

In some embodiments, the present disclosure relates to an oil, wherein the Behenic acid (C22:0) is in an amount of about 0.05% to about 0.57% of the total fatty acids. In some embodiments, the Behenic acid is in an amount of about 0.05% to about 0.15%, about 0.15% to about 0.25%, about 0.25% to about 0.35%, about 0.35% to about 0.45%, or about 0.45% to about 0.57% of the total fatty acids, and any value within these ranges. In some embodiments, the Behenic acid is in an amount of about 0.11% of the total fatty acids. In some embodiments, the Behenic acid is in an amount of about 0.05%, about 0.10%, about 0.11%, about 0.15%, about 0.20%, about 0.25%, about 0.30%, about 0.35%, about 0.40%, about 0.45%, about 0.50%, about 0.55%, or about 0.57% of the total fatty acids, and ranges between any two of these values. In some embodiments, the Behenic acid is in an amount of about 0.48% to about 0.66% of the total fatty acids. In some embodiments, the Behenic acid is in an amount of about 0.57% of the total fatty acids. In some embodiments, the Behenic acid is in an amount of about 0.35% to about 0.47% of the total fatty acids. In some embodiments, the Behenic acid is in an amount of about 0.41% of the total fatty acids.

In some embodiments, the present disclosure relates to an oil, wherein the Lignoceric acid (C24:0) is in an amount of about 0.02% to about 0.47% of the total fatty acids. In some embodiments, the Lignoceric acid is in an amount of about 0.02% to about 0.10%, about 0.10% to about 0.20%, about 0.20% to about 0.30%, about 0.30% to about 0.40%, or about 0.40% to about 0.47% of the total fatty acids, and any value within these ranges. In some embodiments, the Lignoceric acid is in an amount of about 0.08% of the total fatty acids. In some embodiments, the Lignoceric acid is in an amount of about 0.02%, about 0.04%, about 0.06%, about 0.08%, about 0.10%, about 0.15%, about 0.20%, about 0.25%, about 0.30%, about 0.35%, about 0.40%, about 0.45%, or about 0.47% of the total fatty acids, and ranges between any two of these values. In some embodiments, the Lignoceric acid is in an amount of about 0.18% to about 0.24% of the total fatty acids. In some embodiments, the Lignoceric acid is in an amount of about 0.21% of the total fatty acids. In some embodiments, the Lignoceric acid is in an amount of about 0.34% to about 0.46% of the total fatty acids. In some embodiments, the Lignoceric acid is in an amount of about 0.40% of the total fatty acids.

In some embodiments, the present disclosure relates to an oil, wherein the unsaturated fatty acids are selected from the group consisting of monounsaturated fatty acids, polyunsaturated fatty acids, and combinations thereof. In some embodiments, the present disclosure relates to an oil, wherein the monounsaturated fatty acids comprise about 45.5% of the total fatty acids. In some embodiments, the present disclosure relates to an oil, wherein the monounsaturated fatty acids comprise about 38.68% to about 52.33% of the total fatty acids. In some embodiments, the monounsaturated fatty acids comprise about 38.68% to about 40.68%, about 40.68% to about 42.68%, about 42.68% to about 44.68%, about 44.68% to about 46.68%, about 46.68% to about 48.68%, about 48.68% to about 50.68%, or about 50.68% to about 52.33% of the total fatty acids, and any value within these ranges. In some embodiments, the monounsaturated fatty acids comprise about 38.68%, about 40.68%, about 42.68%, about 44.68%, about 45.55%, about 46.68%, about 48.68%, about 50.68%, or about 52.33% of the total fatty acids, and ranges between any two of these values.

In some embodiments, the present disclosure relates to an oil, wherein the fatty acids are monounsaturated fatty acids are selected from the group consisting of Myristoleic acid (C14:1), Palmitoleic acid (C16:1), Oleic acid (C18:1n9), Gadoleic acid (C20:1), and combinations thereof.

In some embodiments, the present disclosure relates to an oil, wherein the Myristoleic acid (C14:1) is in an amount of about 0.11% to about 0.50% of the total fatty acids. In some embodiments, the Myristoleic acid is in an amount of about 0.11% to about 0.20%, about 0.20% to about 0.30%, about 0.30% to about 0.40%, or about 0.40% to about 0.50% of the total fatty acids, and any value within these ranges. In some embodiments, the Myristoleic acid is in an amount of about 0.22% of the total fatty acids. In some embodiments, the Myristoleic acid is in an amount of about 0.11%, about 0.15%, about 0.20%, about 0.22%, about 0.25%, about 0.30%, about 0.35%, about 0.40%, about 0.45%, or about 0.50% of the total fatty acids, and ranges between any two of these values. In some embodiments, the Myristoleic acid is in an amount of about 0.09% to about 0.12% of the total fatty acids. In some embodiments, the Myristoleic acid is in an amount of about 0.10% of the total fatty acids. In some embodiments, the Myristoleic acid is in an amount of about 0.09% to about 0.13% of the total fatty acids. In some embodiments, the Myristoleic acid is in an amount of about 0.11% of the total fatty acids.

In some embodiments, the present disclosure relates to an oil, wherein the Palmitoleic acid (C16:1) is in an amount of about 0.25% to about 2.70% of the total fatty acids. In some embodiments, the Palmitoleic acid is in an amount of about 0.25% to about 0.70%, about 0.70% to about 1.15%, about 1.15% to about 1.60%, about 1.60% to about 2.05%, or about 2.05% to about 2.70% of the total fatty acids, and any value within these ranges. In some embodiments, the Palmitoleic acid is in an amount of about 2.36% of the total fatty acids. In some embodiments, the Palmitoleic acid is in an amount of about 0.25%, about 0.50%, about 0.70%, about 0.75%, about 1.00%, about 1.15%, about 1.25%, about 1.50%, about 1.60%, about 1.75%, about 2.0%, about 2.05%, about 2.25%, about 2.36%, about 2.50%, about 2.60%, or about 2.70% of the total fatty acids, and ranges between any two of these values. In some embodiments, the Palmitoleic acid is in an amount of about 0.20% to about 0.28% of the total fatty acids. In some embodiments, the Palmitoleic acid is in an amount of about 0.24% of the total fatty acids. In some embodiments, the Palmitoleic acid is in an amount of about 1.42% to about 1.92% of the total fatty acids. In some embodiments, the Palmitoleic acid is in an amount of about 1.67% of the total fatty acids.

In some embodiments, the present disclosure relates to an oil, wherein the Oleic acid (C18:1n9) is in an amount of about 26.20% to about 51.00% of the total fatty acids. In some embodiments, the Oleic acid is in an amount of about 26.20% to about 31.20%, about 31.20% to about 36.20%, about 36.20% to about 41.20%, about 41.20% to about 46.20%, or about 46.20% to about 51.00% of the total fatty acids, and any value within these ranges. In some embodiments, the Oleic acid is in an amount of about 42.38% of the total fatty acids. In some embodiments, the Oleic acid is in an amount of about 26.20%, about 31.20%, about 36.20%, about 41.20%, about 42.38%, about 46.20%, about 48.00%, or about 51.00% of the total fatty acids, and ranges between any two of these values. In some embodiments, the Oleic acid is in an amount of about 46.58% to about 63.02% of the total fatty acids. In some embodiments, the Oleic acid is in an amount of about 54.80% of the total fatty acids. In some embodiments, the Oleic acid is in an amount of about 38.27% to about 51.78% of the total fatty acids. In some embodiments, the Oleic acid is in an amount of about 45.02% of the total fatty acids.

In some embodiments, the present disclosure relates to an oil, wherein the Gadoleic acid (C20:1) is in an amount of about 0.08% to about 0.60% of the total fatty acids. In some embodiments, the Gadoleic acid is in an amount of about 0.08% to about 0.18%, about 0.18% to about 0.28%, about 0.28% to about 0.38%, about 0.38% to about 0.48%, or about 0.48% to about 0.60% of the total fatty acids, and any value within these ranges. In some embodiments, the Gadoleic acid is in an amount of about 0.45% of the total fatty acids. In some embodiments, the Gadoleic acid is in an amount of about 0.08%, about 0.10%, about 0.18%, about 0.22%, about 0.28%, about 0.32%, about 0.38%, about 0.42%, about 0.45%, about 0.48%, about 0.52%, about 0.58%, or about 0.60% of the total fatty acids, and ranges between any two of these values. In some embodiments, the Gadoleic acid is in an amount of about 0.31% to about 0.43% of the total fatty acids. In some embodiments, the Gadoleic acid is in an amount of about 0.37% of the total fatty acids. In some embodiments, the Gadoleic acid is in an amount of about 0.32% to about 0.44% of the total fatty acids. In some embodiments, the Gadoleic acid is in an amount of about 0.38% of the total fatty acids.

In some embodiments, the present disclosure relates to an oil, wherein the oil comprises less than about 0.10% Erucic acid (C22:1). In some embodiments, the present disclosure relates to an oil, wherein the oil comprises less than about 0.10%, about 0.09%, about 0.08%, about 0.07%, about 0.06%, about 0.05%, about 0.04%, about 0.03%, about 0.02%, about 0.01%, or about 0% Erucic acid, and any value within these ranges. In some embodiments, the Erucic acid is in an amount of about 0.10%, about 0.09%, about 0.08%, about 0.07%, about 0.06%, about 0.05%, about 0.04%, about 0.03%, about 0.02%, about 0.01%, or about 0%, and ranges between any two of these values. In some embodiments, the oil is free of Erucic acid. In some embodiments, the oil comprises substantially no Erucic acid.

In some embodiments, the present disclosure relates to an oil, wherein the oil comprises less than about 0.22% Nervonic acid (C24:1). In some embodiments, the present disclosure relates to an oil, wherein the oil comprises less than about 0.22%, about 0.21%, about 0.20%, about 0.19%, about 0.18%, about 0.17%, about 0.16%, about 0.15%, about 0.14%, about 0.13%, about 0.12%, about 0.11%, about 0.10%, about 0.09%, about 0.08%, about 0.07%, about 0.06%, about 0.05%, about 0.04%, about 0.03%, about 0.02%, about 0.01%, or about 0% Nervonic acid, and any value within these ranges. In some embodiments, the Nervonic acid is in an amount of about 0.09% of the total fatty acids. In some embodiments, the Nervonic acid is in an amount of about 0.22%, about 0.21%, about 0.20%, about 0.19%, about 0.18%, about 0.17%, about 0.16%, about 0.15%, about 0.14%, about 0.13%, about 0.12%, about 0.11%, about 0.10%, about 0.09%, about 0.08%, about 0.07%, about 0.06%, about 0.05%, about 0.04%, about 0.03%, about 0.02%, about 0.01%, or about 0% of the total fatty acids. In some embodiments, Nervonic acid in an amount of less than about 0.04% of the total fatty acids. In some embodiments, Nervonic acid in an amount of about 0.04% of the total fatty acids.

In some embodiments, the present disclosure relates to an oil, wherein the polyunsaturated fatty acids comprise about 8.5% of the total fatty acids. In some embodiments, the present disclosure relates to an oil, wherein the polyunsaturated fatty acids comprise about 7.23% to about 9.78% of the total fatty acids. In some embodiments, the polyunsaturated fatty acids comprise about 7.23% to about 7.73%, about 7.73% to about 8.23%, about 8.23% to about 8.73%, about 8.73% to about 9.23%, or about 9.23% to about 9.78% of the total fatty acids, and any value within these ranges. In some embodiments, the polyunsaturated fatty acids comprise about 7.23%, about 7.73%, about 8.23%, about 8.5%, about 8.73%, about 9.23%, or about 9.78% of the total fatty acids, and ranges between any two of these values.

In some embodiments, the present disclosure relates to an oil, wherein the fatty acids are polyunsaturated fatty acids are selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

In some embodiments, the present disclosure relates to an oil, wherein the Linoleic acid (C18:2n6) is in an amount of about 5.85% to about 9.00% of the total fatty acids. In some embodiments, the Linoleic acid is in an amount of about 5.85% to about 6.35%, about 6.35% to about 6.85%, about 6.85% to about 7.35%, about 7.35% to about 7.85%, about 7.85% to about 8.35%, about 8.35% to about 8.85%, or about 8.85% to about 9.00% of the total fatty acids, and any value within these ranges. In some embodiments, the Linoleic acid is in an amount of about 6.20% of the total fatty acid. In some embodiments, the Linoleic acid is in an amount of about 5.85%, about 6.20%, about 6.35%, about 6.85%, about 7.35%, about 7.85%, about 8.35%, about 8.85%, or about 9.00% of the total fatty acids, and ranges between any two of these values. In some embodiments, the Linoleic acid is in an amount of about 7.60% to about 10.27% of the total fatty acids. In some embodiments, the Linoleic acid is in an amount of about 8.93% of the total fatty acids. In some embodiments, the Linoleic acid is in an amount of about 5.58% to about 7.54% of the total fatty acids. In some embodiments, the Linoleic acid is in an amount of about 6.56% of the total fatty acids.

In some embodiments, the present disclosure relates to an oil, wherein the Linolenic acid (C18:3n3) is in an amount of about 0.89% to about 2.07% of the total fatty acids. In some embodiments, the Linolenic acid is in an amount of about 0.89% to about 1.09%, about 1.09% to about 1.29%, about 1.29% to about 1.49%, about 1.49% to about 1.69%, about 1.69% to about 1.89%, or about 1.89% to about 2.07% of the total fatty acids, and any value within these ranges. In some embodiments, the Linolenic acid is in an amount of about 1.02% of the total fatty acids. In some embodiments, the Linolenic acid is in an amount of about 0.89%, about 1.02%, about 1.09%, about 1.15%, about 1.29%, about 1.39%, about 1.49%, about 1.59%, about 1.69%, about 1.79%, about 1.89%, about 1.99%, or about 2.07% of the total fatty acids, and ranges between any two of these values. In some embodiments, the Linolenic acid is in an amount of about 1.59% to about 2.15% of the total fatty acids. In some embodiments, the Linolenic acid is in an amount of about 1.87% of the total fatty acids. In some embodiments, the Linolenic acid is in an amount of about 1.11% to about 1.50% of the total fatty acids. In some embodiments, the Linolenic acid is in an amount of about 1.30% of the total fatty acids.

In some embodiments, the present disclosure relates to an oil, wherein Arachidonic acid (C20:4n6) is in an amount of about 0.60% to about 0.66% of the total fatty acids. In some embodiments, the Arachidonic acid is in an amount of about 0.60% to about 0.61%, about 0.61% to about 0.62%, about 0.62% to about 0.63%, about 0.63% to about 0.64%, about 0.64% to about 0.65%, or about 0.65% to about 0.66% of the total fatty acids, and any value within these ranges. In some embodiments, the Arachidonic acid is in an amount of about 0.63% of the total fatty acids. In some embodiments, the Arachidonic acid is in an amount of about 0.60%, about 0.61%, about 0.62%, about 0.63%, about 0.64%, about 0.65%, or about 0.66% of the total fatty acids, and ranges between any two of these values. In some embodiments, the Arachidonic acid is in an amount of about 0.54% to about 0.73% of the total fatty acids. In some embodiments, the Arachidonic acid is in an amount of about 0.63% of the total fatty acids. In some embodiments, the Arachidonic acid is in an amount of about 0.54% to about 0.73% of the total fatty acids. In some embodiments, the Arachidonic acid in an amount of about 0.63% of the total fatty acids.

In some embodiments, the present disclosure relates to an oil, wherein the Eicosapentaenoic acid (C20:5n3) is in an amount of about 0.06% to about 0.26% of the total fatty acids. In some embodiments, the Eicosapentaenoic acid is in an amount of about 0.06% to about 0.10%, about 0.10% to about 0.14%, about 0.14% to about 0.18%, about 0.18% to about 0.22%, or about 0.22% to about 0.26% of the total fatty acids, and any value within these ranges. In some embodiment, the Eicosapentaenoic acid is in an amount of about 0.11% of the total fatty acids. In some embodiments, the Eicosapentaenoic acid is in an amount of about 0.06%, about 0.7%, about 0.8%, about 0.9%, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, or about 0.26% of the total fatty acids, and ranges between any two of these values. In some embodiments, the Eicosapentaenoic acid is in an amount of about 0.07% to about 0.09% of the total fatty acids. In some embodiments, the Eicosapentaenoic acid is in an amount of about 0.08% of the total fatty acids. In some embodiments, the Eicosapentaenoic acid is in an amount of about 0.07% to about 0.09% of the total fatty acids. In some embodiments, the Eicosapentaenoic acid is in an amount of about 0.08% of the total fatty acids.

In some embodiments, the present disclosure relates to an oil, wherein the Docosapentaenoic acid (C22:5n3) is in an amount of about 0.04% to about 0.29% of the total fatty acids. In some embodiments, the Docosapentaenoic acid is in an amount of about 0.04% to about 0.09%, about 0.09% to about 0.14%, about 0.14% to about 0.19%, about 0.19% to about 0.24%, or about 0.24% to about 0.29% of the total fatty acids, and any value within these ranges. In some embodiments, the Docosapentaenoic acid is in an amount of about 0.17% of the total fatty acids. In some embodiments, the Docosapentaenoic acid is in an amount of about 0.04%, about 0.7%, about 0.09%, about 0.11%, about 0.14%, about 0.17%, about 0.19%, about 0.21%, about 0.24%, about 0.27%, or about 0.29% of the total fatty acids, and ranges between any two of these values. In some embodiments, the Docosapentaenoic acid is in an amount of about 0.03% to about 0.05% of the total fatty acids. In some embodiments, the Docosapentaenoic acid is in an amount of about 0.04% of the total fatty acids.

In some embodiments, the present disclosure relates to an oil, wherein the Docosahexaenoic acid (C22:6n3) is in an amount of about 0.35% to about 0.39% of the total fatty acids. In some embodiments, the Docosahexaenoic acid is in an amount of about 0.35% to about 0.36%, about 0.36% to about 0.37%, about 0.37% to about 0.38%, or about 0.38% to about 0.39% of the total fatty acids, and any value within these ranges. In some embodiments, the Docosahexaenoic acid is in an amount of about 0.37% of the total fatty acids. In some embodiments, the Docosahexaenoic acid is in an amount of about 0.35%, about 0.36%, about 0.37%, about 0.38%, or about 0.39% of the total fatty acids, and ranges between any two of these values. In some embodiments, the Docosahexaenoic acid is in an amount of about 0.31% to about 0.43% of the total fatty acids. In some embodiments, the Docosahexaenoic acid is in an amount of about 0.37% of the total fatty acids.

In some embodiments, the present disclosure relates to an oil, comprising Palmitic acid (C16:0), Linoleic acid (C18:2n6), Arachidonic acid (C20:4n6), Docosahexaenoic acid (C22:6n3), or combinations thereof.

In some embodiments, the present disclosure relates to an oil, comprising Palmitic acid (C16:0), Linoleic acid (C18:2n6), Arachidonic acid (C20:4n6), and Docosahexaenoic acid (C22:6n3).

In some embodiments, the present disclosure relates to an oil, wherein the oil comprises essentially no Erucic acid (C22:1). In some embodiments, the present disclosure relates to an oil, wherein the oil is free of Erucic acid (C22:1).

In some embodiments, the present disclosure relates to an oil, comprising Butyric acid (C4:0), Caproic acid (C6:0), Caprylic acid (C8:0), Capric acid (C10:0), Lauric acid (C12:0), Myristic acid (C14:0), Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), Myristoleic acid (C14:1), Palmitoleic acid (C16:1), Oleic acid (C181n9), Gadoleic acid (C20:1), Nervonic acid (C24:1), Linoleic acid (C18:2n6), Linolenic acid (C18:3n3), Arachidonic acid (C20:4n6), Eicosapentaenoic acid (C20:5n3), Docosapentaenoic acid (C22:5n3), and Docosahexaenoic acid (C22:6n3); and wherein the oil optionally further comprises Erucic acid (C22:1), Nervonic acid (C24:1), and combinations thereof.

In some embodiments, the present disclosure relates to an oil, comprising Butyric acid in an amount of about 0% to about 0.39% of the total fatty acids; Caproic acid in an amount of about 0.05% to about 0.39% of the total fatty acids; Caprylic acid in an amount of about 0.11% to about 1.68% of the total fatty acids; Capric acid in an amount of about 0.28% to about 2.00% of the total fatty acids; Lauric acid in an amount of about 4.40% to about 10.0% of the total fatty acids; Myristic acid in an amount of about 3.10% to about 10.0% of the total fatty acids; Pentadecanoic acid in an amount of about 0.16% to about 0.39% of the total fatty acids; Palmitic acid in an amount of about 18.67% to about 23.83% of the total fatty acids; Margaric acid in an amount of about 0.09% to about 0.41% of the total fatty acids; Stearic acid in an amount of about 3.61% to about 10.14% of the total fatty acids; Arachidic acid in an amount of about 0.19% to about 1.30% of the total fatty acids; Behenic acid in an amount of about 0.05% to about 0.57% of the total fatty acids; Lignoceric acid in an amount of about 0.02% to about 0.47% of the total fatty acids; Myristoleic acid in an amount of about 0.11% to about 0.50% of the total fatty acids; Palmitoleic acid in an amount of about 0.25% to about 2.70% of the total fatty acids; Oleic acid in an amount of about 26.20% to about 51.00% of the total fatty acids; Gadoleic acid in an amount of about 0.08% to about 0.60% of the total fatty acids; Erucic acid in an amount of less than about 0.10% of the total fatty acids; Nervonic acid in an amount of less than about 0.22% of the total fatty acids; Linoleic acid in an amount of about 5.85% to about 9.00% of the total fatty acids; Linolenic acid in an amount of about 0.89% to about 2.07% of the total fatty acids; Arachidonic acid in an amount of about 0.60% to about 0.66% of the total fatty acids; Eicosapentaenoic acid in an amount of about 0.06% to about 0.26% of the total fatty acids; Docosapentaenoic acid in an amount of about 0.04% to about 0.29% of the total fatty acids; and Docosahexaenoic acid in an amount of about 0.35% to about 0.39% of the total fatty acids.

In some embodiments, the present disclosure relates to an oil, comprising Butyric acid in an amount of about 0.35% of the total fatty acids; Caproic acid in an amount of about 0.14% of the total fatty acids; Caprylic acid in an amount of about 0.21% of the total fatty acids; Capric acid in an amount of about 1.57% of the total fatty acids; Lauric acid in an amount of about 5.90% of the total fatty acids; Myristic acid in an amount of about 6.61% of the total fatty acids; Pentadecanoic acid in an amount of about 0.28% of the total fatty acids; Palmitic acid in an amount of about 21.47% of the total fatty acids; Margaric acid in an amount of about 0.32% of the total fatty acids; Stearic acid in an amount of about 6.40% of the total fatty acids; Arachidic acid in an amount of about 0.22% of the total fatty acids; Behenic acid in an amount of about 0.11% of the total fatty acids; Lignoceric acid in an amount of about 0.08% of the total fatty acids; Myristoleic acid in an amount of about 0.22% of the total fatty acids; Palmitoleic acid in an amount of about 2.36% of the total fatty acids; Oleic acid in an amount of about 42.38% of the total fatty acids; Gadoleic acid in an amount of about 0.45% of the total fatty acids; Erucic acid in an amount of about 0% of the total fatty acids; Nervonic acid in an amount of about 0.09% of the total fatty acids; Linoleic acid in an amount of about 6.20% of the total fatty acids; Linolenic acid in an amount of about 1.02% of the total fatty acids; Arachidonic acid in an amount of about 0.63% of the total fatty acids; Eicosapentaenoic acid in an amount of about 0.11% of the total fatty acids; Docosapentaenoic acid in an amount of about 0.17% of the total fatty acids; and Docosahexaenoic acid in an amount of about 0.37% of the total fatty acids.

In some embodiments, the present disclosure relates to an oil, wherein the ratio of Arachidonic acid to Docosahexaenoic acid is about 1.4:1 to about 2:1. In some embodiments, the ratio of Arachidonic acid to Docosahexaenoic acid is about 1.7:1. In some embodiments, the ratio of Arachidonic acid to Docosahexaenoic acid is about 1.4:1, about 1.5:1, about 1.6:1, about 1.7:1, about 1.8:1, about 1.9:1, or about 2:1, and any range between any two of these values. In some embodiments, the ratio is about 4.5:1 to about 8.5:1, about 5:1 to about 8:1, about 5.5:1 to about 7.5:1, about 6:1 to about 7:1, or about 6.5:1 to about 6.5:1. In some embodiments, the ratio is about 3.5:1 to about 2.5:1, about 3:1 to about 2:1, or about 2.5:1 to about 1.5:1, and any value within these ranges.

In some embodiments, the present disclosure relates to an oil, wherein the ratio of Eicosapentaenoic acid to Docosahexaenoic acid is about 0.2:1 to about 0.8:1. In some embodiments, the present disclosure relates to an oil, wherein the ratio of Eicosapentaenoic acid to Docosahexaenoic acid is about 0.3:1. In some embodiments, the ratio of Eicosapentaenoic acid to Docosahexaenoic acid is about 0.2:1, about 0.3:1, about 0.4:1, about 0.5:1, about 0.6:1, about 0.7:1, or about 0.8:1, and any range between any two of these values. In some embodiments, the ratio is about 0.25:1 to about 0.75:1, about 0.3:1 to about 0.7:1, about 0.35:1 to about 0.65:1, about 0.4:1 to about 0.6:1, or about 0.45:1 to about 0.55:1, and any value within these ranges.

In some embodiments, the present disclosure relates to an oil, wherein the ratio of Linoleic acid to alpha-Linolenic acid is about 4:1 to about 20:1. In some embodiments, the present disclosure relates to an oil, wherein the ratio of Linoleic acid to alpha-Linolenic acid is about 4:1 to about 15:1. In some embodiments, the present disclosure relates to an oil, wherein the ratio of Linoleic acid to alpha-Linolenic acid is about 4:1 to about 9:1. In some embodiments, the present disclosure relates to an oil, wherein the ratio of Linoleic acid to alpha-Linolenic acid is about 6.1:1. In some embodiments, the ratio of Linoleic acid to alpha-Linolenic acid is about 4:1, about 4.5:1, about 5:1, about 5.5:1, about 6:1, about 6.1:1, about 6.5:1, about 7:1, about 7.5:1, about 8:1, about 8.5:1, or about 9:1, or about 15:1; or about 20:1, and ranges between any two of these values. In some embodiments, the ratio is about 4.5:1 to about 8.5:1, about 5:1 to about 8:1, about 5.5:1 to about 7.5:1, about 6:1 to about 7:1, or about 6:1 to about 6.5:1, and any value within these ranges.

In some embodiments, the present disclosure relates to an oil, wherein the polyunsaturated fatty acids comprise n-6 fatty acids, n-3 fatty acids, and combinations thereof. In some embodiments, the present disclosure relates to an oil, wherein the ratio of n-6 fatty acids to n-3 fatty acids is about 4.1:1. In some embodiments, the ratio of n-6 fatty acids to n-3 fatty acids is about 3.49:1, about 3.57:1, about 3.65:1, about 3.73:1, about 3.81:1, about 3.89:1, about 3.97:1, about 4.05:1, about 4.1:1, about 4.15:1, about 4.23:1, about 4.31:1, about 4.39:1, about 4.47:1, about 4.55:1, about 4.63:1, or about 4.71:1, and ranges between any two of these values. In some embodiments, the ratio is about 3.49:1 to about 4.71:1, about 3.65:1 to about 4.55:1, about 3.81:1 to about 4.39:1, about 3.97:1 to about 4.23:1, or about 4.05:1 to about 4.15:1, and any value within these ranges.

Embodiments of the present disclosure relate to oils comprising fatty acids, wherein the oil comprises saturated fatty acids, unsaturated fatty acids, and combinations thereof; and wherein the saturated fatty acids are selected from the group consisting of short/medium chain fatty acids comprising less than twelve carbons, intermediate chain fatty acids comprising twelve to fourteen carbons, long chain fatty acids comprising greater than fourteen carbons, and combinations thereof; and wherein the unsaturated fatty acids are selected from the group consisting of monounsaturated fatty acids, polyunsaturated fatty acids, and combinations thereof.

In some embodiments, the present disclosure relates to an oil, wherein the short/medium chain saturated fatty acids comprise about 3.87% of the total fatty acids. In some embodiments, the short/medium chain saturated fatty acids comprise about 3.29%, about 3.36%, about 3.43%, about 3.50%, about 3.57%, about 3.64%, about 3.71%, about 3.78%, about 3.85%, about 3.87%, about 3.92%, about 3.99%, about 4.06%, about 4.13%, about 4.20%, about 4.27%, about 4.34%, or about 4.45% of the total fatty acids, and ranges between any two of these values. In some embodiments, the short/medium chain saturated fatty acids comprise about 3.29% to about 4.45%, about 3.29% to about 3.75%, about 3.75% to about 4.25%, about 4.25% to about 4.45%, and any value within these ranges.

In some embodiments, the present disclosure relates to an oil, wherein the intermediate chain fatty acids comprise about 13.63% of the total fatty acids. In some embodiments, the intermediate chain fatty acids comprise about 11.59%, about 11.93%, about 12.27%, about 12.61%, about 12.95%, about 13.29%, about 13.63%, about 13.97%, about 14.31%, about 14.65%, about 14.99%, about 15.33%, or about 15.67% of the total fatty acids, and ranges between any two of these values. In some embodiments, the intermediate chain fatty acids comprise about 11.58% to about 15.68%, about 11.58% to about 12%, about 12% to about 13%, about 13% to about 14%, about 14% to about 15%, about 15% to about 15.68% of the total fatty acids, and any value within these ranges.

In some embodiments, the present disclosure relates to an oil, wherein the long chain fatty acids comprise about 13.85% of the total fatty acids. In some embodiments, the long chain fatty acids comprise about 11.77%, about 12.01%, about 12.25%, about 12.49%, about 12.73%, about 12.97%, about 13.21%, about 13.45%, about 13.69%, about 13.85%, about 14.01%, about 14.25%, about 14.49%, about 14.73%, about 14.97%, about 15.21%, or about 15.45% of the total fatty acids, and ranges between any two of these values. In some embodiments, the long chain fatty acids comprise about 11.77% to about 15.45%, about 11.77% to about 12%, about 12% to about 13%, about 13% to about 14%, about 14% to about 15%, about 15% to about 15.45% of the total fatty acids, and any value within these ranges.

In some embodiments, the present disclosure relates to an oil, wherein the monounsaturated fatty acids comprise about 55.56% of the total fatty acids. In some embodiments, the monounsaturated fatty acids comprise about 47.22%, about 48.56%, about 49.90%, about 51.24%, about 52.58%, about 53.92%, about 55.26%, about 56.60%, about 57.94%, about 59.28%, about 60.62%, about 61.96%, about 63.30%, or about 63.90% of the total fatty acids, and ranges between any two of these values. In some embodiments, the monounsaturated fatty acids comprise about 47.22% to about 63.90%, about 47.22% to about 48%, about 48% to about 50%, about 50% to about 52%, about 52% to about 54%, about 54% to about 56%, about 56% to about 58%, about 58% to about 60%, about 60% to about 62%, about 62% to about 64% of the total fatty acids, any value within these ranges.

In some embodiments, the present disclosure relates to an oil, wherein the polyunsaturated fatty acids comprise about 11.92% of the total fatty acids. In some embodiments, the polyunsaturated fatty acids comprise about 10.13%, about 10.37%, about 10.61%, about 10.85%, about 11.09%, about 11.33%, about 11.57%, about 11.81%, about 11.92%, about 12.05%, about 12.29%, about 12.53%, about 12.77%, about 13.01%, about 13.25%, about 13.49%, or about 13.71% of the total fatty acids, and ranges between any two of these values. In some embodiments, the polyunsaturated fatty acids comprise about 10.13% to about 13.71%, about 10.13% to about 10.5%, about 10.5% to about 11%, about 11% to about 11.5%, about 11.5% to about 12%, about 12% to about 12.5%, about 12.5% to about 13%, about 13% to about 13.5%, about 13.5% to about 13.71% of the total fatty acids, and any value within these ranges.

In some embodiments, the present disclosure relates to an oil, comprising Butyric acid in an amount of about 0.31% to about 0.42% of the total fatty acids; Caproic acid in an amount of about 0.31% to about 0.43% of the total fatty acids; Caprylic acid in an amount of about 1.44% to about 1.94% of the total fatty acids; Capric acid in an amount of about 1.23% to about 1.67% of the total fatty acids; Lauric acid in an amount of about 7.65% to about 10.35% of the total fatty acids; Myristic acid in an amount of about 3.94% to about 5.32% of the total fatty acids; Pentadecanoic acid in an amount of about 0.14% to about 0.20% of the total fatty acids; Palmitic acid in an amount of about 7.29% to about 9.87% of the total fatty acids; Margaric acid in an amount of about 0.08% to about 0.10% of the total fatty acids; Stearic acid in an amount of about 2.97% to about 4.51% of the total fatty acids; Arachidic acid in an amount of about 0.26% to about 0.36% of the total fatty acids; Behenic acid in an amount of about 0.48% to about 0.66% of the total fatty acids; Lignoceric acid in an amount of about 0.18% to about 0.24% of the total fatty acids; Myristoleic acid in an amount of about 0.09% to about 0.12% of the total fatty acids; Palmitoleic acid in an amount of about 0.20% to about 0.28% of the total fatty acids; Oleic acid in an amount of about 46.58% to about 63.02% of the total fatty acids; Gadoleic acid in an amount of about 0.31% to about 0.43% of the total fatty acids; Erucic acid in an amount of less than about 0.01% of the total fatty acids; Nervonic acid in an amount of less than about 0.05% of the total fatty acids; Linoleic acid in an amount of about 7.60% to about 10.27% of the total fatty acids; Linolenic acid in an amount of about 1.59% to about 2.15% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; and Docosahexaenoic acid in an amount of about 0.31% to about 0.43% of the total fatty acids.

In some embodiments, the present disclosure relates to an oil, comprising Butyric acid in an amount of about 0.36% of the total fatty acids; Caproic acid in an amount of about 0.37% of the total fatty acids; Caprylic acid in an amount of about 1.69% of the total fatty acids; Capric acid in an amount of about 1.45% of the total fatty acids; Lauric acid in an amount of about 9.00% of the total fatty acids; Myristic acid in an amount of about 4.63% of the total fatty acids; Pentadecanoic acid in an amount of about 0.17% of the total fatty acids; Palmitic acid in an amount of about 8.58% of the total fatty acids; Margaric acid in an amount of about 0.09% of the total fatty acids; Stearic acid in an amount of about 3.92% of the total fatty acids; Arachidic acid in an amount of about 0.31% of the total fatty acids; Behenic acid in an amount of about 0.57% of the total fatty acids; Lignoceric acid in an amount of about 0.21% of the total fatty acids; Myristoleic acid in an amount of about 0.10% of the total fatty acids; Palmitoleic acid in an amount of about 0.24% of the total fatty acids; Oleic acid in an amount of about 54.80% of the total fatty acids; Gadoleic acid in an amount of about 0.37% of the total fatty acids; Erucic acid in an amount of about 0.01% of the total fatty acids; Nervonic acid in an amount of about 0.04% of the total fatty acids; Linoleic acid in an amount of about 8.93% of the total fatty acids; Linolenic acid in an amount of about 1.87% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; and Docosahexaenoic acid in an amount of about 0.37% of the total fatty acids.

In some embodiments, the present disclosure relates to an oil, wherein the ratio of Arachidonic acid to Docosahexaenoic acid is about 1.7:1. In some embodiments, the ratio of Arachidonic acid to Docosahexaenoic acid is about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, or about 0.22:1, and any range between these values. In some embodiments, the ratio of Arachidonic acid to Docosahexaenoic acid is about 1.5:1 to about 0.5:1, about 1.3:1 to about 0.7:1, about 1.1:1 to about 0.9:1, or about 1:1 to about 0.8:1, and any value between these ranges.

In some embodiments, the present disclosure relates to an oil, wherein the ratio of Eicosapentaenoic acid to Docosahexaenoic acid is about 0.22:1. In some embodiments, the ratio of Eicosapentaenoic acid to Docosahexaenoic acid is about 0.19:1, about 0.20:1, about 0.21:1, about 0.22:1, about 0.23:1, about 0.24:1, about 0.25:1, about 0.26:1, about 0.27:1, about 0.28:1, about 0.29:1, about 0.30:1, about 0.31:1, about 0.32:1, about 0.33:1, about 0.34:1, about 0.35:1, or about 0.36:1, and any range between these values. In some embodiments, the ratio of Eicosapentaenoic acid to Docosahexaenoic acid is about 0.19:1 to about 0.20:1, about 0.20:1 to about 0.21:1, about 0.21:1 to about 0.22:1, about 0.22:1 to about 0.23:1, about 0.23:1 to about 0.24:1, about 0.24:1 to about 0.25:1, about 0.25:1 to about 0.26:1, about 0.26:1 to about 0.27:1, about 0.27:1 to about 0.28:1, about 0.28:1 to about 0.29:1, about 0.29:1 to about 0.30:1, about 0.30:1 to about 0.31:1, about 0.31:1 to about 0.32:1, about 0.32:1 to about 0.33:1, about 0.33:1 to about 0.34:1, or about 0.34:1 to about 0.35:1, and any ratio within these ranges.

In some embodiments, the present disclosure relates to an oil, wherein the ratio of Linoleic acid to alpha-Linolenic acid is about 4.78:1. In some embodiments, the ratio of Linoleic acid to alpha-Linolenic acid is about 4.06:1, about 4.15:1, about 4.24:1, about 4.33:1, about 4.42:1, about 4.51:1, about 4.60:1, about 4.69:1, about 4.78:1, about 4.87:1, about 4.96:1, about 5.05:1, about 5.14:1, about 5.23:1, about 5.32:1, about 5.41:1, or about 5.50:1, and any range between these values. In some embodiments, the ratio of Linoleic acid to alpha-Linolenic acid is about 4.06:1 to about 4.20:1, about 4.20:1 to about 4.34:1, about 4.34:1 to about 4.48:1, about 4.48:1 to about 4.62:1, about 4.62:1 to about 4.76:1, about 4.76:1 to about 4.90:1, about 4.90:1 to about 5.04:1, about 5.04:1 to about 5.18:1, about 5.18:1 to about 5.32:1, about 5.32:1 to about 5.46:1, or about 5.46:1 to about 5.50:1, and any ratio between these ranges.

In some embodiments, the present disclosure relates to an oil, wherein the polyunsaturated fatty acids comprise n-6 fatty acids, n-3 fatty acids, and combinations thereof. In some embodiments, the present disclosure relates to an oil, wherein the ratio of n-6 fatty acids to n-3 fatty acids is about 4.05:1. In some embodiments, the ratio of n-6 fatty acids to n-3 fatty acids is about 3.44:1, about 3.52:1, about 3.60:1, about 3.68:1, about 3.76:1, about 3.84:1, about 3.92:1, about 4.00:1, about 4.05:1, about 4.08:1, about 4.16:1, about 4.24:1, about 4.32:1, about 4.40:1, about 4.48:1, about 4.56:1, or about 4.66:1, and any ratio between these values. In some embodiments, the ratio of n-6 fatty acids to n-3 fatty acids is about 3.44:1 to about 3.58:1, about 3.58:1 to about 3.72:1, about 3.72:1 to about 3.86:1, about 3.86:1 to about 4.00:1, about 4.00:1 to about 4.14:1, about 4.14:1 to about 4.28:1, about 4.28:1 to about 4.42:1, about 4.42:1 to about 4.56:1, or about 4.56:1 to about 4.66:1, and any ratio between these ranges.

In some embodiments, the present disclosure relates to an oil, wherein the short/medium chain saturated fatty acids comprise about 3.10% of the total fatty acids. In some embodiments, the short/medium chain saturated fatty acids comprise about 2.64%, about 2.71%, about 2.78%, about 2.85%, about 2.92%, about 2.99%, about 3.06%, about 3.13%, about 3.20%, about 3.27%, about 3.34%, about 3.41%, about 3.48%, about 3.55%, or about 3.62% of the total fatty acids, and any value within these ranges.

In some embodiments, the present disclosure relates to an oil, wherein the intermediate chain fatty acids comprise about 10.41% of the total fatty acids. In some embodiments, the present disclosure relates to an oil, wherein the intermediate chain fatty acids comprise about 8.85%, about 9.06%, about 9.27%, about 9.48%, about 9.69%, about 9.90%, about 10.11%, about 10.32%, about 10.53%, about 10.74%, about 10.95%, about 11.16%, about 11.37%, about 11.58%, about 11.79%, or about 11.97% of the total fatty acids, and any value within these ranges.

In some embodiments, the present disclosure relates to an oils, wherein the long chain fatty acids comprise about 32.71% of the total fatty acids. In some embodiments, the long chain fatty acids comprise about 27.80%, about 28.41%, about 29.02%, about 29.63%, about 30.24%, about 30.85%, about 31.46%, about 32.07%, about 32.68%, about 33.29%, about 33.90%, about 34.51%, about 35.12%, about 35.73%, about 36.34%, about 36.95%, or about 37.62% of the total fatty acids, and any value within these ranges.

In some embodiments, the present disclosure relates to an oil, wherein the monounsaturated fatty acids comprise about 47.18% of the total fatty acids. In some embodiments, the monounsaturated fatty acids comprise about 40.10%, about 41.02%, about 41.94%, about 42.86%, about 43.78%, about 44.70%, about 45.62%, about 46.54%, about 47.18%, about 47.46%, about 48.38%, about 49.30%, about 50.22%, about 51.14%, about 52.06%, about 52.98%, or about 54.26% of the total fatty acids, and any value within these ranges.

In some embodiments, the present disclosure relates to an oil, wherein the polyunsaturated fatty acids comprise about 8.98% of the total fatty acids. In some embodiments, the polyunsaturated fatty acids comprise about 7.63%, about 7.80%, about 7.97%, about 8.14%, about 8.31%, about 8.48%, about 8.65%, about 8.82%, about 8.98%, about 9.15%, about 9.32%, about 9.49%, about 9.66%, about 9.83%, about 10.00%, about 10.17%, or about 10.33% of the total fatty acids, and any value within these ranges.

In some embodiments, the present disclosure relates to an oil, comprising: Butyric acid in an amount of about 0.31% to about 0.42% of the total fatty acids; Caproic acid in an amount of about 0.28% to about 0.38% of the total fatty acids; Caprylic acid in an amount of about 1.08% to about 1.46% of the total fatty acids; Capric acid in an amount of about 0.97% to about 1.31% of the total fatty acids; Lauric acid in an amount of about 5.67% to about 7.67% of the total fatty acids; Myristic acid in an amount of about 3.18% to about 4.30% of the total fatty acids; Pentadecanoic acid in an amount of about 0.14% to about 0.20% of the total fatty acids; Palmitic acid in an amount of about 18.17% to about 24.59% of the total fatty acids; Margaric acid in an amount of about 0.20% to about 0.28% of the total fatty acids; Stearic acid in an amount of about 7.92% to about 10.72% of the total fatty acids; Arachidic acid in an amount of about 0.67% to about 0.91% of the total fatty acids; Behenic acid in an amount of about 0.35% to about 0.47% of the total fatty acids; Lignoceric acid in an amount of about 0.34% to about 0.46% of the total fatty acids; Myristoleic acid in an amount of about 0.09% to about 0.13% of the total fatty acids; Palmitoleic acid in an amount of about 1.42% to about 1.92% of the total fatty acids; Oleic acid in an amount of about 38.27% to about 51.78% of the total fatty acids; Gadoleic acid in an amount of about 0.32% to about 0.44% of the total fatty acids; Linoleic acid in an amount of about 5.58% to about 7.54% of the total fatty acids; Linolenic acid in an amount of about 1.11% to about 1.50% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; Docosahexaenoic acid in an amount of about 0.31% to about 0.43% of the total fatty acids; and wherein the oil comprises essentially no Erucic acid and essentially no Nervonic acid.

In some embodiments, the present disclosure relates to an oil, comprising: Butyric acid in an amount of about 0.36% of the total fatty acids; Caproic acid in an amount of about 0.33% of the total fatty acids; Caprylic acid in an amount of about 1.27% of the total fatty acids; Capric acid in an amount of about 1.14% of the total fatty acids; Lauric acid in an amount of about 6.67% of the total fatty acids; Myristic acid in an amount of about 3.74% of the total fatty acids; Pentadecanoic acid in an amount of about 0.17% of the total fatty acids; Palmitic acid in an amount of about 21.38% of the total fatty acids; Margaric acid in an amount of about 0.24% of the total fatty acids; Stearic acid in an amount of about 9.32% of the total fatty acids; Arachidic acid in an amount of about 0.79% of the total fatty acids; Behenic acid in an amount of about 0.41% of the total fatty acids; Lignoceric acid in an amount of about 0.40% of the total fatty acids; Myristoleic acid in an amount of about 0.11% of the total fatty acids; Palmitoleic acid in an amount of about 1.67% of the total fatty acids; Oleic acid in an amount of about 45.02% of the total fatty acids; Gadoleic acid in an amount of about 0.38% of the total fatty acids; Linoleic acid in an amount of about 6.56% of the total fatty acids; Linolenic acid in an amount of about 1.30% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; Docosahexaenoic acid in an amount of about 0.37% of the total fatty acids; and wherein the oil comprises essentially no Erucic acid and essentially no Nervonic acid.

In some embodiments, the present disclosure relates to an oil, wherein the ratio of Arachidonic acid to Docosahexaenoic acid is about 1.7:1. In some embodiments, the ratio of Arachidonic acid to Docosahexaenoic acid is about 1.45:1, about 1.48:1, about 1.51:1, about 1.54:1, about 1.57:1, about 1.60:1, about 1.63:1, about 1.66:1, about 1.70:1, about 1.73:1, about 1.76:1, about 1.79:1, about 1.82:1, about 1.85:1, about 1.88:1, about 1.91:1, or about 1.96:1, and any range between these values. In some embodiments, the ratio of Arachidonic acid to Docosahexaenoic acid is about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, or about 0.22:1, and any range between these values. In some embodiments, the ratio is about 1.5:1 to about 0.5:1, about 1.3:1 to about 0.7:1, about 1.1:1 to about 0.9:1, or about 1:1 to about 0.8:1, and any value between these ranges.

In some embodiments, the present disclosure relates to an oil, wherein the ratio of Eicosapentaenoic acid to Docosahexaenoic acid is about 0.22:1. In some embodiments, the ratio of Eicosapentaenoic acid to Docosahexaenoic acid is about 0.19:1, about 0.20:1, about 0.21:1, about 0.22:1, about 0.23:1, about 0.24:1, about 0.25:1, and any range between these values. In some embodiments, the ratio of Eicosapentaenoic acid to Docosahexaenoic acid is about 0.19:1 to about 0.20:1, about 0.20:1 to about 0.21:1, about 0.21:1 to about 0.22:1, about 0.22:1 to about 0.23:1, about 0.23:1 to about 0.24:1, about 0.24:1 to about 0.25:1, about 0.25:1 to about 0.26:1, about 0.26:1 to about 0.27:1, about 0.27:1 to about 0.28:1, about 0.28:1 to about 0.29:1, about 0.29:1 to about 0.30:1, about 0.30:1 to about 0.31:1, about 0.31:1 to about 0.32:1, about 0.32:1 to about 0.33:1, about 0.33:1 to about 0.34:1, or about 0.34:1 to about 0.35:1, and any ratio within these ranges.

In some embodiments, the present disclosure relates to an oil, wherein the ratio of Linoleic acid to alpha-Linolenic acid is about 5.05:1. In some embodiments, the ratio of Linoleic acid to alpha-Linolenic acid is about 4.29:1, about 4.37:1, about 4.45:1, about 4.53:1, about 4.61:1, about 4.69:1, about 4.77:1, about 4.85:1, about 4.93:1, about 5.01:1, about 5.05:1, about 5.09:1, about 5.17:1, about 5.25:1, about 5.33:1, about 5.41:1, about 5.49:1, about 5.57:1, about 5.65:1, about 5.73:1, or about 5.81:1, and any range between these values. In some embodiments, the ratio of Linoleic acid to alpha-Linolenic acid is about 4.26:1 to about 5.81:1, about 4.26:1 to about 4.34:1, about 4.34:1 to about 4.48:1, about 4.48:1 to about 4.62:1, about 4.62:1 to about 4.76:1, about 4.76:1 to about 4.90:1, about 4.90:1 to about 5.04:1, about 5.04:1 to about 5.18:1, about 5.18:1 to about 5.32:1, about 5.32:1 to about 5.46:1, about 5.46:1 to about 5.50:1, about 5.50:1 to about 5.81:1, and any ratio between these ranges.

In some embodiments, the present disclosure relates to an oil, wherein the polyunsaturated fatty acids comprise n-6 fatty acids, n-3 fatty acids, and combinations thereof. In some embodiments, the present disclosure relates to an oil, wherein the ratio of n-6 fatty acids to n-3 fatty acids is about 4.02:1. In some embodiments, the ratio of n-6 fatty acids to n-3 fatty acids is about 3.42:1, about 3.48:1, about 3.54:1, about 3.60:1, about 3.66:1, about 3.72:1, about 3.78:1, about 3.84:1, about 3.90:1, about 3.96:1, about 4.02:1, about 4.08:1, about 4.14:1, about 4.20:1, about 4.26:1, about 4.32:1, about 4.38:1, about 4.44:1, about 4.50:1, about 4.56:1, about 4.62:1, and any range between these values. In some embodiments, the ratio of n-6 fatty acids to n-3 fatty acids is about 3.42:1 to about 3.58:1, about 3.58:1 to about 3.72:1, about 3.72:1 to about 3.86:1, about 3.86:1 to about 4.00:1, about 4.00:1 to about 4.14:1, about 4.14:1 to about 4.28:1, about 4.28:1 to about 4.42:1, about 4.42:1 to about 4.56:1, or about 4.56:1 to about 4.62:1, and any ratio between these ranges.

In some embodiments, the present disclosure relates to an oil, wherein the fatty acids are derived from recombinant sources. In some embodiments, the present disclosure relates to an oil, wherein the fatty acids are derived from only recombinant sources. Recombinant sources include, but are not limited to genetically engineered microorganisms (e.g. bacteria, yeast, algae), transgenic plants, transgenic animals, cell-free protein synthesis systems, recombinant enzymes, engineered cell lines, synthetic biology platforms, recombinant DNA technology, CRISPR-engineered organisms, recombinant protein production systems, metabolically engineered microbes, genetically modified crops, recombinant antibody production systems, engineered mammalian cell cultures, recombinant vaccine production platforms, engineered insect cell lines, recombinant gene therapy vectors, engineered plant cell cultures, recombinant hormone production systems, engineered microbial consortia, recombinant enzyme bioreactors, engineered chloroplasts, recombinant protein secretion systems, engineered fungi, recombinant nucleic acid production systems, carbon dioxide and water sources via thermal chemistry, and combinations thereof.

In some embodiments, the present disclosure relates to an oil, wherein the fatty acids are derived from recombinant sources in combination with whole milk powder. In some embodiments, the present disclosure relates to an oil, wherein the fatty acids are derived from whole milk and plant oils.

In some embodiments, the present disclosure relates to an oil, wherein the plant oils are selected from the group comprising coconut oil, canola oil, sunflower oil, algal oil, and combinations thereof. In some embodiments, the present disclosure relates to an oil, wherein the plant oils are selected from the group comprising coconut oil, algal oil, and combinations thereof. In some embodiments, plant oils include but are not limited to Coconut oil, olive oil, palm oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, palm kernel oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

In some embodiments, the present disclosure relates to an oil, wherein the fatty acids are derived from whole milk, plant oils, and recombinant oils.

In some embodiments, the present disclosure relates to an oil, wherein the whole milk powder is in an amount of about 11% to about 21% of the oil. In some embodiments, the present disclosure relates to an oil, wherein the whole milk powder is in an amount of about 11.7% of the oil. In some embodiments, the present disclosure relates to an oil, wherein the whole milk powder is in an amount of about 21% of the oil. In some embodiments, the present disclosure relates to an oil, wherein the whole milk powder comprises less than about 50% milkfat. In some embodiments, the present disclosure relates to an oil, wherein the whole milk powder comprises about 26% to about 42% milkfat. In some embodiments, the present disclosure relates to an oil, wherein the whole milk powder comprises substantially no milkfat. In some embodiments, the present disclosure relates to an oil, wherein the whole milk powder comprises nonfat whole milk.

In some embodiments, the present disclosure relates to an oil, wherein the fatty acids are derived from fatty fish, algae, fungi, dairy products, cooking oils, plant source, or combinations thereof.

In some embodiments, the present disclosure relates to an oil, wherein the fatty fish are salmon, mackerel, sardines, trout, herring, tuna, or combinations thereof.

In some embodiments, the present disclosure relates to an oil, wherein the dairy products are butter, cheese, cream, whole milk, or combinations thereof.

In some embodiments, the present disclosure relates to an oil, wherein the cooking oils are palm oil, coconut oil, vegetable oil, or combinations thereof. In some embodiments, the cooking oil is vegetable oil, canola oil, olive oil, coconut oil, sunflower oil, corn oil, peanut oil, soybean oil, grapeseed oil, avocado oil, sesame oil, safflower oil, palm oil, rice bran oil, almond oil, walnut oil, flaxseed oil, cottonseed oil, ghee, lard, butter, margarine, shortening, palm kernel oil, mustard oil, groundnut oil, rapeseed oil, hemp seed oil, pumpkin seed oil, macadamia oil, hazelnut oil, grape seed oil, argan oil, camellia oil, tea seed oil, and combinations thereof.

In some embodiments, the present disclosure relates to an oil that does not include or is substantially free of palm oil, seed oils, soybean oil, rapeseed oil, and/or cottonseed oil. The oil may comprise less than about 5%, less than about 2%, less than about 1%, or less than about 0.5% of these oils, based on the total weight of the oil.

In some embodiments, the present disclosure relates to an oil, wherein the plant source is a nut, a seed, an avocado, a plant oil, a soybean product, a whole grain, or combinations thereof.

In some embodiments, the present disclosure relates to an oil, wherein the nut or seed is an almond, a walnut, flaxseed, chia seed, hemp seed, pumpkin seed, or combinations thereof. In some embodiments, the nut or seed oil is almond, walnut, hazelnut, macadamia, pecan, pistachio, cashew, brazil nut, coconut, sunflower, pumpkin, flaxseed, chia, sesame, hemp, poppy, grape seed, rapeseed (also known as canola), safflower, cotton seed, and combinations thereof.

In some embodiments, the present disclosure relates to an oil, wherein the plant oil is olive oil, canola oil, flaxseed oil, walnut oil, sesame oil, or combinations thereof. In some embodiments, the present disclosure relates to an oil, wherein the soybean product is tofu, tempeh, edamame, or combinations thereof. In some embodiments, the present disclosure relates to an oil, wherein the whole grain is oats, quinoa, brown rice, or combinations thereof.

Embodiments of the present disclosure relate to preparing any oil described herein by combining the fatty acids.

Embodiments of the present disclosure relate to an infant formula comprising an oil of any embodiment described herein. In some embodiments, the infant formula mimics human breast milk.

### FURTHER EMBODIMENTS

Aspect 1. A composition comprising fatty acids, wherein the composition comprises saturated fatty acids, unsaturated fatty acids, and combinations thereof.

Aspect 2. The composition of Aspect 1, wherein the saturated fatty acids are selected from the group consisting of short/medium chain fatty acids, intermediate chain fatty acids, long chain fatty acids, and combinations thereof.

Aspect 3. The composition of Aspect 2, wherein the short/medium chain fatty acids comprise less than twelve carbons.

Aspect 4. The composition of Aspect 2, wherein the short/medium chain fatty acids are selected from the group consisting of Butyric acid (C4:0), Caproic acid (C6:0), Caprylic acid (C8:0), Capric acid (C10:0), and combinations thereof.

Aspect 5. The composition of Aspect 4, wherein the Butyric acid (C4:0) is in an amount of less than about 0.39% of the total fatty acids.

Aspect 6. The composition of Aspect 4, wherein the Caproic acid (C6:0) is in an amount of about 0.05% to about 0.39% of the total fatty acids.

Aspect 7. The composition of Aspect 4, wherein the Caprylic acid (C8:0) is in an amount of about 0.11% to about 1.68% of the total fatty acids.

Aspect 8. The composition of Aspect 4, wherein the Capric acid (C10:0) is in an amount of about 0.28% to about 2.00% of the total fatty acids.

Aspect 9. The composition of Aspect 2, wherein the intermediate chain fatty acids comprise twelve to fourteen carbons.

Aspect 10. The composition of Aspect 9, wherein the intermediate chain fatty acids are selected from the group consisting of Myristic acid (C14:0), Lauric acid (C12:0), and combinations thereof.

Aspect 11. The composition of Aspect 10, wherein the Lauric acid (C12:0) is in an amount of about 4.40% to about 10.0% of the total fatty acids.

Aspect 12. The composition of Aspect 10, wherein the Myristic acid (C14:0) is in an amount of about 3.10% to about 10.0% of the total fatty acids.

Aspect 13. The composition of Aspect 2, wherein the long chain fatty acids comprise greater than fourteen carbons.

Aspect 14. The composition of Aspect 13, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

Aspect 15. The composition of Aspect 14, wherein the Pentadecanoic acid (C15:0) is in an amount of about 0.16% to about 0.39% of the total fatty acids.

Aspect 16. The composition of Aspect 14, wherein the Palmitic acid (C16:0) is in an amount of about 18.67% to about 23.83% of the total fatty acids.

Aspect 17. The composition of Aspect 14, wherein the Margaric acid (C17:0) is in an amount of about 0.09% to about 0.41% of the total fatty acids.

Aspect 18. The composition of Aspect 14, wherein the Stearic acid (C18:0) is in an amount of about 3.61% to about 10.14% of the total fatty acids.

Aspect 19. The composition of Aspect 14, wherein the Arachidic acid (C20:0) is in an amount of about 0.19% to about 1.30% of the total fatty acids.

Aspect 20. The composition of Aspect 14, wherein the Behenic acid (C22:0) is in an amount of about 0.05% to about 0.57% of the total fatty acids.

Aspect 21. The composition of Aspect 14, wherein the Lignoceric acid (C24:0) is in an amount of about 0.02% to about 0.47% of the total fatty acids.

Aspect 22. The composition of Aspect 1, wherein the unsaturated fatty acids are selected from the group consisting of monounsaturated fatty acids, polyunsaturated fatty acids, and combinations thereof.

Aspect 23. The composition of Aspect 22, wherein the fatty acids are monounsaturated fatty acids are selected from the group consisting of Myristoleic acid (C14:1), Palmitoleic acid (C16:1), Oleic acid (C18:1n9), Gadoleic acid (C20:1), and combinations thereof.

Aspect 24. The composition of Aspect 23, wherein the Myristoleic acid (C14:1) is in an amount of about 0.11% to about 0.50% of the total fatty acids.

Aspect 25. The composition of Aspect 23, wherein the Palmitoleic acid (C16:1) is in an amount of about 0.25% to about 2.70% of the total fatty acids.

Aspect 26. The composition of Aspect 23, wherein the Oleic acid (C18:1n9) is in an amount of about 26.20% to about 51.00% of the total fatty acids.

Aspect 27. The composition of Aspect 23, wherein the Gadoleic acid (C20:1) is in an amount of about 0.08% to about 0.60% of the total fatty acids.

Aspect 28. The composition of Aspect 23, wherein the composition comprises less than about 0.10% Erucic acid (C22:1).

Aspect 29. The composition of Aspect 23, wherein the composition comprises less than about 0.22% Nervonic acid (C24:1).

Aspect 30. The composition of Aspect 22, wherein the fatty acids are polyunsaturated fatty acids are selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

Aspect 31. The composition of Aspect 30, wherein the Linoleic acid (C18:2n6) is in an amount of about 5.85% to about 9.00% of the total fatty acids.

Aspect 32. The composition of Aspect 30, wherein the Linolenic acid (C18:3n3) is in an amount of about 0.89% to about 2.07% of the total fatty acids.

Aspect 33. The composition of Aspect 30, wherein Arachidonic acid (C20:4n6) is in an amount of about 0.60% to about 0.66% of the total fatty acids.

Aspect 34. The composition of Aspect 30, wherein the Eicosapentaenoic acid (C20:5n3) is in an amount of about 0.06% to about 0.26% of the total fatty acids.

Aspect 35. The composition of Aspect 30, wherein the Docosapentaenoic acid (C22:5n3) is in an amount of about 0.04% to about 0.29% of the total fatty acids.

Aspect 36. The composition of Aspect 30, wherein the Docosahexaenoic acid (C22:6n3) is in an amount of about 0.35% to about 0.39% of the total fatty acids.

Aspect 37. The composition of Aspect 1, comprising Palmitic acid (C16:0), Linoleic acid (C18:2n6), Arachidonic acid (C20:4n6), Docosahexaenoic acid (C22:6n3), or combinations thereof.

Aspect 38. The composition of Aspect 1, comprising Palmitic acid (C16:0), Linoleic acid (C18:2n6), Arachidonic acid (C20:4n6), and Docosahexaenoic acid (C22:6n3).

Aspect 39. The composition of Aspect 37 or claim 38, wherein the composition comprises essentially no Erucic acid (C22:1).

Aspect 40. The composition of Aspect 39, wherein the composition is free of Erucic acid (C22:1).

Aspect 41. The composition of Aspect 1, comprising Butyric acid (C4:0), Caproic acid (C6:0), Caprylic acid (C8:0), Capric acid (C10:0), Lauric acid (C12:0), Myristic acid (C14:0), Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), Myristoleic acid (C14:1), Palmitoleic acid (C16:1), Oleic acid (C181n9), Gadoleic acid (C20:1), Nervonic acid (C24:1), Linoleic acid (C18:2n6), Linolenic acid (C18:3n3), Arachidonic acid (C20:4n6), Eicosapentaenoic acid (C20:5n3), Docosapentaenoic acid (C22:5n3), and Docosahexaenoic acid (C22:6n3); and wherein the composition optionally further comprises Erucic acid (C22:1), Nervonic acid (C24:1), and combinations thereof.

Aspect 42. The composition of Aspect 41, comprising: Butyric acid in an amount of about 0% to about 0.39% of the total fatty acids; Caproic acid in an amount of about 0.05% to about 0.39% of the total fatty acids; Caprylic acid in an amount of about 0.11% to about 1.68% of the total fatty acids; Capric acid in an amount of about 0.28% to about 2.00% of the total fatty acids; Lauric acid in an amount of about 4.40% to about 10.0% of the total fatty acids; Myristic acid in an amount of about 3.10% to about 10.0% of the total fatty acids; Pentadecanoic acid in an amount of about 0.16% to about 0.39% of the total fatty acids; Palmitic acid in an amount of about 18.67% to about 23.83% of the total fatty acids; Margaric acid in an amount of about 0.09% to about 0.41% of the total fatty acids; Stearic acid in an amount of about 3.61% to about 10.14% of the total fatty acids; Arachidic acid in an amount of about 0.19% to about 1.30% of the total fatty acids; Behenic acid in an amount of about 0.05% to about 0.57% of the total fatty acids; Lignoceric acid in an amount of about 0.02% to about 0.47% of the total fatty acids; Myristoleic acid in an amount of about 0.11% to about 0.50% of the total fatty acids; Palmitoleic acid in an amount of about 0.25% to about 2.70% of the total fatty acids; Oleic acid in an amount of about 26.20% to about 51.00% of the total fatty acids; Gadoleic acid in an amount of about 0.08% to about 0.60% of the total fatty acids; Erucic acid in an amount of less than about 0.10% of the total fatty acids; Nervonic acid in an amount of less than about 0.22% of the total fatty acids; Linoleic acid in an amount of about 5.85% to about 9.00% of the total fatty acids; Linolenic acid in an amount of about 0.89% to about 2.07% of the total fatty acids; Arachidonic acid in an amount of about 0.60% to about 0.66% of the total fatty acids; Eicosapentaenoic acid in an amount of about 0.06% to about 0.26% of the total fatty acids; Docosapentaenoic acid in an amount of about 0.04% to about 0.29% of the total fatty acids; and Docosahexaenoic acid in an amount of about 0.35% to about 0.39% of the total fatty acids.

Aspect 43. The composition of Aspect 41, comprising: Butyric acid in an amount of about 0.35% of the total fatty acids; Caproic acid in an amount of about 0.14% of the total fatty acids; Caprylic acid in an amount of about 0.21% of the total fatty acids; Capric acid in an amount of about 1.57% of the total fatty acids; Lauric acid in an amount of about 5.90% of the total fatty acids; Myristic acid in an amount of about 6.61% of the total fatty acids; Pentadecanoic acid in an amount of about 0.28% of the total fatty acids; Palmitic acid in an amount of about 21.47% of the total fatty acids; Margaric acid in an amount of about 0.32% of the total fatty acids; Stearic acid in an amount of about 6.40% of the total fatty acids; Arachidic acid in an amount of about 0.22% of the total fatty acids; Behenic acid in an amount of about 0.11% of the total fatty acids; Lignoceric acid in an amount of about 0.08% of the total fatty acids; Myristoleic acid in an amount of about 0.22% of the total fatty acids; Palmitoleic acid in an amount of about 2.36% of the total fatty acids; Oleic acid in an amount of about 42.38% of the total fatty acids; Gadoleic acid in an amount of about 0.45% of the total fatty acids; Erucic acid in an amount of about 0% of the total fatty acids; Nervonic acid in an amount of about 0.09% of the total fatty acids; Linoleic acid in an amount of about 6.20% of the total fatty acids; Linolenic acid in an amount of about 1.02% of the total fatty acids; Arachidonic acid in an amount of about 0.63% of the total fatty acids; Eicosapentaenoic acid in an amount of about 0.11% of the total fatty acids; Docosapentaenoic acid in an amount of about 0.17% of the total fatty acids; and Docosahexaenoic acid in an amount of about 0.37% of the total fatty acids.

Aspect 44. The composition of any one of Aspects 1 to 43, wherein the ratio of Arachidonic acid to Docosahexaenoic acid is about 1.4:1 to about 2:1.

Aspect 45. The composition of Aspect 44, wherein the ratio of Arachidonic acid to Docosahexaenoic acid is about 1.7:1.

Aspect 46. The composition of any one of Aspects 1 to 43, wherein the ratio of Eicosapentaenoic acid to Docosahexaenoic acid is about 0.2:1 to about 0.8:1.

Aspect 47. The composition of any one of Aspects 1 to 43, wherein the ratio of Eicosapentaenoic acid to Docosahexaenoic acid is about 0.3:1.

Aspect 48. The composition of any one of Aspects 1 to 43, wherein the ratio of Linoleic acid to alpha-Linolenic acid is about 4:1 to about 9:1.

Aspect 49. The composition of any one of Aspects 1 to 43, wherein the ratio of Linoleic acid to alpha-Linolenic acid is about 6.1:1.

Aspect 50. The composition of Aspect 22, wherein the polyunsaturated fatty acids comprise n-6 fatty acids, n-3 fatty acids, and combinations thereof.

Aspect 51. The composition of Aspect 50, wherein the ratio of n-6 fatty acids to n-3 fatty acids is about 3.49:1 to about 4.71:1.

Aspect 52. The composition of Aspects 50, wherein the ratio of n-6 fatty acids to n-3 fatty acids is about 4.1:1.

Aspect 53. A composition comprising fatty acids, wherein the composition comprises saturated fatty acids, unsaturated fatty acids, and combinations thereof; and wherein the saturated fatty acids are selected from the group consisting of short/medium chain fatty acids comprising less than twelve carbons, intermediate chain fatty acids comprising twelve to fourteen carbons, long chain fatty acids comprising greater than fourteen carbons, and combinations thereof; and wherein the unsaturated fatty acids are selected from the group consisting of monounsaturated fatty acids, polyunsaturated fatty acids, and combinations thereof.

Aspect 54. The composition of Aspect 53, comprising: Butyric acid in an amount of about 0.31% to about 0.42% of the total fatty acids; Caproic acid in an amount of about 0.31% to about 0.43% of the total fatty acids; Caprylic acid in an amount of about 1.44% to about 1.94% of the total fatty acids; Capric acid in an amount of about 1.23% to about 1.67% of the total fatty acids; Lauric acid in an amount of about 7.65% to about 10.35% of the total fatty acids; Myristic acid in an amount of about 3.94% to about 5.32% of the total fatty acids; Pentadecanoic acid in an amount of about 0.14% to about 0.20% of the total fatty acids; Palmitic acid in an amount of about 7.29% to about 9.87% of the total fatty acids; Margaric acid in an amount of about 0.08% to about 0.10% of the total fatty acids; Stearic acid in an amount of about 3.33% to about 4.51% of the total fatty acids; Arachidic acid in an amount of about 0.26% to about 0.36% of the total fatty acids; Behenic acid in an amount of about 0.48% to about 0.66% of the total fatty acids; Lignoceric acid in an amount of about 0.18% to about 0.24% of the total fatty acids; Myristoleic acid in an amount of about 0.09% to about 0.12% of the total fatty acids; Palmitoleic acid in an amount of about 0.20% to about 0.28% of the total fatty acids; Oleic acid in an amount of about 46.58% to about 63.02% of the total fatty acids; Gadoleic acid in an amount of about 0.31% to about 0.43% of the total fatty acids; Erucic acid in an amount of less than about 0.01% of the total fatty acids; Nervonic acid in an amount of less than about 0.05% of the total fatty acids; Linoleic acid in an amount of about 7.60% to about 10.27% of the total fatty acids; Linolenic acid in an amount of about 1.59% to about 2.15% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; and Docosahexaenoic acid in an amount of about 0.31% to about 0.43% of the total fatty acids.

Aspect 55. The composition of Aspect 53, comprising: Butyric acid in an amount of about 0.36% of the total fatty acids; Caproic acid in an amount of about 0.37% of the total fatty acids; Caprylic acid in an amount of about 1.69% of the total fatty acids; Capric acid in an amount of about 1.45% of the total fatty acids; Lauric acid in an amount of about 9.00% of the total fatty acids; Myristic acid in an amount of about 4.63% of the total fatty acids; Pentadecanoic acid in an amount of about 0.17% of the total fatty acids; Palmitic acid in an amount of about 8.58% of the total fatty acids; Margaric acid in an amount of about 0.09% of the total fatty acids; Stearic acid in an amount of about 3.92% of the total fatty acids; Arachidic acid in an amount of about 0.31% of the total fatty acids; Behenic acid in an amount of about 0.57% of the total fatty acids; Lignoceric acid in an amount of about 0.21% of the total fatty acids; Myristoleic acid in an amount of about 0.10% of the total fatty acids; Palmitoleic acid in an amount of about 0.24% of the total fatty acids; Oleic acid in an amount of about 54.80% of the total fatty acids; Gadoleic acid in an amount of about 0.37% of the total fatty acids; Erucic acid in an amount of about 0.01% of the total fatty acids; Nervonic acid in an amount of about 0.04% of the total fatty acids; Linoleic acid in an amount of about 8.93% of the total fatty acids; Linolenic acid in an amount of about 1.87% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; and Docosahexaenoic acid in an amount of about 0.37% of the total fatty acids.

Aspect 56. The composition of any one of Aspects 53 to 55, wherein the ratio of Arachidonic acid to Docosahexaenoic acid is about 1.7:1.

Aspect 57. The composition of any one of Aspects 53 to 55, wherein the ratio of Eicosapentaenoic acid to Docosahexaenoic acid is about 0.22:1.

Aspect 58. The composition any one of Aspects 53 to 55, wherein the ratio of Linoleic acid to alpha-Linolenic acid is about 4.78:1.

Aspect 59. The composition of any one of Aspects 53 to 55, wherein the polyunsaturated fatty acids comprise n-6 fatty acids, n-3 fatty acids, and combinations thereof.

Aspect 60. The composition of Aspect 59, wherein the ratio of n-6 fatty acids to n-3 fatty acids is about 4.05:1.

Aspect 61. The composition of Aspect 53, comprising: Butyric acid in an amount of about 0.31% to about 0.42% of the total fatty acids; Caproic acid in an amount of about 0.28% to about 0.38% of the total fatty acids; Caprylic acid in an amount of about 1.08% to about 1.46% of the total fatty acids; Capric acid in an amount of about 0.97% to about 1.31% of the total fatty acids; Lauric acid in an amount of about 5.67% to about 7.67% of the total fatty acids; Myristic acid in an amount of about 3.18% to about 4.30% of the total fatty acids; Pentadecanoic acid in an amount of about 0.14% to about 0.20% of the total fatty acids; Palmitic acid in an amount of about 18.17% to about 24.59% of the total fatty acids; Margaric acid in an amount of about 0.20% to about 0.28% of the total fatty acids; Stearic acid in an amount of about 7.92% to about 10.72% of the total fatty acids; Arachidic acid in an amount of about 0.67% to about 0.91% of the total fatty acids; Behenic acid in an amount of about 0.35% to about 0.47% of the total fatty acids; Lignoceric acid in an amount of about 0.34% to about 0.46% of the total fatty acids; Myristoleic acid in an amount of about 0.09% to about 0.13% of the total fatty acids; Palmitoleic acid in an amount of about 1.42% to about 1.92% of the total fatty acids; Oleic acid in an amount of about 38.27% to about 51.78% of the total fatty acids; Gadoleic acid in an amount of about 0.32% to about 0.44% of the total fatty acids; Linoleic acid in an amount of about 5.58% to about 7.54% of the total fatty acids; Linolenic acid in an amount of about 1.11% to about 1.50% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; Docosahexaenoic acid in an amount of about 0.31% to about 0.43% of the total fatty acids; and wherein the composition comprises essentially no Erucic acid and essentially no Nervonic acid.

Aspect 62. The composition of Aspect 53, comprising: Butyric acid in an amount of about 0.36% of the total fatty acids; Caproic acid in an amount of about 0.33% of the total fatty acids; Caprylic acid in an amount of about 1.27% of the total fatty acids; Capric acid in an amount of about 1.14% of the total fatty acids; Lauric acid in an amount of about 6.67% of the total fatty acids; Myristic acid in an amount of about 3.74% of the total fatty acids; Pentadecanoic acid in an amount of about 0.17% of the total fatty acids; Palmitic acid in an amount of about 21.38% of the total fatty acids; Margaric acid in an amount of about 0.24% of the total fatty acids; Stearic acid in an amount of about 9.32% of the total fatty acids; Arachidic acid in an amount of about 0.79% of the total fatty acids; Behenic acid in an amount of about 0.41% of the total fatty acids; Lignoceric acid in an amount of about 0.40% of the total fatty acids; Myristoleic acid in an amount of about 0.11% of the total fatty acids; Palmitoleic acid in an amount of about 1.67% of the total fatty acids; Oleic acid in an amount of about 45.02% of the total fatty acids; Gadoleic acid in an amount of about 0.38% of the total fatty acids; Linoleic acid in an amount of about 6.56% of the total fatty acids; Linolenic acid in an amount of about 1.30% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; Docosahexaenoic acid in an amount of about 0.37% of the total fatty acids; and wherein the composition comprises essentially no Erucic acid and essentially no Nervonic acid.

Aspect 63. The composition of any one of Aspects 53 to 62, wherein the ratio of Arachidonic acid to Docosahexaenoic acid is about 1.7:1.

Aspect 64. The composition of any one of Aspects 53 to 62, wherein the ratio of Eicosapentaenoic acid to Docosahexaenoic acid is about 0.22:1.

Aspect 65. The composition of any one of Aspects 53 to 62, wherein the ratio of Linoleic acid to alpha-Linolenic acid is about 5.05:1.

Aspect 66. The composition of any one of Aspects 53 to 62, wherein the polyunsaturated fatty acids comprise n-6 fatty acids, n-3 fatty acids, and combinations thereof.

Aspect 67. The composition of Aspects 66, wherein the ratio of n-6 fatty acids to n-3 fatty acids is about 4.02:1.

Aspect 68. The composition of any one of Aspect 1 to claim 67, wherein the fatty acids are derived from recombinant sources.

Aspect 69. The composition of Aspect 68, wherein the fatty acids are derived from only recombinant sources.

Aspect 70. The composition of Aspect 68, wherein the fatty acids are derived from recombinant sources in combination with whole milk powder.

Aspect 71. The composition of Aspect 68, wherein the fatty acids are derived from whole milk and plant oils.

Aspect 72. The composition of Aspect 71, wherein the plant oils are selected from the group comprising coconut oil, canola oil, sunflower oil, algal oil, and combinations thereof.

Aspect 73. The composition of Aspect 71, wherein the plant oils are selected from the group comprising coconut oil, algal oil, and combinations thereof.

Aspect 74. The composition of Aspect 68, wherein the fatty acids are derived from whole milk, plant oils, and recombinant oils.

Aspect 75. The composition of any one of Aspects 70 to 74, wherein the whole milk powder is in an amount of about 11% to about 21% of the composition.

Aspect 76. The composition of any one of Aspects 70 to 74, wherein the whole milk powder is in an amount of about 11.7% of the composition.

Aspect 77. The composition of any one of Aspects 70 to 74, wherein the whole milk powder is in an amount of about 21% of the composition.

Aspect 78. The composition of any one of Aspects 70 to 77, wherein the whole milk powder comprises less than about 50% milkfat.

Aspect 79. The composition of any one of Aspects 70 to 78, wherein the whole milk powder comprises about 26% to about 42% milkfat.

Aspect 80. The composition of Aspect 78, wherein the whole milk powder comprises substantially no milkfat.

Aspect 81. The composition of Aspect 78, wherein the whole milk powder comprises nonfat whole milk.

Aspect 82. The composition of any one of Aspect 1 to claim 67, wherein the fatty acids are derived from fatty fish, algae, fungi, dairy products, cooking oils, plant source, or combinations thereof.

Aspect 83. The composition of Aspect 82, wherein the fatty fish are salmon, mackerel, sardines, trout, herring, tuna, or combinations thereof.

Aspect 84. The composition of Aspect 82, wherein the dairy products are butter, cheese, cream, whole milk, or combinations thereof.

Aspect 85. The composition of Aspect 82, wherein the cooking oils are palm oil, coconut oil, vegetable oil, or combinations thereof.

Aspect 86. The composition of Aspect 82, wherein the plant source is a nut, a seed, an avocado, a plant oil, a soybean product, a whole grain, or combinations thereof.

Aspect 87. The composition of Aspect 86, wherein the nut or seed is an almond, a walnut, flaxseed, chia seed, hemp seed, pumpkin seed, or combinations thereof.

Aspect 88. The composition of Aspect 86, wherein the plant oil is olive oil, canola oil, flaxseed oil, walnut oil, sesame oil, or combinations thereof.

Aspect 89. The composition of Aspect 86, wherein the soybean product is tofu, tempeh, edamame, or combinations thereof.

Aspect 90. The composition of Aspect 86, wherein the whole grain is oats, quinoa, brown rice, or combinations thereof.

Aspect 91. A composition according to any one of Aspects 1 to 90, prepared by combining the fatty acids.

Aspect 92. An infant formula comprising the composition of any one of Aspects 1 to 90.

Aspect 93. The infant formula of Aspect 92, wherein the infant formula mimics human breast milk.

Aspect 94. An oil comprising fatty acids, wherein the oil comprises saturated fatty acids, unsaturated fatty acids, and combinations thereof.

Aspect 95. The oil of Aspect 94, wherein the saturated fatty acids are selected from the group consisting of short/medium chain fatty acids, intermediate chain fatty acids, long chain fatty acids, and combinations thereof.

Aspect 96. The oil of Aspect 95, wherein the short/medium chain fatty acids comprise less than twelve carbons.

Aspect 97. The oil of Aspect 95, wherein the short/medium chain fatty acids are selected from the group consisting of Butyric acid (C4:0), Caproic acid (C6:0), Caprylic acid (C8:0), Capric acid (C10:0), and combinations thereof.

Aspect 98. The oil of Aspect 97, wherein the Butyric acid (C4:0) is in an amount of less than about 0.39% of the total fatty acids.

Aspect 99. The oil of Aspect 97, wherein the Caproic acid (C6:0) is in an amount of about 0.05% to about 0.39% of the total fatty acids.

Aspect 100. The oil of Aspect 97, wherein the Caprylic acid (C8:0) is in an amount of about 0.11% to about 1.68% of the total fatty acids.

Aspect 101. The oil of Aspect 97, wherein the Capric acid (C10:0) is in an amount of about 0.28% to about 2.00% of the total fatty acids.

Aspect 102. The oil of Aspect 95, wherein the intermediate chain fatty acids comprise twelve to fourteen carbons.

Aspect 103. The oil of Aspect 102, wherein the intermediate chain fatty acids are selected from the group consisting of Myristic acid (C14:0), Lauric acid (C12:0), and combinations thereof.

Aspect 104. The oil of Aspect 103, wherein the Lauric acid (C12:0) is in an amount of about 4.40% to about 10.0% of the total fatty acids.

Aspect 105. The oil of Aspect 103, wherein the Myristic acid (C14:0) is in an amount of about 3.10% to about 10.0% of the total fatty acids.

Aspect 106. The oil of Aspect 95, wherein the long chain fatty acids comprise greater than fourteen carbons.

Aspect 107. The oil of Aspect 106, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

Aspect 108. The oil of Aspect 107, wherein the Pentadecanoic acid (C15:0) is in an amount of about 0.16% to about 0.39% of the total fatty acids.

Aspect 109. The oil of Aspect 107, wherein the Palmitic acid (C16:0) is in an amount of about 18.67% to about 23.83% of the total fatty acids.

Aspect 110. The oil of Aspect 107, wherein the Margaric acid (C17:0) is in an amount of about 0.09% to about 0.41% of the total fatty acids.

Aspect 111. The oil of Aspect 107, wherein the Stearic acid (C18:0) is in an amount of about 3.61% to about 10.14% of the total fatty acids.

Aspect 112. The oil of Aspect 107, wherein the Arachidic acid (C20:0) is in an amount of about 0.19% to about 1.30% of the total fatty acids.

Aspect 113. The oil of Aspect 107, wherein the Behenic acid (C22:0) is in an amount of about 0.05% to about 0.57% of the total fatty acids.

Aspect 114. The oil of Aspect 107, wherein the Lignoceric acid (C24:0) is in an amount of about 0.02% to about 0.47% of the total fatty acids.

Aspect 115. The oil of Aspect 94, wherein the unsaturated fatty acids are selected from the group consisting of monounsaturated fatty acids, polyunsaturated fatty acids, and combinations thereof.

Aspect 116. The oil of Aspect 115, wherein the fatty acids are monounsaturated fatty acids are selected from the group consisting of Myristoleic acid (C14:1), Palmitoleic acid (C16:1), Oleic acid (C18:1n9), Gadoleic acid (C20:1), and combinations thereof.

Aspect 117. The oil of Aspect 116, wherein the Myristoleic acid (C14:1) is in an amount of about 0.11% to about 0.50% of the total fatty acids.

Aspect 118. The oil of Aspect 116, wherein the Palmitoleic acid (C16:1) is in an amount of about 0.25% to about 2.70% of the total fatty acids.

Aspect 119. The oil of Aspect 116, wherein the Oleic acid (C18:1n9) is in an amount of about 26.20% to about 51.00% of the total fatty acids.

Aspect 120. The oil of Aspect 116, wherein the Gadoleic acid (C20:1) is in an amount of about 0.08% to about 0.60% of the total fatty acids.

Aspect 121. The oil of Aspect 116, wherein the oil comprises less than about 0.10% Erucic acid (C22:1).

Aspect 122. The oil of Aspect 116, wherein the oil comprises less than about 0.22% Nervonic acid (C24:1).

Aspect 123. The oil of Aspect 115, wherein the fatty acids are polyunsaturated fatty acids are selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

Aspect 124. The oil of Aspect 123, wherein the Linoleic acid (C18:2n6) is in an amount of about 5.85% to about 9.00% of the total fatty acids.

Aspect 125. The oil of Aspect 123, wherein the Linolenic acid (C18:3n3) is in an amount of about 0.89% to about 2.07% of the total fatty acids.

Aspect 126. The oil of Aspect 123, wherein Arachidonic acid (C20:4n6) is in an amount of about 0.60% to about 0.66% of the total fatty acids.

Aspect 127. The oil of Aspect 123, wherein the Eicosapentaenoic acid (C20:5n3) is in an amount of about 0.06% to about 0.26% of the total fatty acids.

Aspect 128. The oil of Aspect 123, wherein the Docosapentaenoic acid (C22:5n3) is in an amount of about 0.04% to about 0.29% of the total fatty acids.

Aspect 129. The oil of Aspect 123, wherein the Docosahexaenoic acid (C22:6n3) is in an amount of about 0.35% to about 0.39% of the total fatty acids.

Aspect 130. The oil of Aspect 94, comprising Palmitic acid (C16:0), Linoleic acid (C18:2n6), Arachidonic acid (C20:4n6), Docosahexaenoic acid (C22:6n3), or combinations thereof.

Aspect 131. The oil of Aspect 94, comprising Palmitic acid (C16:0), Linoleic acid (C18:2n6), Arachidonic acid (C20:4n6), and Docosahexaenoic acid (C22:6n3).

Aspect 132. The oil of Aspect 130 or claim 131, wherein the oil comprises essentially no Erucic acid (C22:1).

Aspect 133. The oil of Aspect 132, wherein the oil is free of Erucic acid (C22:1).

Aspect 134. The oil of Aspect 94, comprising Butyric acid (C4:0), Caproic acid (C6:0), Caprylic acid (C8:0), Capric acid (C10:0), Lauric acid (C12:0), Myristic acid (C14:0), Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), Myristoleic acid (C14:1), Palmitoleic acid (C16:1), Oleic acid (C181n9), Gadoleic acid (C20:1), Nervonic acid (C24:1), Linoleic acid (C18:2n6), Linolenic acid (C18:3n3), Arachidonic acid (C20:4n6), Eicosapentaenoic acid (C20:5n3), Docosapentaenoic acid (C22:5n3), and Docosahexaenoic acid (C22:6n3); and wherein the oil optionally further comprises Erucic acid (C22:1), Nervonic acid (C24:1), and combinations thereof.

Aspect 135. The oil of Aspect 134, comprising: Butyric acid in an amount of about 0% to about 0.39% of the total fatty acids; Caproic acid in an amount of about 0.05% to about 0.39% of the total fatty acids; Caprylic acid in an amount of about 0.11% to about 1.68% of the total fatty acids; Capric acid in an amount of about 0.28% to about 2.00% of the total fatty acids; Lauric acid in an amount of about 4.40% to about 10.0% of the total fatty acids; Myristic acid in an amount of about 3.10% to about 10.0% of the total fatty acids; Pentadecanoic acid in an amount of about 0.16% to about 0.39% of the total fatty acids; Palmitic acid in an amount of about 18.67% to about 23.83% of the total fatty acids; Margaric acid in an amount of about 0.09% to about 0.41% of the total fatty acids; Stearic acid in an amount of about 3.61% to about 10.14% of the total fatty acids; Arachidic acid in an amount of about 0.19% to about 1.30% of the total fatty acids; Behenic acid in an amount of about 0.05% to about 0.57% of the total fatty acids; Lignoceric acid in an amount of about 0.02% to about 0.47% of the total fatty acids; Myristoleic acid in an amount of about 0.11% to about 0.50% of the total fatty acids; Palmitoleic acid in an amount of about 0.25% to about 2.70% of the total fatty acids; Oleic acid in an amount of about 26.20% to about 51.00% of the total fatty acids; Gadoleic acid in an amount of about 0.08% to about 0.60% of the total fatty acids; Erucic acid in an amount of less than about 0.10% of the total fatty acids; Nervonic acid in an amount of less than about 0.22% of the total fatty acids; Linoleic acid in an amount of about 5.85% to about 9.00% of the total fatty acids; Linolenic acid in an amount of about 0.89% to about 2.07% of the total fatty acids; Arachidonic acid in an amount of about 0.60% to about 0.66% of the total fatty acids; Eicosapentaenoic acid in an amount of about 0.06% to about 0.26% of the total fatty acids; Docosapentaenoic acid in an amount of about 0.04% to about 0.29% of the total fatty acids; and Docosahexaenoic acid in an amount of about 0.35% to about 0.39% of the total fatty acids.

Aspect 136. The oil of Aspect 134, comprising: Butyric acid in an amount of about 0.35% of the total fatty acids; Caproic acid in an amount of about 0.14% of the total fatty acids; Caprylic acid in an amount of about 0.21% of the total fatty acids; Capric acid in an amount of about 1.57% of the total fatty acids; Lauric acid in an amount of about 5.90% of the total fatty acids; Myristic acid in an amount of about 6.61% of the total fatty acids; Pentadecanoic acid in an amount of about 0.28% of the total fatty acids; Palmitic acid in an amount of about 21.47% of the total fatty acids; Margaric acid in an amount of about 0.32% of the total fatty acids; Stearic acid in an amount of about 6.40% of the total fatty acids; Arachidic acid in an amount of about 0.22% of the total fatty acids; Behenic acid in an amount of about 0.11% of the total fatty acids; Lignoceric acid in an amount of about 0.08% of the total fatty acids; Myristoleic acid in an amount of about 0.22% of the total fatty acids; Palmitoleic acid in an amount of about 2.36% of the total fatty acids; Oleic acid in an amount of about 42.38% of the total fatty acids; Gadoleic acid in an amount of about 0.45% of the total fatty acids; Erucic acid in an amount of about 0% of the total fatty acids; Nervonic acid in an amount of about 0.09% of the total fatty acids; Linoleic acid in an amount of about 6.20% of the total fatty acids; Linolenic acid in an amount of about 1.02% of the total fatty acids; Arachidonic acid in an amount of about 0.63% of the total fatty acids; Eicosapentaenoic acid in an amount of about 0.11% of the total fatty acids; Docosapentaenoic acid in an amount of about 0.17% of the total fatty acids; and Docosahexaenoic acid in an amount of about 0.37% of the total fatty acids.

Aspect 137. The oil of any one of Aspects 94 to 136, wherein the ratio of Arachidonic acid to Docosahexaenoic acid is about 4:1 to about 9:1.

Aspect 138. The oil of Aspect 137, wherein the ratio of Arachidonic acid to Docosahexaenoic acid is about 1.7:1.

Aspect 139. The oil of any one of Aspects 94 to 136, wherein the ratio of Eicosapentaenoic acid to Docosahexaenoic acid is about 0.2:1 to about 0.8:1.

Aspect 140. The oil of any one of Aspects 94 to 136, wherein the ratio of Eicosapentaenoic acid to Docosahexaenoic acid is about 0.3:1.

Aspect 141. The oil of any one of Aspects 94 to 136, wherein the ratio of Linoleic acid to alpha-Linolenic acid is about 4:1 to about 9:1.

Aspect 142. The oil of any one of Aspects 94 to 136, wherein the ratio of Linoleic acid to alpha-Linolenic acid is about 6.1:1.

Aspect 143. The oil of Aspect 115, wherein the polyunsaturated fatty acids comprise n-6 fatty acids, n-3 fatty acids, and combinations thereof.

Aspect 144. The composition of Aspect 143, wherein the ratio of n-6 fatty acids to n-3 fatty acids is about 3.49:1 to about 4.71:1.

Aspect 145. The oil of Aspects 143, wherein the ratio of n-6 fatty acids to n-3 fatty acids is about 4.1:1.

Aspect 146. An oil comprising fatty acids, wherein the oil comprises saturated fatty acids, unsaturated fatty acids, and combinations thereof; and wherein the saturated fatty acids are selected from the group consisting of short/medium chain fatty acids comprising less than twelve carbons, intermediate chain fatty acids comprising twelve to fourteen carbons, long chain fatty acids comprising greater than fourteen carbons, and combinations thereof; and wherein the unsaturated fatty acids are selected from the group consisting of monounsaturated fatty acids, polyunsaturated fatty acids, and combinations thereof.

Aspect 147. The oil of Aspect 146, comprising: Butyric acid in an amount of about 0.31% to about 0.42% of the total fatty acids; Caproic acid in an amount of about 0.31% to about 0.43% of the total fatty acids; Caprylic acid in an amount of about 1.44% to about 1.94% of the total fatty acids; Capric acid in an amount of about 1.23% to about 1.67% of the total fatty acids; Lauric acid in an amount of about 7.65% to about 10.35% of the total fatty acids; Myristic acid in an amount of about 3.94% to about 5.32% of the total fatty acids; Pentadecanoic acid in an amount of about 0.14% to about 0.20% of the total fatty acids; Palmitic acid in an amount of about 7.29% to about 9.87% of the total fatty acids; Margaric acid in an amount of about 0.08% to about 0.10% of the total fatty acids; Stearic acid in an amount of about 3.33% to about 4.51% of the total fatty acids; Arachidic acid in an amount of about 0.26% to about 0.36% of the total fatty acids; Behenic acid in an amount of about 0.48% to about 0.66% of the total fatty acids; Lignoceric acid in an amount of about 0.18% to about 0.24% of the total fatty acids; Myristoleic acid in an amount of about 0.09% to about 0.12% of the total fatty acids; Palmitoleic acid in an amount of about 0.20% to about 0.28% of the total fatty acids; Oleic acid in an amount of about 46.58% to about 63.02% of the total fatty acids; Gadoleic acid in an amount of about 0.31% to about 0.43% of the total fatty acids; Erucic acid in an amount of less than about 0.01% of the total fatty acids; Nervonic acid in an amount of less than about 0.03% of the total fatty acids; Linoleic acid in an amount of about 7.60% to about 10.27% of the total fatty acids; Linolenic acid in an amount of about 1.59% to about 2.15% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; and Docosahexaenoic acid in an amount of about 0.31% to about 0.43% of the total fatty acids.

Aspect 148. The oil of Aspect 146, comprising: Butyric acid in an amount of about 0.36% of the total fatty acids; Caproic acid in an amount of about 0.37% of the total fatty acids; Caprylic acid in an amount of about 1.69% of the total fatty acids; Capric acid in an amount of about 1.45% of the total fatty acids; Lauric acid in an amount of about 9.00% of the total fatty acids; Myristic acid in an amount of about 4.63% of the total fatty acids; Pentadecanoic acid in an amount of about 0.17% of the total fatty acids; Palmitic acid in an amount of about 8.58% of the total fatty acids; Margaric acid in an amount of about 0.09% of the total fatty acids; Stearic acid in an amount of about 3.92% of the total fatty acids; Arachidic acid in an amount of about 0.31% of the total fatty acids; Behenic acid in an amount of about 0.57% of the total fatty acids; Lignoceric acid in an amount of about 0.21% of the total fatty acids; Myristoleic acid in an amount of about 0.10% of the total fatty acids; Palmitoleic acid in an amount of about 0.24% of the total fatty acids; Oleic acid in an amount of about 54.80% of the total fatty acids; Gadoleic acid in an amount of about 0.37% of the total fatty acids; Erucic acid in an amount of about 0.01% of the total fatty acids; Nervonic acid in an amount of about 0.04% of the total fatty acids; Linoleic acid in an amount of about 8.93% of the total fatty acids; Linolenic acid in an amount of about 1.87% of the total fatty acids; Arachidonic acid in an amount of about 0.63% of the total fatty acids; Eicosapentaenoic acid in an amount of about 0.08 of the total fatty acids; Docosapentaenoic acid in an amount of about 0.04% of the total fatty acids; and Docosahexaenoic acid in an amount of about 0.37% of the total fatty acids.

Aspect 149. The oil of any one of Aspects 146 to 148, wherein the ratio of Arachidonic acid to Docosahexaenoic acid is about 1.7:1.

Aspect 150. The oil of any one of Aspects 146 to 148, wherein the ratio of Eicosapentaenoic acid to Docosahexaenoic acid is about 0.22:1.

Aspect 151. The oil of any one of Aspects 146 to 148, wherein the ratio of Linoleic acid to alpha-Linolenic acid is about 4.78:1.

Aspect 152. The oil of any one of Aspects 146 to 148, wherein the polyunsaturated fatty acids comprise n-6 fatty acids, n-3 fatty acids, and combinations thereof.

Aspect 153. The oil of Aspects 152, wherein the ratio of n-6 fatty acids to n-3 fatty acids is about 4.05:1.

Aspect 154. The oil of Aspect 146, comprising: Butyric acid in an amount of about 0.31% to about 0.42% of the total fatty acids; Caproic acid in an amount of about 0.28% to about 0.38% of the total fatty acids; Caprylic acid in an amount of about 1.08% to about 1.46% of the total fatty acids; Capric acid in an amount of about 0.97% to about 1.31% of the total fatty acids; Lauric acid in an amount of about 5.67% to about 7.67% of the total fatty acids; Myristic acid in an amount of about 3.18% to about 4.30% of the total fatty acids; Pentadecanoic acid in an amount of about 0.14% to about 0.20% of the total fatty acids; Palmitic acid in an amount of about 18.17% to about 24.59% of the total fatty acids; Margaric acid in an amount of about 0.20% to about 0.28% of the total fatty acids; Stearic acid in an amount of about 7.92% to about 10.72% of the total fatty acids; Arachidic acid in an amount of about 0.67% to about 0.91% of the total fatty acids; Behenic acid in an amount of about 0.35% to about 0.47% of the total fatty acids; Lignoceric acid in an amount of about 0.34% to about 0.46% of the total fatty acids; Myristoleic acid in an amount of about 0.09% to about 0.13% of the total fatty acids; Palmitoleic acid in an amount of about 1.42% to about 1.92% of the total fatty acids; Oleic acid in an amount of about 38.27% to about 51.78% of the total fatty acids; Gadoleic acid in an amount of about 0.32% to about 0.44% of the total fatty acids; Linoleic acid in an amount of about 5.58% to about 7.54% of the total fatty acids; Linolenic acid in an amount of about 1.11% to about 1.50% of the total fatty acids; Arachidonic acid in an amount of about 0.54% to about 0.73% of the total fatty acids; Eicosapentaenoic acid in an amount of about 0.07% to about 0.09% of the total fatty acids; Docosapentaenoic acid in an amount of about 0.03% to about 0.05% of the total fatty acids; Docosahexaenoic acid in an amount of about 0.31% to about 0.43% of the total fatty acids; and wherein the oil comprises essentially no Erucic acid and essentially no Nervonic acid.

Aspect 155. The oil of Aspect 146, comprising: Butyric acid in an amount of about 0.36% of the total fatty acids; Caproic acid in an amount of about 0.33% of the total fatty acids; Caprylic acid in an amount of about 1.27% of the total fatty acids; Capric acid in an amount of about 1.14% of the total fatty acids; Lauric acid in an amount of about 6.67% of the total fatty acids; Myristic acid in an amount of about 3.74% of the total fatty acids; Pentadecanoic acid in an amount of about 0.17% of the total fatty acids; Palmitic acid in an amount of about 21.38% of the total fatty acids; Margaric acid in an amount of about 0.24% of the total fatty acids; Stearic acid in an amount of about 9.32% of the total fatty acids; Arachidic acid in an amount of about 0.79% of the total fatty acids; Behenic acid in an amount of about 0.41% of the total fatty acids; Lignoceric acid in an amount of about 0.40% of the total fatty acids; Myristoleic acid in an amount of about 0.11% of the total fatty acids; Palmitoleic acid in an amount of about 1.67% of the total fatty acids; Oleic acid in an amount of about 45.02% of the total fatty acids; Gadoleic acid in an amount of about 0.38% of the total fatty acids; Linoleic acid in an amount of about 6.56% of the total fatty acids; Linolenic acid in an amount of about 1.30% of the total fatty acids; Arachidonic acid in an amount of about 0.63% of the total fatty acids; Eicosapentaenoic acid in an amount of about 0.08% of the total fatty acids; Docosapentaenoic acid in an amount of about 0.04% of the total fatty acids; Docosahexaenoic acid in an amount of about 0.37% of the total fatty acids; and wherein the oil comprises essentially no Erucic acid and essentially no Nervonic acid.

Aspect 156. The oil of Aspect 146, wherein the ratio of Arachidonic acid to Docosahexaenoic acid is about 1.7:1.

Aspect 157. The oil of Aspect 146, wherein the ratio of Eicosapentaenoic acid to Docosahexaenoic acid is about 0.22:1.

Aspect 158. The oil of Aspect 146, wherein the ratio of Linoleic acid to alpha-Linolenic acid is about 5.05:1.

Aspect 159. The oil of Aspect 146, wherein the polyunsaturated fatty acids comprise n-6 fatty acids, n-3 fatty acids, and combinations thereof.

Aspect 160. The oil of Aspects 159, wherein the ratio of n-6 fatty acids to n-3 fatty acids is about 4.02:1.

Aspect 161. The oil of any one of Aspect 94 to claim 160, wherein the fatty acids are derived from recombinant sources.

Aspect 162. The oil of Aspect 161, wherein the fatty acids are derived from only recombinant sources.

Aspect 163. The oil of Aspect 161, wherein the fatty acids are derived from recombinant sources in combination with whole milk powder.

Aspect 164. The oil of Aspect 161, wherein the fatty acids are derived from whole milk and plant oils.

Aspect 165. The oil of Aspect 164, wherein the plant oils are selected from the group comprising coconut oil, canola oil, sunflower oil, algal oil, and combinations thereof.

Aspect 166. The oil of Aspect 164, wherein the plant oils are selected from the group comprising coconut oil, algal oil, and combinations thereof.

Aspect 167. The oil of Aspect 161, wherein the fatty acids are derived from whole milk, plant oils, and recombinant oils.

Aspect 168. The oil of any one of Aspects 163 to 167, wherein the whole milk powder is in an amount of about 11% to about 21% of the oil.

Aspect 169. The oil of any one of Aspects 163 to 167, wherein the whole milk powder is in an amount of about 11.7% of the oil.

Aspect 170. The oil of any one of Aspects 163 to 167, wherein the whole milk powder is in an amount of about 21% of the oil.

Aspect 171. The oil of any one of Aspects 163 to 170, wherein the whole milk powder comprises less than about 50% milkfat.

Aspect 172. The oil of any one of Aspects 163 to 171, wherein the whole milk powder comprises about 26% to about 42% milkfat.

Aspect 173. The oil of Aspect 172, wherein the whole milk powder comprises substantially no milkfat.

Aspect 174. The oil of Aspect 172, wherein the whole milk powder comprises nonfat whole milk.

Aspect 175. The oil of any one of Aspect 94 to claim 160, wherein the fatty acids are derived from fatty fish, algae, fungi, dairy products, cooking oils, plant source, or combinations thereof.

Aspect 176. The oil of Aspect 175, wherein the fatty fish are salmon, mackerel, sardines, trout, herring, tuna, or combinations thereof.

Aspect 177. The oil of Aspect 175, wherein the dairy products are butter, cheese, cream, whole milk, or combinations thereof.

Aspect 178. The oil of Aspect 175, wherein the cooking oils are palm oil, coconut oil, vegetable oil, or combinations thereof.

Aspect 179. The oil of Aspect 175, wherein the plant source is a nut, a seed, an avocado, a plant oil, a soybean product, a whole grain, or combinations thereof.

Aspect 180. The oil of Aspect 179, wherein the nut or seed is an almond, a walnut, flaxseed, chia seed, hemp seed, pumpkin seed, or combinations thereof.

Aspect 181. The oil of Aspect 179, wherein the plant oil is olive oil, canola oil, flaxseed oil, walnut oil, sesame oil, or combinations thereof.

Aspect 182. The oil of Aspect 179, wherein the soybean product is tofu, tempeh, edamame, or combinations thereof.

Aspect 183. The oil of Aspect 179, wherein the whole grain is oats, quinoa, brown rice, or combinations thereof.

Aspect 184. An oil according to any one of Aspects 94 to 183, prepared by combining the fatty acids.

Aspect 185. An infant formula comprising the oil of any one of Aspects 94 to 183.

Aspect 186. The infant formula of Aspect 185, wherein the infant formula mimics human breast milk.

Clause 1. An optimized breast milk composition comprising fatty acids, wherein the optimized breast milk composition comprises saturated fatty acids, unsaturated fatty acids, and combinations thereof; wherein the saturated fatty acids are selected from the group consisting of short/medium chain fatty acids, intermediate chain fatty acids, long chain fatty acids, and combinations thereof.

Clause 2. The optimized breast milk composition of clause 1, wherein the long chain fatty acids comprise greater than fourteen carbons.

Clause 3. The optimized breast milk composition of clause 2, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

Clause 4. The optimized breast milk composition of clause 3, wherein the Palmitic acid (C16:0) is in an amount of about 18.67% to about 23.83% of the fatty acids.

Clause 5. The optimized breast milk composition of any one of clauses 1 to 4, wherein the fatty acids are polyunsaturated fatty acids are selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

Clause 6. The optimized breast milk composition of clause 5, wherein the Linoleic acid (C18:2n6) is in an amount of about 5.85% to about 9.00% of the fatty acids.

Clause 7. The optimized breast milk composition of clause 5, wherein Arachidonic acid (C20:4n6) is in an amount of about 0.60% to about 0.66% of the fatty acids.

Clause 8. The optimized breast milk composition of clause 5, wherein the Docosahexaenoic acid (C22:6n3) is in an amount of about 0.35% to about 0.39% of the fatty acids.

Clause 9. The optimized breast milk composition of any one of clauses 1 to 8, wherein the composition comprises essentially no Erucic acid (C22:1).

Clause 10. The optimized breast milk composition of any one of clauses 1 to 9, wherein a ratio of Arachidonic acid to Docosahexaenoic acid is about 1.4:1 to about 2:1.

Clause 11. The optimized breast milk composition of any one of clauses 1 to 9, wherein a ratio of Eicosapentaenoic acid to Docosahexaenoic acid is about 0.2:1 to about 0.8:1.

Clause 12. The optimized breast milk composition of any one of clauses 1 to 9, wherein a ratio of Linoleic acid to alpha-Linolenic acid is about 4:1 to about 15:1.

Clause 13. The optimized breast milk composition of any one of clauses 1 to 12, wherein the polyunsaturated fatty acids comprise n-6 fatty acids, n-3 fatty acids, and combinations thereof.

Clause 14. The optimized breast milk composition of any one of clauses 1 to 12, wherein the fatty acids are derived from whole milk, plant oils, and recombinant oils.

Clause 15. The optimized breast milk composition of any one of clauses 1 to 12, wherein the fatty acids are derived from recombinant sources in combination with whole milk powder.

Clause 16. The optimized breast milk composition of any one of clauses 14 to 15, wherein the whole milk is a whole milk powder.

Clause 17. The optimized breast milk composition of clause 16, wherein the whole milk powder comprises less than about 50% milkfat.

Clause 18. The optimized breast milk composition of clause 16, wherein the whole milk powder comprises nonfat whole milk.

Clause 19. The optimized breast milk composition of clause 14, wherein the plant oils are selected from the group comprising coconut oil, olive oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, palm kernel oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

Clause 20. The optimized breast milk composition of clause 14, wherein the plant oil is coconut oil, olive oil, avocado oil, or combinations thereof.

Clause 21. The optimized breast milk composition of clause 14, wherein the plant oils are selected from the group comprising coconut oil, canola oil, sunflower oil, algal oil, and combinations thereof.

Clause 22. The optimized breast milk composition of clause 14, wherein the plant oils are selected from the group comprising coconut oil, algal oil, and combinations thereof.

Clause 23. The optimized breast milk composition of clause 14, wherein the plant oil is olive oil, canola oil, flaxseed oil, walnut oil, sesame oil, or combinations thereof.

Clause 24. The optimized breast milk composition of clause 14, wherein the plant oil is derived from a nut, a seed, an avocado, a plant oil, a soybean product, a whole grain, or combinations thereof.

Clause 25. The optimized breast milk composition of clause 24, wherein the nut or seed is an almond, a walnut, flaxseed, chia seed, hemp seed, pumpkin seed, or combinations thereof.

Clause 26. The optimized breast milk composition of clause 24, wherein the soybean product is tofu, tempeh, edamame, or combinations thereof.

Clause 27. The optimized breast milk composition of clause 24, wherein the whole grain is oats, quinoa, brown rice, or combinations thereof.

Clause 28. The optimized breast milk composition of any one of clauses 1 to 27, wherein the fatty acids are derived from recombinant sources.

Clause 29. The optimized breast milk composition of clause 28, wherein the fatty acids are derived from only recombinant sources.

Clause 30. The optimized breast milk composition of any one of clauses 1 to 14, wherein the fatty acids are derived from fatty fish, algae, fungi, dairy products, cooking oils, plant source, or combinations thereof.

Clause 31. The optimized breast milk composition of clause 30, wherein the fatty fish are salmon, mackerel, sardines, trout, herring, tuna, or combinations thereof.

Clause 32. The optimized breast milk composition of clause 30, wherein the dairy products are butter, cheese, cream, whole milk, or combinations thereof.

Clause 33. The optimized breast milk composition of clause 30, wherein the cooking oils are palm oil, coconut oil, vegetable oil, or combinations thereof.

Clause 34. The optimized breast milk composition of any one of clauses 1 to 33, wherein the composition does not comprise palm oil.

Clause 35. An optimized breast milk composition according to any one of clauses 1 to 34, prepared by combining the fatty acids.

Clause 36. An infant formula comprising the optimized breast milk composition of any one of clauses 1 to 34.

Clause 37. The infant formula of clause 36, wherein the infant formula mimics a human breast milk.

Clause 38. An optimized breast milk oil comprising fatty acids, wherein the oil comprises saturated fatty acids, unsaturated fatty acids, and combinations thereof; wherein the saturated fatty acids are selected from the group consisting of short/medium chain fatty acids, intermediate chain fatty acids, long chain fatty acids, and combinations thereof.

Clause 39. The optimized breast milk oil of clause 38, wherein the long chain fatty acids comprise greater than fourteen carbons.

Clause 40. The optimized breast milk oil of clause 39, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

Clause 41. The optimized breast milk oil of any one of clauses 38 to 40, wherein the fatty acids are polyunsaturated fatty acids are selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

Clause 42. The optimized breast milk oil of clause 41, wherein the Linoleic acid (C18:2n6) is in an amount of about 5.85% to about 9.00% of the fatty acids.

Clause 43. The optimized breast milk oil of clause 41, wherein Arachidonic acid (C20:4n6) is in an amount of about 0.60% to about 0.66% of the fatty acids.

Clause 44. The optimized breast milk oil of clause 41, wherein the Docosahexaenoic acid (C22:6n3) is in an amount of about 0.35% to about 0.39% of the fatty acids.

Clause 45. The optimized breast milk oil of any one of clauses 38 to 44, wherein the oil comprises essentially no Erucic acid (C22:1).

Clause 46. The optimized breast milk oil of any one of clauses 38 to 45, wherein a ratio of Arachidonic acid to Docosahexaenoic acid is about 4:1 to about 15:1.

Clause 47. The optimized breast milk oil of any one of clauses 38 to 45, wherein a ratio of Eicosapentaenoic acid to Docosahexaenoic acid is about 0.2:1 to about 0.8:1.

Clause 48. The optimized breast milk oil of any one of clauses 38 to 45, wherein a ratio of Linoleic acid to alpha-Linolenic acid is about 4:1 to about 15:1.

Clause 49. The optimized breast milk oil of any one of clauses 38 to 45, wherein the polyunsaturated fatty acids comprise n-6 fatty acids, n-3 fatty acids, and combinations thereof.

Clause 50. The optimized breast milk oil of any one of clauses 38 to 49, wherein the fatty acids are derived from whole milk, plant oils, and recombinant oils.

Clause 51. The optimized breast milk oil of any one of clauses 38 to 49, wherein the fatty acids are derived from recombinant sources in combination with whole milk powder.

Clause 52. The optimized breast milk oil of any one of clauses 50 to 51, wherein the whole milk is a whole milk powder.

Clause 53. The optimized breast milk oil of clause 52, wherein the whole milk powder comprises less than about 50% milkfat.

Clause 54. The optimized breast milk oil of clause 52, wherein the whole milk powder comprises nonfat whole milk.

Clause 55. The optimized breast milk oil of clause 50, wherein the plant oils are selected from the group comprising coconut oil, olive oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, palm kernel oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

Clause 56. The optimized breast milk oil of clause 50, wherein the plant oil is coconut oil, olive oil, avocado oil, or combinations thereof.

Clause 57. The optimized breast milk oil of clause 50, wherein the plant oils are selected from the group comprising coconut oil, canola oil, sunflower oil, algal oil, and combinations thereof.

Clause 58. The optimized breast milk oil of clause 50, wherein the plant oils are selected from the group comprising coconut oil, algal oil, and combinations thereof.

Clause 59. The optimized breast milk oil of clause 50, wherein the plant oil is olive oil, canola oil, flaxseed oil, walnut oil, sesame oil, or combinations thereof.

Clause 60. The optimized breast milk oil of clause 50, wherein the plant oil is derived from a nut, a seed, an avocado, a plant oil, a soybean product, a whole grain, or combinations thereof.

Clause 61. The optimized breast milk oil of clause 60, wherein the nut or seed is an almond, a walnut, flaxseed, chia seed, hemp seed, pumpkin seed, or combinations thereof.

Clause 62. The optimized breast milk oil of clause 60, wherein the soybean product is tofu, tempeh, edamame, or combinations thereof.

Clause 63. The optimized breast milk oil of clause 60, wherein the whole grain is oats, quinoa, brown rice, or combinations thereof.

Clause 64. The optimized breast milk oil of any one of clauses 38 to 49, wherein the fatty acids are derived from recombinant sources.

Clause 65. The optimized breast milk oil of clause 64, wherein the fatty acids are derived from only recombinant sources.

Clause 66. The optimized breast milk oil of any one of clauses 38 to 49, wherein the fatty acids are derived from fatty fish, algae, fungi, dairy products, cooking oils, plant source, or combinations thereof.

Clause 67. The optimized breast milk oil of clause 66, wherein the fatty fish are salmon, mackerel, sardines, trout, herring, tuna, or combinations thereof.

Clause 68. The optimized breast milk oil of clause 66, wherein the dairy products are butter, cheese, cream, whole milk, or combinations thereof.

Clause 69. The optimized breast milk oil of clause 66, wherein the cooking oils are palm oil, coconut oil, vegetable oil, or combinations thereof.

Clause 70. The optimized breast milk oil of any one of clauses 38 to 69, wherein the oil does not comprise palm oil.

Clause 71. A optimized breast milk oil according to any one of clauses 38 to 70, prepared by combining the fatty acids.

Clause 72. An infant formula comprising the optimized breast milk oil of any one of clauses 38 to 69.

Clause 73. The infant formula of clause 72, wherein the infant formula mimics a human breast milk.

Clause 74. An optimized breast milk composition comprising fatty acids, wherein the optimized breast milk composition comprises saturated fatty acids, unsaturated fatty acids, and combinations thereof; wherein the fatty acids are selected from the group consisting of short/medium chain fatty acids, intermediate chain fatty acids, long chain fatty acids, and combinations thereof.

Clause 75. The optimized breast milk composition of clause 74, wherein the long chain fatty acids comprise greater than fourteen carbons.

Clause 76. The optimized breast milk composition of clause 75, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

Clause 77. The optimized breast milk composition of clause 76, wherein the Palmitic acid (C16:0) is in an amount of about 18.67% to about 23.83% of the fatty acids.

Clause 78. The optimized breast milk composition of clause 74, wherein the fatty acids are polyunsaturated fatty acids selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

Clause 79. The optimized breast milk composition of clause 78, wherein the Linoleic acid (C18:2n6) is in an amount of about 5.85% to about 9.00% of the fatty acids.

Clause 80. The optimized breast milk composition of clause 78, wherein Arachidonic acid (C20:4n6) is in an amount of about 0.60% to about 0.66% of the fatty acids.

Clause 81. The optimized breast milk composition of clause 78, wherein the Docosahexaenoic acid (C22:6n3) is in an amount of about 0.35% to about 0.39% of the fatty acids.

Clause 82. The optimized breast milk composition of clause 78, wherein a ratio of Eicosapentaenoic acid to Docosahexaenoic acid is about 0.2:1 to about 0.8:1.

Clause 83. The optimized breast milk composition of clause 78, wherein a ratio of Linoleic acid to alpha-Linolenic acid is about 4:1 to about 15:1.

Clause 84. The optimized breast milk composition of clause 78, wherein the polyunsaturated fatty acids comprise n-6 fatty acids, n-3 fatty acids, and combinations thereof.

Clause 85. The optimized breast milk composition of clause 78, wherein the fatty acids are derived from whole milk, plant oils, and recombinant oils.

Clause 86. The optimized breast milk composition of clause 78, wherein the fatty acids are derived from recombinant sources in combination with whole milk powder.

Clause 87. The optimized breast milk composition of clause 85, wherein the whole milk is a whole milk powder.

Clause 88. The optimized breast milk composition of clause 87, wherein the whole milk powder comprises less than about 50% milkfat.

Clause 89. The optimized breast milk composition of clause 87, wherein the whole milk powder comprises nonfat whole milk.

Clause 90. The optimized breast milk composition of clause 85, wherein the plant oils are selected from the group comprising coconut oil, olive oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, palm kernel oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

Clause 91. The optimized breast milk composition of clause 85, wherein the plant oil is coconut oil, olive oil, avocado oil, or combinations thereof.

Clause 92. The optimized breast milk composition of clause 85, wherein the fatty acids are derived from only recombinant sources.

Clause 93. The optimized breast milk composition of clause 74, wherein the composition does not comprise palm oil.

Clause 94. An optimized breast milk composition according to clause 74, prepared by combining the fatty acids.

Clause 95. An infant formula comprising the optimized breast milk composition of clause 74.

Clause 96. The infant formula of clause 95, wherein the infant formula mimics a human breast milk.

Clause 97. A composition comprising fatty acids, the composition comprising: saturated fatty acids, unsaturated fatty acids, and combinations thereof; wherein the fatty acids are selected from the group consisting of short/medium chain fatty acids, intermediate chain fatty acids, long chain fatty acids, and combinations thereof; wherein the long chain fatty acids comprise palmitic acid; and wherein the composition does not comprise palm oil.

Clause 98. The composition of clause 97, wherein the palmitic acid is in an amount of about 18.17% to about 24.59% of the fatty acids.

Clause 99. The composition of clause 97, wherein a ratio of Arachidonic acid to Docosahexaenoic acid is about 1.4:1 to about 2:1.

Clause 100. The composition of clause 97, wherein a ratio of Linoleic acid to alpha-Linolenic acid is about 4:1 to about 15:1.

Clause 101. The composition of clause 97, wherein the fatty acids are derived from whole milk, plant oils, and recombinant oils.

Clause 102. The composition of clause 101, wherein the whole milk is a whole milk powder.

Clause 103. The composition of clause 102, wherein the whole milk powder is in an amount of about 11% to about 21% of the composition.

Clause 104. The composition of clause 102, wherein the whole milk powder comprises less than about 50% milkfat.

Clause 105. The composition of clause 102, wherein the whole milk powder comprises nonfat whole milk.

Clause 106. The composition of clause 101, wherein the plant oils are selected from the group comprising coconut oil, olive oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

Clause 107. The composition of clause 106, wherein the plant oil is coconut oil, olive oil, avocado oil, or combinations thereof.

Clause 108. The composition of clause 97, wherein the fatty acids are derived from recombinant sources.

Clause 109. The composition of clause 97, wherein the fatty acids are derived from only recombinant sources.

Clause 110. The composition of clause 97, wherein the fatty acids are derived from recombinant sources in combination with whole milk powder.

Clause 111. An infant formula comprising fatty acids, wherein the infant formula comprises: saturated fatty acids, unsaturated fatty acids, and combinations thereof; wherein the saturated fatty acids are selected from the group consisting of short/medium chain fatty acids, intermediate chain fatty acids, long chain fatty acids, and combinations thereof; wherein the long chain fatty acids comprise palmitic acid; and wherein the infant formula does not comprise palm oil.

Clause 112. The infant formula of clause 111, wherein the infant formula mimics a human breast milk.

Clause 113. The infant formula of clause 111, wherein the palmitic acid is in an amount of about 18.17% to about 24.59% of the fatty acids.

Clause 114. The infant formula of clause 111, wherein a ratio of Arachidonic acid to Docosahexaenoic acid is about 1.4:1 to about 2:1.

Clause 115. The infant formula of clause 111, wherein a ratio of Linoleic acid to alpha-Linolenic acid is about 4:1 to about 15:1.

Clause 116. The infant formula of clause 111, wherein the fatty acids are derived from whole milk, plant oils, and recombinant oils.

Clause 117. The infant formula of clause 116, wherein the plant oils are selected from the group comprising coconut oil, olive oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

Clause 118. The infant formula of clause 117, wherein the plant oil is coconut oil, olive oil, avocado oil, or combinations thereof.

### EXAMPLES

The below examples are merely illustrative and are not inclusive of any additional data or experimental results that can be derived from any embodiments provided in the instant disclosure.

### Example 1: Fatty Acid Profile Comparisons

FIG. 1 illustrates a comparison of fatty acid profiles between breast milk, current marketed infant formulas (average of three different brands), and a composition of embodiments disclosed herein (Composition 1). The graph shows the relative percentages of different fatty acid groups (shown on the x-axis from left to right), including short/medium chain, intermediate chain saturated, long chain saturated, monounsaturated, and polyunsaturated fatty acids. This figure demonstrates the significant differences between breast milk and current infant formulas, as well as how Composition 1 aims to more closely mimic average healthy human breast milk composition while optimizing certain aspects. The fatty acid profile of optimized human breast milk mimicking formula is outlined in Table 1.

TABLE 1
Fatty acid content of optimized human
breast milk mimicking formula

| Fatty Acid Type | Range |
|---|---|
| Short/Medium Chain Saturated | 0.4-4.2% |
| Intermediate Chain Saturated | 7.5-20.0% |
| Long Chain Saturated | 22.79-38.0% |
| Monounsaturated | 26.64-55.22% |
| Polyunsaturated | 7.8-12.67% |

FIG. 2 presents fatty acid (FA) profiles of mature breast milk from healthy and unhealthy subjects. The graph compares the relative percentages of various fatty acid groups between these two categories, highlighting the differences in fatty acid composition that can occur based on maternal health status. This figure provides insight into the variability of breast milk composition and the importance of targeting an optimal fatty acid profile in infant formula development. The graph shows the relative percentages of different fatty acid groups (shown on the x-axis from left to right), including short/medium chain, intermediate chain saturated, long chain saturated, monounsaturated, and polyunsaturated fatty acids.

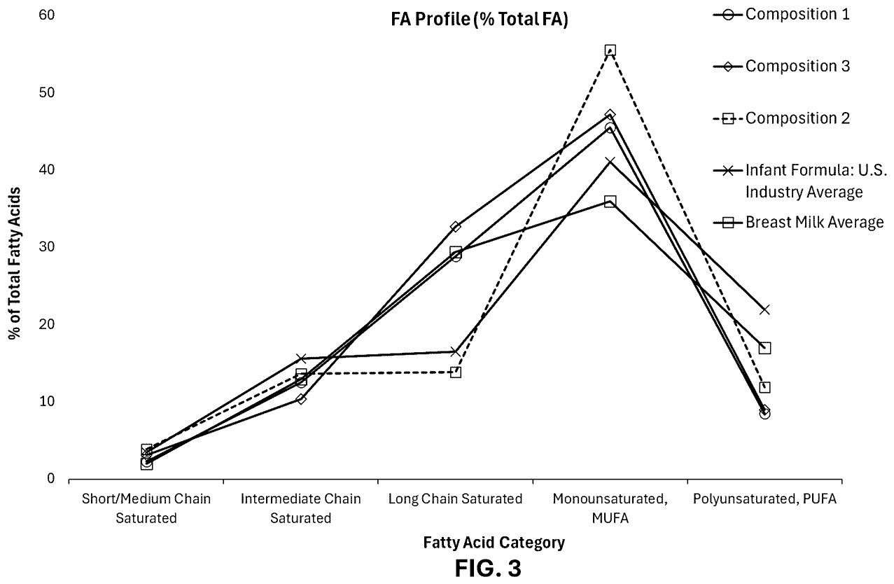

FIG. 3 depicts a composition of embodiments disclosed herein (Composition 1, Composition 2, and Composition 3) for achieving the target fatty acid profile. The graph shows multiple scenarios, including, the U.S. Industry Average Infant Formula, average breast milk fatty acid profile as well as Compositions 1, 2, and 3 from embodiments of the present application.

The graph illustrates the relative percentages of different fatty acid groups, including short/medium chain, intermediate chain saturated, long chain saturated, monounsaturated, and polyunsaturated fatty acids, as shown on the x-axes from left to right. This figure demonstrates how the present technology's formulation progressively approaches the breast milk fatty acid profile, particularly in achieving the desired levels of long chain saturated fatty acids without the use of palm oil.

Existing infant formulas often rely on a limited range of fat sources, primarily vegetable oils, which may not provide the diverse array of fatty acids found in breast milk. This can result in suboptimal levels of certain beneficial fatty acids, such as docosahexaenoic acid (DHA) and arachidonic acid (ARA), which are crucial for brain and eye development. Another challenge is the presence of undesirable fatty acids in some formula ingredients. For example, certain vegetable oils used in formulas can contain erucic acid, which may have potential negative health effects on infants. Balancing the need for beneficial fatty acids while minimizing potentially harmful ones has been an ongoing challenge for formula manufacturers.

Raw materials limit the development of optimal formulas as combinations of fatty acids are derived from individual sources and it is not possible to combine each individual ingredient. Development of an optimal formula would be impossible without undue experimentation and is not obvious.

Despite significant advancements in infant formula development, current products still face challenges in replicating the complex composition and benefits of human breast milk. As these figures show, existing infant formulas still do not mimic the fatty acid profiles breast milk. The formulas of the present disclosure, depicted in Compositions 1, 2, and 3 of FIG. 3, mimic the fatty acid distribution of breast milk more closely.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The disclosures of each and every patent, patent application, publication, and accession number cited herein are hereby incorporated herein by reference in their entirety.

While present disclosure has been disclosed with reference to various embodiments, it is apparent that other embodiments and variations of these may be devised by others skilled in the art without departing from the true spirit and scope of the disclosure. The appended claims are intended to be construed to include all such embodiments and equivalent variations.

What is claimed is:

1. An optimized breast milk composition comprising fatty acids, wherein the optimized breast milk composition comprises saturated fatty acids, unsaturated fatty acids, and combinations thereof;
wherein the fatty acids are selected from the group consisting of short/medium chain fatty acids, intermediate chain fatty acids, long chain fatty acids, and combinations thereof.

2. The optimized breast milk composition of claim 1, wherein the long chain fatty acids comprise greater than fourteen carbons.

3. The optimized breast milk composition of claim 2, wherein the long chain fatty acids selected from the group consisting of Pentadecanoic acid (C15:0), Palmitic acid (C16:0), Margaric acid (C17:0), Stearic acid (C18:0), Arachidic acid (C20:0), Behenic acid (C22:0), Lignoceric acid (C24:0), and combinations thereof.

4. The optimized breast milk composition of claim 3, wherein the Palmitic acid (C16:0) is in an amount of about 18.67% to about 23.83% of the fatty acids.

5. The optimized breast milk composition of claim 1, wherein the fatty acids are polyunsaturated fatty acids selected from the group consisting of Linoleic acid (C18:2n6), Linolenic acid (C18:3n3), Arachidonic acid (C20:4n6), Eicosapentaenoic acid (C20:5n3), Docosapentaenoic acid (C22:5n3), Docosahexaenoic acid (C22:6n3), and combinations thereof.

6. The optimized breast milk composition of claim 5, wherein the Linoleic acid (C18:2n6) is in an amount of about 5.85% to about 9.00% of the fatty acids.

7. The optimized breast milk composition of claim 5, wherein Arachidonic acid (C20:4n6) is in an amount of about 0.60% to about 0.66% of the fatty acids.

8. The optimized breast milk composition of claim 5, wherein the Docosahexaenoic acid (C22:6n3) is in an amount of about 0.35% to about 0.39% of the fatty acids.

9. The optimized breast milk composition of claim 5, wherein a ratio of Eicosapentaenoic acid to Docosahexaenoic acid is about 0.2:1 to about 0.8:1.

10. The optimized breast milk composition of claim 5, wherein a ratio of Linoleic acid to alpha-Linolenic acid is about 4:1 to about 15:1.

11. The optimized breast milk composition of claim 5, wherein the polyunsaturated fatty acids comprise n-6 fatty acids, n-3 fatty acids, and combinations thereof.

12. The optimized breast milk composition of claim 5, wherein the fatty acids are derived from whole milk, plant oils, and recombinant oils.

13. The optimized breast milk composition of claim 5, wherein the fatty acids are derived from recombinant sources in combination with whole milk powder.

14. The optimized breast milk composition of claim 12, wherein the whole milk is a whole milk powder.

15. The optimized breast milk composition of claim 14, wherein the whole milk powder comprises less than about 50% milkfat.

16. The optimized breast milk composition of claim 14, wherein the whole milk powder comprises nonfat whole milk.

17. The optimized breast milk composition of claim 12, wherein the plant oils are selected from the group comprising coconut oil, olive oil, soybean oil, canola oil, sunflower oil, corn oil, peanut oil, safflower oil, sesame oil, grapeseed oil, avocado oil, flaxseed oil, walnut oil, almond oil, hazelnut oil, macadamia nut oil, rice bran oil, cottonseed oil, hemp seed oil, pumpkin seed oil, argan oil, jojoba oil, castor oil, rapeseed oil, mustard oil, palm kernel oil, babassu oil, neem oil, camellia oil, evening primrose oil, borage oil, black cumin seed oil, chia seed oil, apricot kernel oil, pecan oil, pistachio oil, wheat germ oil, grape seed oil, marula oil, baobab oil, moringa oil, and combinations thereof.

18. The optimized breast milk composition of claim 12, wherein the plant oil is coconut oil, olive oil, avocado oil, or combinations thereof.

19. The optimized breast milk composition of claim 12, wherein the fatty acids are derived from only recombinant sources.

20. The optimized breast milk composition of claim 1, wherein the composition does not comprise palm oil.

21. An optimized breast milk composition according to claim 1, prepared by combining the fatty acids.

22. An infant formula comprising the optimized breast milk composition of claim 1.

23. The infant formula of claim 22, wherein the infant formula mimics a human breast milk.
